(19) United States
(12) Patent Application Publication
(10) Pub. No.: US 2004/0202317 A1
(43) Pub. Date: Oct. 14, 2004

(54) Advanced encryption standard (AES) implementation as an instruction set extension

(76) Inventors: Victor Demjanenko, Pendleton, NY (US); Michael Terhaar, Amherst, NY (US); Kevin Coopman, Niwot, CO (US)

Correspondence Address: Juan Alberto Torres, VOCAL Technologies, Ltd., 200 John James Audubon Parkway, Suite 105, Buffalo, NY, 14228, US

(21) Appl. No.: 10/742,717

(22) Filed: Dec. 19, 2003

Related U.S. Application Data
(60) Provisional application No. 60/435,444, filed on Dec. 20, 2002.
(60) Provisional application No. 60/440,706, filed on Jan. 17, 2003.
(60) Provisional application No. 60/500,879, filed on Sep. 5, 2003.
(60) Provisional application No. 60/505,246, filed on Sep. 22, 2003.

(51) Int. Cl. H04L 9/00

(52) U.S. Cl. 380/28

(57) ABSTRACT

This application illustrates several techniques to incorporate AES hardware logic into a processor such that the AES operations are accessed as instructions of the processor. Once the AES operations are initiated by a processor instruction, they operate independently of the processor allowing the processor to perform other operations. In these implementations, the processor may perform other operations to save preceding data already processed by the AES operations. Also, the processor may perform other operations to prepare data for a subsequent AES operation. The AES hardware may have registers to buffer data results from a preceding AES operation so that the processor may read such data results after the AES hardware has initiated another operation. The AES hardware may also have registers to buffer data prepared for a subsequent AES operation so that the processor may prepare data for the following AES operation while the AES hardware is still completing a current operation. The AES hardware may also have a signal to delay the processor until it is ready to begin a subsequent AES operation, whereby the delay is used when the AES hardware is busy with a current AES operation. This avoids the need for the processor to poll for the AES hardware to be ready. The AES operations performed by the AES hardware and started by AES instructions of the processor may include the following: AES encryption, AES decryption, AES CBC mode, AES key expansion, CCMP data encryption, CCMP data decryption, CCMP MIC generation and CCMP MIC authentication. Two AES operations may be performed in an interleaved fashion on the AES hardware whereby the data for the two AES operations are held in two distinct pipeline registers. The two AES operations may be CCMP data encryption and CCMP MIC generation possibly operating on the same incoming data. The two AES operations may also be CCMP data decryption and CCMP MIC authentication possibly operating on the same incoming data. Or the two AES operations may be operating on different sets of incoming data. The distinct pipeline registers are located on the inputs and outputs of a SBOX unit. The SBOX unit may be implemented using well known techniques including read only memory (ROM), random access memory (RAM) or logic implemented in hardware.

### CONTINUATION DATA

This patent application claims the benefit under 35 U.S.C. Section 119(e) of U.S. Provisional Patent Application Serial No. 60/435,444, filed on Dec. 20, 2002, the Provisional Patent Application Serial No. 60/440,706, filed on Jan. 17, 2003, the Provisional Patent Application Serial No. 60/500,879, filed on Sep. 5, 2003 and the Provisional Patent Application Serial No. 60/505,246, filed on Sep. 22, 2003, all of which are incorporated herein by reference.

### COMPUTER PROGRAM LISTING APPENDIX

Incorporated by reference herein is a computer program listing appendix submitted on compact disk herewith and containing ASCII copies of the following files: aes_dec_{—}32b_cop.s 5 kbyte created on Jan. 17, 2003; aes_dec_{—}32b_cop_opt.s 5 kbyte created on Jan. 16, 2003; aes_dec_{—}64b_cop.s 5 kbyte created on Jan. 16, 2003; aes_dec_{—}64b_cop_opt.s 5 kbyte created on Jan. 16, 2003; aes_enc_{—}128b_cop_opt.s 6 kbyte created on Dec. 17, 2003; aes_dec_{—}128b_cop_opt.s 6 kbyte created on Dec. 17, 2003; aes_dec_blk_{—}32b.s 5 kbyte created on Jan. 16, 2003; aes_dec_prim.s 7 kbyte created on Jan. 16, 2003; aes_dec_rnd.s 3 kbyte created on Jan. 16, 2003; aes_driver.c 3 kbyte created on Jan. 16, 2003; aes_enc_{—}32b_cop.s 5 kbyte created on Jan. 17, 2003; aes_enc_{—}32b_cop_opt.s 5 kbyte created on Jan. 17, 2003; aes_enc_{—}64b_cop.s 5 kbyte created on Jan. 17, 2003; aes_enc_{—}64b_cop_opt.s 5 kbyte created on Jan. 12, 2003; aes_enc_blk_{—}32b.s 5 kbyte created on Jan. 16, 2003; aes_enc_prim.s 6 kbyte created on Jan. 16, 2003; aes_ene_rnd.s 3 kbyte created on Jan. 16. 2003; cipher.h 2 kbyte created on Jan. 16, 2003; cipher32.c 8 kbyte created on Jan. 17, 2003; decipher32.c 12 kbyte created on Jan. 17, 2003; extended_key.h 2 kbyte created on Dec. 20, 2002; inv_s_box.h 3 kbyte created on Dec. 20, 2002; s_box.h 3 kbyte created on Jul. 25, 2003; vt802i.c 32 kbyte created on Sep. 5, 2003; vt802i.h 4 kbyte created on Sep. 5. 2003; vt_ciph32.c 13 kbytes created on Jul. 25, 2003; aes_encode_{—}128.v 58 kbytes created on Nov. 20 2003; bus_sel_{—}2_{—}1_gates.v 3 kbytes created on Oct. 27, 2003; bus_xor2.v 1 kbytes created on Oct. 27 2003; Bus_XOR5.v 1 kbytes created on Oct. 9, 2003; byte_ff.v 1 kbytes created on Nov. 21, 2003; GF_Mult2.v 1 kbytes created on Oct. 27, 2003; GF_Mult3.v 1 kbytes created on Oct. 27, 2003; mux_{—}16_{—}1 .v 2 kbytes created on Nov. 18, 2003; pass_en_word_mux.v 1 kbytes created on Oct. 27, 2003; sbox.v 1 kbytes created on Nov. 18, 2003; sbox_rom.v 4 kbytes created on Nov. 20, 2003; Transpose1st_Mux.v 4 kbytes created on Nov. 10, 2003; Transpose_mux.v 5 kbytes created on Oct. 27, 2003; word_sel2.v 3 kbytes created on Oct. 27, 2003 word_xor2.v 1 kbytes created on Oct. 27, 2003; Word_XOR5.v 4 kbytes created on Oct. 29, 2003; bit_ff v 1 kbytes created on Nov. 17, 2003; Bus_{—}2XOR.v 1 kbytes created on Oct. 27, 2003; bus_sel_{—}3_{—}1_gates.v 4 kbytes created on Oct. 27, 2003; bus_sel_{—}5_{—}1_gates.v 4 kbytes created on Oct. 23 2003; byte_fcs.v 1 kbytes created on Nov. 18, 2003; ccmp_{—}128.v 29 kbytes created on Nov. 18 2003; ccmp_{—}128top.v 5 kbytes created on Nov. 18, 2003 ccmp_state_{—}128.v 28 kbytes created on Nov. 20, 2003; counter_{—}16bit.v 1 kbytes created on Sep. 17, 2003; crc32_d8.v 3 kbytes created on October 2September 03; data_alignment_{—}128.v 5 kbytes created on Sep. 29, 2003; fcs.v 8 kbytes created on October 2September 03; gf2_word.v 1 kbytes created on Oct. 27, 2003; gf3_word.v 1 kbytes created on Oct. 27, 2003; ir_ff.v 1 kbytes created on Nov. 21, 2003; keys_{—}1234.v 3 kbytes created on Oct. 27, 2003; key_ff v 1 kbytes created on Nov. 18, 2003; loop_cnt_ffv 1 kbytes created on Nov. 20, 2003; nonce.v 4 kbytes created on Sep. 11, 2003; options.h 1 kbytes created on Nov. 12, 2003; readme.txt 1 kbytes created on Nov. 18, 2003; sbox.dat 2 kbytes created on September October 03; test_ccmp_{—}11.v 21 kbytes created on Nov. 18, 2003; word3_{—}1_sel.v 2 kbytes created on Oct. 27, 2003; word_{—}5_{—}1_sel.v 3 kbytes created on Oct. 27, 2003.

### FIELD OF THE INVENTION

The present invention relates to the implementation of the Advanced Encryption Standard (AES) algorithms for the MIPS Microprocessor in several forms. The forms include varying levels of hardware complexity utilizing User Defined Instructions (UDI). Use of the UDI mechanism allows for the incorporation of digital logic to implement the Advanced Encryption Standard algorithms.

### SUMMARY OF THE INVENTION

This application illustrates several techniques to incorporate AES hardware logic into a processor such that the AES operations are accessed as instructions of the processor. Once the AES operations are initiated by a processor instruction, they operate independently of the processor allowing the processor to perform other operations. In these implementations, the processor may perform other operations to save preceding data already processed by the AES operations. Also, the processor may perform other operations to prepare data for a subsequent AES operation. The AES hardware may have registers to buffer data results from a preceding AES operation so that the processor may read such data results after the AES hardware has initiated another operation. The AES hardware may also have registers to buffer data prepared for a subsequent AES operation so that the processor may prepare data for the following AES operation while the AES hardware is still completing a current operation. The AES hardware may also have a signal to delay the processor until it is ready to begin a subsequent AES operation, whereby the delay is used when the AES hardware is busy with a current AES operation. This avoids the need for the processor to poll for the AES hardware to be ready. The AES operations performed by the AES hardware and started by AES instructions of the processor may include the following: AES encryption, AES decryption, AES CBC mode, AES key expansion, CCMP data encryption, CCMP data decryption, CCMP MIC generation and CCMP MIC authentication. Two AES operations may be performed in an interleaved fashion on the AES hardware whereby the data for the two AES operations are held in two distinct pipeline registers. The two AES operations may be CCMP data encryption and CCMP MIC generation possibly operating on the same incoming data. The two AES operations may also be CCMP data decryption and CCMP MIC authentication possibly operating on the same incoming data. Or the two AES operations may be operating on different sets of incoming data. The distinct pipeline registers are located on the inputs and outputs of a SBOX unit. The SBOX unit may be implemented using well known techniques including read only memory (ROM), random access memory (RAM) or logic implemented in hardware.

### BRIEF DESCRIPTION OF THE DRAWINGS

FIG. 1 shows the Gated 2-Input XOR

FIG. 2 shows the Galios Field Multiplier

FIG. 3 shows the Improved Galios Field Multiplier

FIG. 3 shows the Scalar Galios Field Multiply

FIG. 4 shows the 4×4 SIMD Galios Field Multiply

FIG. 5 shows the 1×4 SIMD Galios Field Multiply

FIG. 6 shows the RS Encode Kernel

FIG. 7 shows the RS Decode Kernel

FIG. 8 shows the Alternate RS Decode Kernel

FIG. 9 shows the UDI AES Encode Round Accelerator Truth Table

FIG. 10 shows the UDI AES Encode Round Accelerator Part 1

FIG. 11 shows the UDI AES Encode Round Accelerator Part 2

FIG. 12 shows the UDI AES Encode Round Accelerator XOR Key

FIG. 13 shows the UDI AES Encode Round Accelerator Transpose 1

FIG. 14 shows the UDI AES Encode Round Accelerator Transpose 2

FIG. 15 shows the UDI AES Encode 32-bit Block Accelerator Truth Table

FIG. 16 shows the UDI AES Encode 32-bit Block Accelerator Part 1

FIG. 17 shows the UDI AES Encode 32-bit Block Accelerator Part 2

FIG. 18 shows the UDI AES Encode 32-bit Block Accelerator Transpose 2

FIG. 19 shows the UDI AES Encode 32-bit Co-Processor Truth Table

FIG. 20 shows the UDI AES Encode 32-bit Co-Processor Part 1

FIG. 21 shows the UDI AES Encode 32-bit Co-Processor Part 2

FIG. 22 shows the UDI AES Encode 32-bit Co-Processor Transpose 2

FIG. 23 shows the UDI AES Encode 64-bit Co-Processor Truth Table

FIG. 24 shows the UDI AES Encode 64-bit Co-Processor Part 1

FIG. 25 shows the UDI AES Encode 64-bit Co-Processor Part 2

FIG. 26 shows the UDI AES Encode 64-bit Co-Processor Transpose 1

FIG. 27 shows the UDI AES Encode 64-bit Co-Processor Transpose 2

FIG. 28 shows the UDI AES Encode 64-bit Co-Processor GF Multipliers

FIG. 29 shows the UDI AES Encode 128-bit Co-Processor Truth Table

FIG. 30 shows the UDI AES Encode 128-bit Co-Processor Block Diagram

FIG. 31 shows the UDI AES Encode 128-bit Co-Processor Part 1

FIG. 32 shows the UDI AES Encode 128-bit Co-Processor Part 2

FIG. 33 shows the UDI AES Encode 128-bit Co-Processor Input Selection

FIG. 34 shows the UDI AES Encode 128-bit Co-Processor Transpose 1

FIG. 35 shows the UDI AES Encode 128-bit Co-Processor Transpose 2

FIG. 36 shows the UDI AES Decode Round Accelerator Truth Table

FIG. 37 shows the UDI AES Decode Round Accelerator Part 1

FIG. 38 shows the UDI AES Decode Round Accelerator Part 2

FIG. 39 shows the UDI AES Decode Round Accelerator XOR Key

FIG. 40 shows the UDI AES Decode Round Accelerator Transpose 1

FIG. 41 shows the UDI AES Decode Round Accelerator Transpose 2

FIG. 42 shows the UDI AES Decode 32-bit Block Accelerator Truth Table

FIG. 43 shows the UDI AES Decode 32-bit Block Accelerator Part 1

FIG. 44 shows the UDI AES Decode 32-bit Block Accelerator Part 2

FIG. 45 shows the UDI AES Decode 32-bit Block Accelerator XOR Key

FIG. 46 shows the UDI AES Decode 32-bit Block Accelerator Transpose 1

FIG. 47 shows the UDI AES Decode 32-bit Block Accelerator Key Memory

FIG. 48 shows the UDI AES Decode 32-bit Block Accelerator Transpose 2

FIG. 49 shows the UDI AES Decode 32-bit Co-Processor Truth Table

FIG. 50 shows the UDI AES Decode 32-bit Co-Processor Part 1

FIG. 51 shows the UDI AES Decode 32-bit Co-Processor Part 2

FIG. 52 shows the UDI AES Decode 32-bit Co-Processor XOR Key

FIG. 53 shows the UDI AES Decode 32-bit Co-Processor Transpose 1

FIG. 54 shows the UDI AES Decode 32-bit Co-Processor Key Memory

FIG. 55 shows the UDI AES Decode 32-bit Co-Processor Transpose 2

FIG. 56 shows the UDI AES Decode 64-bit Co-Processor Truth Table

FIG. 57 shows the UDI AES Decode 64-bit Co-Processor Part 1

FIG. 58 shows the UDI AES Decode 64-bit Co-Processor Part 2

FIG. 59 shows the UDI AES Decode 64-bit Co-Processor XOR Key

FIG. 60 shows the UDI AES Decode 64-bit Co-Processor Transpose 1

FIG. 61 shows the UDI AES Decode 64-bit Co-Processor Key Memory

FIG. 62 show s the UDI AES Decode 64-bit Co-Processor Transpose 2

FIG. 63 shows the UDI AES Decode 64-bit Co-Processor GF Multipliers

FIG. 64 shows the UDI AES Decode 128-bit Co-Processor Truth Table

FIG. 65 shows the UDI AES Decode 128-bit Co-Processor Part 1

FIG. 66 shows the UDI AES Decode 128-bit Co-Processor Part 2

FIG. 67 shows the UDI AES Decode 128-bit Co-Processor Input Selection

FIG. 68 shows the UDI AES Decode 128-bit Co-Processor Transpose 1

FIG. 69 shows the UDI AES Decode 128-bit Co-Processor Transpose 2

FIG. 70 shows the UDI AES Decode 128-bit Co-Processor Key Memory

FIG. 70 shows the UDI AES Decode 128-bit Co-Processor Key Memory

FIG. 71 shows how the hardware interacts with the MIPS CorExtend UDI interface

### DETAILED DESCRIPTION OF THE INVENTION

1. Background

The MIPS processor core is a 32-bit processor with efficient instructions for the implementation of many compiled and hand optimized algorithms. For the support of computationally intensive algorithms. MIPS provides a mechanism for developers to incorporate special instructions into the processor core used for their specific application. The User Defined Instructions (UDI) may be specifically designed to assist with the processing of computationally intensive functions.

2. Introduction

This section presents a brief overview of Advanced Encryption Standard and their associated terminology. It also discusses the advantages of a programmable implementations of the Advanced Encryption Standard encoder and decoder.

2.1 Advanced Encryption Standard (AES) Algorithm

The Advanced Encryption Standard (AES) is a computer security standard that became effective on May 26, 2002 by NIST to replace DES. The cryptography scheme is a symmetric block cipher that encrypts and decrypts 128-bit blocks of data. The algorithm consists of four stages that make up a round, which is iterated 10 times for a 128-bit length key, 12 times for a 192-bit key, and 14 times for a 256-bit key. The first stage “SubBytes” transformation is a non-linear byte substitution for each byte of the block. The second stage “ShiftRows” transformation cyclically shifts (penrutes) the bytes within the block. The third stage “MixColumns” transformation groups 4-bytes together forming 4-term polynomials and multiplies the polynomials with a fixed polynomial mod (x\hat{ }4+1). The fourth stage “AddRoundKey” transformation adds the round key with the block of data.

The AES algorithm is a symmetric block encryption scheme useful in the encryption of private data. It encrypts blocks of plaintext 128 bits at a time. Key lengths of 128, 192, and 256 bits are the standard key lengths used by AES. The encoding is split into rounds and each block requires 10 rounds.

The VOCAL implementation of the Advanced Encryption Standard (AES) algorithms for the MIPS are available in several forms. The forms include pure optimized software and varying levels of hardware complexity utilizing UDI instructions. The AES encoder and decoder rely on Galois Field (GF) and byte manipulation operations. UDI instructions are recommended to support the efficient implementation of Galois Field operations. When special assistive hardware is not available (as is the case on most general purpose processors), the Galois Field operations are typically implemented via software. Additional UDI instructions may be implemented to assist with non-linear byte substitution, exclusive-ors of the data, and byte transposition. Combined with the Galois Field UDI instruction, these UDI hardware instructions yield significant performance increases as summarized below.

2.2 The Round Transform

AES is an iterated block cipher with a fixed 128-bit block length and a variable key length (128, 192, or 256 bits). In most ciphers, the iterated transform (a round) usually has a Feistel Structure. Typically in this structure, some of the bits of the intermediate state are transposed unchanged to another position (permutation). AES does not have a Feistel structure but is composed of three distinct invertible transforms based on the Wide Trial Strategy design method.

The Wide Trial Strategy design method provides resistance against linear and differential cryptanalysis. In the Wide Trail Strategy, every layer has its own function:

| The linear mixing layer: | guarantees high diffusion over multiply |
|---|---|
| | rounds |
| The non-linear layer: | parallel application of S-boxes that have |
| | the optimum worst-case non-linearity |
| | properties. |
| The key addition layer: | a simple XOR of the round key to the |
| | intermediate state |

AES uses the three distinct layers as a round as follows:

ROUND (state,round_key) {

ByteSub (state);
ShiftRow (state);
MixColumn (state);
AddRoundKey (state, round_key);

}

The final round is as follows:

FINAL_ROUND (state, round_key) {

ByteSub (state);
ShiftRow (state);
AddRoundKey (state, round_key);

}

2.2.1 The ByteSub Transform

The ByteSub transformation is a non-linear byte substitution with an invertible substitution table (SBOX).

ByteSub (byte* state) {

for(int i = 0; i < 16; i++)

state [i] = SBOX [state [i]];

}

2.2.2 The ShiftRow Transform

The state consists of 128-bits (block of 16 bytes) and can be thought of as a matrix as follows:

$$[ \begin{matrix}state [ 0 ] & state [ 1 ] & state [ 2 ] & state [ 3 ] \\ state [ 4 ] & state [ 5 ] & state [ 6 ] & state [ 7 ] \\ state [ 8 ] & state [ 9 ] & state [ 10 ] & state [ 11 ] \\ state [ 12 ] & state [ 13 ] & state [ 14 ] & state [ 15 ]\end{matrix} ]$$

The shift rows transform permutes the above matrix into the matrix below:

$$[ \begin{matrix}state [ 0 ] & state [ 1 ] & state [ 2 ] & state [ 3 ] \\ state [ 5 ] & state [ 6 ] & state [ 7 ] & state [ 4 ] \\ state [ 10 ] & state [ 11 ] & state [ 8 ] & state [ 9 ] \\ state [ 15 ] & state [ 12 ] & state [ 13 ] & state [ 14 ]\end{matrix} ]$$

2.2.3 The MixColumn Transformation

In the MixColumn transform, the state matrix is multiplied by a fixed matrix over GF(28) as follows:

$$NEWSTATE = [ \begin{matrix}2 & 3 & 1 & 1 \\ 1 & 2 & 3 & 1 \\ 1 & 1 & 2 & 3 \\ 3 & 1 & 1 & 2\end{matrix} ] [ \begin{matrix}state [ 0 ] & state [ 1 ] & state [ 2 ] & state [ 3 ] \\ state [ 4 ] & state [ 5 ] & state [ 6 ] & state [ 7 ] \\ state [ 8 ] & state [ 9 ] & state [ 10 ] & state [ 11 ] \\ state [ 12 ] & state [ 13 ] & state [ 14 ] & state [ 15 ]\end{matrix} ]$$

2.2.4 The Round Key Addition

The final step in the Round transformation is to add the current round key to the state. Since the arithmetic is over GF(28), addition has no carries and is simply an XOR. The C-code for the AddRoundKey function is as follows:

AddRoundKey (state, round_key) {

for (int i = 0; i < 16; i++)

state [i] \hat{ }= round_key [i];

}

3 Encode Implementation

The implementation of a round can be done on the cipher side with table look-ups as follows:

$$ROUNDSTATE = [ \begin{matrix}2 & 3 & 1 & 1 \\ 1 & 2 & 3 & 1 \\ 1 & 1 & 2 & 3 \\ 3 & 1 & 1 & 2\end{matrix} ] [ \begin{matrix}sbox [ x [ 0 ] ] & sbox [ x [ 1 ] ] & sbox [ x [ 2 ] ] & sbox [ x [ 3 ] ] \\ sbox [ x [ 5 ] ] & sbox [ x [ 6 ] ] & sbox [ x [ 7 ] ] & sbox [ x [ 4 ] ] \\ sbox [ x [ 10 ] ] & sbox [ x [ 11 ] ] & sbox [ x [ 8 ] ] & sbox [ x [ 9 ] ] \\ sbox [ x [ 15 ] ] & sbox [ x [ 12 ] ] & sbox [ x [ 13 ] ] & sbox [ x [ 14 ] ]\end{matrix} ] ⊕ [ \begin{matrix}key [ 0 ] & key [ 1 ] & key [ 2 ] & key [ 3 ] \\ key [ 4 ] & key [ 5 ] & key [ 6 ] & key [ 7 ] \\ key [ 8 ] & key [ 9 ] & key [ 10 ] & key [ 11 ] \\ key [ 12 ] & key [ 13 ] & key [ 14 ] & key [ 15 ]\end{matrix} ]$$

Let the columns of matrix ROUNDSTATE be represented by:

ROUNDSTATE=[c1 c2 c3 c4]

If matrices are multiplied out:

$$\begin{matrix}[ c1 ] = sbox [ x [ 0 ] ] [ \begin{matrix}2 \\ 1 \\ 1 \\ 3\end{matrix} ] ⊕ sbox [ x [ 5 ] ] [ \begin{matrix}3 \\ 2 \\ 1 \\ 1\end{matrix} ] ⊕ sbox [ x [ 10 ] ] [ \begin{matrix}1 \\ 3 \\ 2 \\ 1\end{matrix} ] ⊕ \\ sbox [ x [ 15 ] ] [ \begin{matrix}1 \\ 1 \\ 3 \\ 2\end{matrix} ] ⊕ [ \begin{matrix}key [ 0 ] \\ key [ 4 ] \\ key [ 8 ] \\ key [ 12 ]\end{matrix} ] \\ [ c2 ] = sbox [ x [ 1 ] ] [ \begin{matrix}2 \\ 1 \\ 1 \\ 3\end{matrix} ] ⊕ sbox [ x [ 6 ] ] [ \begin{matrix}3 \\ 2 \\ 1 \\ 1\end{matrix} ] ⊕ sbox [ x [ 11 ] ] [ \begin{matrix}1 \\ 3 \\ 2 \\ 1\end{matrix} ] ⊕ \\ sbox [ x [ 12 ] ] [ \begin{matrix}1 \\ 1 \\ 3 \\ 2\end{matrix} ] ⊕ [ \begin{matrix}key [ 1 ] \\ key [ 5 ] \\ key [ 9 ] \\ key [ 13 ]\end{matrix} ] \\ [ c3 ] = sbox [ x [ 2 ] ] [ \begin{matrix}2 \\ 1 \\ 1 \\ 3\end{matrix} ] ⊕ sbox [ x [ 7 ] ] [ \begin{matrix}3 \\ 2 \\ 1 \\ 1\end{matrix} ] ⊕ sbox [ x [ 8 ] ] [ \begin{matrix}1 \\ 3 \\ 2 \\ 1\end{matrix} ] ⊕ \\ sbox [ x [ 13 ] ] [ \begin{matrix}1 \\ 1 \\ 3 \\ 2\end{matrix} ] ⊕ [ \begin{matrix}key [ 2 ] \\ key [ 6 ] \\ key [ 10 ] \\ key [ 14 ]\end{matrix} ] \\ [ c4 ] = sbox [ x [ 3 ] ] [ \begin{matrix}2 \\ 1 \\ 1 \\ 3\end{matrix} ] ⊕ sbox [ x [ 4 ] ] [ \begin{matrix}3 \\ 2 \\ 1 \\ 1\end{matrix} ] ⊕ sbox [ x [ 9 ] ] [ \begin{matrix}1 \\ 3 \\ 2 \\ 1\end{matrix} ] ⊕ \\ sbox [ x [ 14 ] ] [ \begin{matrix}1 \\ 1 \\ 3 \\ 2\end{matrix} ] ⊕ [ \begin{matrix}key [ 3 ] \\ key [ 7 ] \\ key [ 11 ] \\ key [ 15 ]\end{matrix} ] \end{matrix}$$

If 4 tables (256 32-bit elements) are constructed as follows:

$$\begin{matrix}T1 [ i ] = [ \begin{matrix}\begin{matrix}\begin{matrix}2 * sbox [ i ] \\ sbox [ i ]\end{matrix} \\ sbox [ i ]\end{matrix} \\ 3 * sbox [ i ]\end{matrix} ] , T2 [ i ] = [ \begin{matrix}\begin{matrix}\begin{matrix}3 * sbox [ i ] \\ 2 * sbox [ i ]\end{matrix} \\ sbox [ i ]\end{matrix} \\ sbox [ i ]\end{matrix} ] , \\ T3 [ i ] = [ \begin{matrix}\begin{matrix}\begin{matrix}sbox [ i ] \\ 3 * sbox [ i ]\end{matrix} \\ 2 * sbox [ i ]\end{matrix} \\ sbox [ i ]\end{matrix} ] , T4 [ i ] = [ \begin{matrix}\begin{matrix}\begin{matrix}sbox [ i ] \\ sbox [ i ]\end{matrix} \\ 3 * sbox [ i ]\end{matrix} \\ 2 * sbox [ i ]\end{matrix} ]\end{matrix}$$

After multiplying the matrices it looks like the following:

$$\begin{matrix}[ c1 ] = T1 [ x [ 0 ] ] ⊕ T2 [ x [ 5 ] ] ⊕ T3 [ x [ 10 ] ] ⊕ T4 [ x [ 15 ] ] ⊕ [ \begin{matrix}key [ 0 ] \\ key [ 4 ] \\ key [ 8 ] \\ key [ 12 ]\end{matrix} ] \\ [ c2 ] = T1 [ x [ 1 ] ] ⊕ T2 [ x [ 6 ] ] ⊕ T3 [ x [ 11 ] ] ⊕ T4 [ x [ 12 ] ] ⊕ [ \begin{matrix}key [ 1 ] \\ key [ 5 ] \\ key [ 9 ] \\ key [ 13 ]\end{matrix} ] \\ [ c3 ] = T1 [ x [ 2 ] ] ⊕ T2 [ x [ 7 ] ] ⊕ T3 [ x [ 8 ] ] ⊕ T4 [ x [ 13 ] ] ⊕ [ \begin{matrix}key [ 2 ] \\ key [ 6 ] \\ key [ 10 ] \\ key [ 14 ]\end{matrix} ] \\ [ c4 ] = T1 [ x [ 3 ] ] ⊕ T2 [ x [ 4 ] ] ⊕ T3 [ x [ 9 ] ] ⊕ T4 [ x [ 14 ] ] ⊕ [ \begin{matrix}key [ 3 ] \\ key [ 7 ] \\ key [ 11 ] \\ key [ 15 ]\end{matrix} ]\end{matrix}$$

Thus, the algorithm can be simplified down to table lookups and exclusive-or's of the data from the tables. The shift row's and SBOX lookup's are performed at the same time, and the data remains intact without having to shift bytes around.

3.1. Optimized Software

The software implementation of the 128-bit AES algorithm utilizes a main loop, which is executed essentially 9 times. Each iteration of the loop performs a round. The loop begins by splitting the block into bytes and performing a non-linear transformation of the data. Table lookup for Galois field multiplication by 2 and 3 is performed on each word. The results from the table lookup are exclusive-or'd together, and the expanded key is then exclusive-or'd with the results from the table lookup. The end results are saved into a buffer and the whole loop starts from the beginning using the new results for input. After the main loop is finished, a final smaller round is performed and the final results are obtained.

If the key length is changed, the algorithm requires an increased number of rounds performed per block. The optimized software requires 774 instructions per block of 16 bytes of data using a 128-bit key. For a 192-bit key, the optimized software requires 936 instructions per block. Each step to the next higher key size requires two additional iterations of the main loop. Therefore, each increase in key size for this implementation will require an additional 1.3 MIPS.

There are 7812.5 blocks required to transmit a megabit of data. For a 128-bit key, a block would consume 774 cycles and encoding a megabit of data would take 6.0 MIPS. For a 192-bit key, a block would consume 936 cycles and 7.3 MIPS. A 256-bit key would consume 1098 cycles and 8.6 MIPS for each block.

3.2 UDI AES Encode Primitives

The GF2 multiplication, non-linear substitution, and the byte transposition operations may be assisted with UDI instructions on the MIPS processor. The effectiveness and use of these instructions are described in this section.

One of the complexities of the AES algorithm is the multiplication over a finite field (the Galois Field). Without a GF2 hardware instruction, the multiplication is performed in software by table lookup to simulate a Galois Field hardware instruction:

word GF2_MULT (word input) {

flag = ((input & GF_MASK) >> 7);
result = (input & ˜GF_MASK) << 1;
result #\hat{ }= (flag * 0x1b);
return result;

}

The table lookup implementation of GF2 multiplication requires 1 arithmetic instruction and 2 table lookup instructions consuming 3 clock cycles. Thus, with the GF2 multiplication being performed 9 out of 10 rounds, 4 times per round, it results in 108 clocks per block being consumed for the GF2 in software (assuming a key size of 128 bits.) GF2_MULT may be replaced by a UDI instruction, and GF3 may be obtained by an exclusive-or with GF2. The GF2_MULT function would be replaced by a UDI instruction in the software that is executed like the following:

GF2 (word1, GF2_word1);
GF2 (word2, GF2_word2);
GF2 (word3, GF2_word3);
GF2 (word4, GF2_word4);

Performing the GF2 in hardware also removes the need to store the results in memory saving another instruction per GF2. Each result would be obtained after 1 clock cycle saving 3 clock cycles per GF2. Using a 128-bit key, the GF2 instruction for the encoder will be issued 36 times per block replacing the original:

1) 320 table lookups

2) 160 additions

Another significant processing burden is the non-linear substitution lookup preformed across 16 bytes at the start of each round. The MIPS architecture is a RISC architecture employing an instruction set which only performs operations on data in registers. Without being able to operate on memory directly, the software implementation suffers due to the constant load/store action occurring from the substitution lookup and byte manipulation:

row1[0] = SBOX[buffer[0]];
row1[1] = SBOX[buffer[1]];
row1[2] = SBOX[buffer[2]];
row1[3] = SBOX[buffer[3]];
row2[3] = SBOX[buffer[4]];
row2[0] = SBOX[buffer[5]];
row2[1] = SBOX[buffer[6]];
row2[2] = SBOX[buffer[7]];
row3[2] = SBOX[buffer[8]];
row3[3] = SBOX[buffer[9]];
row3[0] = SBOX[buffer[10]];
row3[1] = SBOX[buffer[11]];
row4[1] = SBOX[buffer[12]];
row4[2] = SBOX[buffer[13]];
row4[3] = SBOX[buffer[14]];
row4[0] = SBOX[buffer[15]];

Before the substitution lookup, each byte must be moved into a specific position in each row. All together, the substitution lookups and byte merging accounts for over half of the processing per round. This may be improved through UDI instructions, which would perform the SBOX lookups 4 bytes at a time and byte manipulation in hardware.

The byte manipulation may be split into 2 groups of instructions. The first form of manipulation involves byte transposition. These instructions will be used to shift the data from being held as rows to being held as columns or vice-versa. For example, at the start of the encoder algorithm, the data must shifted from a normal buffer to the state array:

| | |
|---|---|
| Data | State Array |

| | | | | | | | |
|---|---|---|---|---|---|---|---|
| s0 | s1 | s2 | s3 | s0 | s4 | s8 | s12 |
| s4 | s5 | s6 | s7 | s1 | s5 | s9 | s13 |
| s8 | s9 | s10 | s11 | s2 | s6 | s10 | s14 |
| s12 | s13 | s14 | s15 | s3 | s7 | s11 | S15 |

To perform this transposition, UDI instructions may be implemented in the following fashion to increase performance by saving cycles consumed by the transposition:

d0-d15 are 16 bytes of data to be transposed

| | | | | | |
|---|---|---|---|---|---|
| d0 | d1 | d2 | d3 | ≡ | $s0 |
| d4 | d5 | d6 | d7 | ≡ | $s1 |
| d8 | d9 | d10 | d11 | ≡ | $s2 |
| d12 | d13 | d14 | d15 | ≡ | $s3 |

| | | | |
|---|---|---|---|
| T2A | $t0, $s0, $s1 | // d0, d4, d2, d6 ≡ $t0 | 1st and 3rd bytes |
| T2B | $s1, $s0, $s1 | // d1, d5, d3, d7 ≡ $s1 | 2nd and 4th bytes |
| T2A | $t1, $s2, $s3 | // d8, d12, d10, d14 ≡ $t1 | 1st and 3rd bytes |
| T2B | $s3, $s2, $s3 | // d9, d13, d11, d15 ≡ $s3 | 2nd and 4th bytes |
| T4A | $s0, $t0, $t1 | // d0, d4, d8, d12 ≡ $s0 | 1st two bytes from |
| | | | each register |
| T4B | $s2, $t0, $t1 | // d2, d6, d10, d14 ≡ $s2 | 2nd two bytes from |
| | | | each register |
| T4A | $t1, $s1, $s3 | // d1, d5, d9, d13 ≡ $t1 | |
| T4B | $s3, $s1, $s3 | // d3, 67, d11, d15 ≡ $s3 | |

The C-code for the entire transposition looks like this:

ByteTransposition (char* data, char* state) {

state [0] = data [0];
state [1] = data [4];
state [2] = data [8];
state [3] = data [12];
state [4] = data [1];
state [5] = data [5];
state [6] = data [9];
state [7] = data [13];
state [8] = data [2];
state [9] = data [6];
state [10] = data [10];
state [11] = data [14];
state [12] = data [3];
state [13] = data [7];
state [14] = data [11];
state [15] = data [15];

}

The second type of byte manipulation requires a byte rotation by 1, 2, or 3 bytes to the right. The MIPS instruction set contains a simulated bit rotation, but at compile time the simulated instruction expands to 4 hardware instructions. A UDI instruction, rbr, is defined to handle byte rotation according to the following example:

| | | |
|---|---|---|
| rbr $d1, $s1, 1 | // d5, d6, d7, d4 ≡ $d1 | rotate right by 1 byte |
| rbr $d1, $s1, 2 | // d10, d11, d8, d9 ≡ $d2 | rotate right by 2 bytes |
| rbr $d1, $s1, 3 | // d15, d12, d13, d14 ≡ $d3 | rotate right by 3 bytes |

The C-code for the byte rotation looks like this:

ByteRotation (unsigned char* data, unsigned char* state) {

state [0] = data [0];
state [1] = data [1];
state [2] = data [2];
state [3] = data [3];
state [4] = data [5];
state [5] = data [6];
state [6] = data [7];
state [7] = data [4];
state [8] = data [10];
state [9] = data [11];
state [10] = data [8];
state [11] = data [9];
state [12] = data [15];
state [13] = data [12];
state [14] = data [13];
state [15] = data [14];

}

The SBOX substitution lookup may be implemented in hardware to perform the lookups for the data provided as a source operand for the UDI instruction. The SBOX data for the lookup may be held in a ROM as a part of the hardware. When each byte comes in, it is immediately used as the offset to the ROM and the results are saved to a destination register specified in the UDI instruction. Using this technique, the SBOX lookup is able to operate on 4 bytes at a time in parallel. The C-code for this UDI instruction would look like:

unsigned long SBOX (unsigned long src) {

unsigned long tmp;
unsigned char tmp_mem [4], tmp_src [4];
unsigned long* ptr_src;
ptr_src = (unsigned long*)tmp_src;
*ptr_src = src;
tmp_mem [0] = SBOX [tmp_src [0]];
tmp_mem [1] = SBOX [tmp_src [1]];
tmp_mem [2] = SBOX [tmp_src [2]];
tmp_mem [3] = SBOX [tmp_src [3]];
return *ptr_src;

}

The assembly code for this implementation using these UDI instructions is as follows:

// start of AES encode primitives
// extended key is assumed to be already calculated according to key expansion routine
// and has been permuted
// loop for each block of data
loop:

// xor key
lw $data1, 0($buffer)
lw $data2, 4($buffer)
lw $data3, 8($buffer)
lw $data4, 12($buffer)
lw $key1, 0($extended_key)
lw $key2, 4($extended_key)
lw $key3, 8($extended_key)
lw $key4, 12($extended_key)
xor $data1, $data1, $key1
xor $data2, $data2, $key2
xor $data3, $data3, $key3
xor $data4, $data4, $key4
add $extended_key, $extended_key, 16

// perform preamble

| // 8 transpose UDI instructions | |
|---|---|
| t2a $t0, $data1, $data2 | // 1st and 3rd bytes |
| t2b $data2, $data1, $data2 | // 2nd and 4th bytes |
| t2a $t1, $data3, $data4 | // 1st and 3rd bytes |
| t2b $data4, $data3, $data4 | // 2nd and 4th bytes |
| t4a $data1, $t0, $t1 | // 1st two bytes from each register |
| t4b $data3, $t0, $t1 | // 2nd two bytes from each register |
| t4a $t1, $data2, $data4 | // 1st two bytes from each register |
| t4b $data4, $data2, $data4 | // 2nd two bytes from each register |
| // 3 rotate UDI instructions | |
| rbr1 $data2, $data2 | |
| rbr2 $data3, $data3 | |
| rbr3 $data4, $data4 | |
| sbox $data1, $data1 | |
| sbox $data2, $data2 | // splits word into bytes and does s_box lookup |
| | // 4 bytes at a time into same positions |
| sbox $data3, $data3 | |
| sbox $data4, $data4 | // from rom on each byte |
| gf2 $GF2_data1, $data1 | |
| gf2 $GF2_data2, $data2 | |
| gf2 $GF2_data3, $data3 | |
| gf2 $GF2_data4, $data4 | |
| xor $GF3_data1, $GF2_data1, $data1 | |
| xor $GF3_data2, $GF2_data2, $data2 | |
| xor $GF3_data3, $GF2_data3, $data3 | |
| xor $GF3_data4, $GF2_data4, $data4 | |
| lw $key1, 0($extended_key) | |
| lw $key2, 4($extended_key) | |
| lw $key3, 8($extended_key) | |
| lw $key4, 12($extended_key) | |
| add $extended_key, $extended_key, 16 | |
| xor $tmp, $key1, $data3 | |
| xor $tmp, $tmp, $data4 | |
| xor $tmp, $tmp, $GF3_data2 | |
| xor $result1, $tmp, $GF2_data1 | // first answer for preamble in $result1 |
| xor $tmp, $key2, $data4 | |
| xor $tmp, $tmp, $data3 | |
| xor $tmp, $tmp, $GF3_data3 | |
| xor $result2, $tmp, $GF2_data2 | |
| xor $tmp, $key3, $data1 | |
| xor $tmp, $tmp, $data2 | |
| xor $tmp, $tmp, $GF3_data4 | |
| xor $result3, $tmp, $GF2_data3 | |
| xor $tmp, $key4, $data3 | |
| xor $tmp, $tmp, $data2 | |
| xor $tmp, $tmp, $GF3_data1 | |
| xor $result4, $tmp, $GF2_data4 | |
| move $inner_loop_counter, 8 | |

// main loop (8×)
inner_loop:

| // shift data 3 rotate instructions | |
|---|---|
| rbr1 $data2, $result2 | |
| rbr2 $data3, $result3 | |
| rbr3 $data4, $result4 | |
| sbox $data1, $result1 | |
| sbox $data2, $data2 | // splits word into bytes and does s_box lookup |
| | // 4 bytes at a time into same positions |
| sbox $data3, $data3 | |
| sbox $data4, $data4 | // from rom on each byte |
| gf2 $GF2_data1, $data1 | |
| gf2 $GF2_data2, $data2 | |
| gf2 $GF2_data3, $data3 | |
| gf2 $GF2_data4, $data4 | |
| xor $GF3_data1, $GF2_data1, $data1 | |
| xor $GF3_data2, $GF2_data2, $data2 | |
| xor $GF3_data3, $GF2_data3, $data3 | |
| xor $GF3_data4, $GF2_data4, $data4 | |
| lw $key1, 0($extended_key) | |
| lw $key2, 4($extended_key) | |
| lw $key3, 8($extended_key) | |
| lw $key4, 12($extended_key) | |
| add $extended_key, $extended_key, 16 | |
| xor $tmp, $key1, $data3 | |
| xor $tmp, $tmp, $data4 | |
| xor $tmp, $tmp, $GF3_data2 | |
| xor $result1, $tmp, $GF2_data1 | // first answer for this round in $result1 |
| xor $tmp, $key2, $data4 | |
| xor $tmp, $tmp, $data3 | |
| xor $tmp, $tmp, $GF3_data3 | |
| xor $result2, $tmp, $GF2_data2 | |
| xor $tmp, $key3, $data1 | |
| xor $tmp, $tmp, $data2 | |
| xor $tmp, $tmp, $GF3_data4 | |
| xor $result3, $tmp, $GF2_data3 | |
| xor $tmp, $key4, $data3 | |
| xor $tmp, $tmp, $data2 | |
| xor $tmp, $tmp, $GF3_data1 | |
| xor $result4, $tmp, $GF2_data4 | |

sub $inner_loop_counter, $inner_loop_counter, 1
bne $inner_loop_counter, inner_loop
// end of main loop

// perform post amble

| // shift data - 3 rotate instructions | |
|---|---|
| rbr1 $data2, $result2 | |
| rbr2 $data3, $result3 | |
| rbr3 $data4, $result4 | |
| // transpose - 8 instructions | |
| t2a $t0, $result1, $data2 | // 1st and 3rd bytes |

| | |
|---|---|
| t2b $data2, $result1, $data2 | // 2nd and 4th bytes |
| t2a $t1, $data3, $data4 | // 1st and 3rd bytes |
| t2b $data4, $data3, $data4 | // 2nd and 4th bytes |
| t4a $data1, $t0, $t1 | // 1st two bytes from each register |
| t4b $data3, $t0, $t1 | // 2nd two bytes from each register |
| t4a $t1, $data2, $data4 | // 1st two bytes from each register |
| t4b $data4, $data2, $data4 | // 2nd two bytes from each register |
| sbox $data1, $data1 | |
| sbox $data2, $data2 | |
| sbox $data3, $data3 | |
| sbox $data4, $data4 | |
| lw $key1, 0($extended_key) | // xor key with data |
| lw $key2, 4($extended_key) | |
| lw $key3, 8($extended_key) | |
| lw $key4, 12($extended_key) | |
| xor $result1, $data1, $key1 | |
| xor $result2, $data2, $key2 | |
| xor $result3, $data3, $key3 | |
| xor $result4, $data4, $key4 | |

| | |
|---|---|
| sub $extended_key, $extended_key, 160 | // put extended_key back to 0 |

| | |
|---|---|
| add $buffer, $buffer, 16 | // increment the data pointer to the next block |

sub $num_of_blocks, $num_of_blocks, 1
bne $num_of_blocks, loop

// end of AES encode primitives

The number of cycles saved for this implementation is substantial because there are enough registers to eliminate the need to save data to memory. For a 128-bit key, a block consumes 393 cycles and encoding a megabit of data would take 3.1 MIPS. For a 192-bit key, a block would consume 470 cycles and 3.7 MIPS. A 256-bit key would consume 546 cycles and 4.3 MIPS. For each additional step in key size, this implementation requires 0.6 additional MIPS.

3.3 UDI AES Encode Round Accelerator

The major processing of the AES algorithm may be executed almost entirely using UDI instructions accessing the AES Encode Round Accelerator hardware. The hardware acceleration implementation operates with all key sizes as longer keys simply involve more iterations of the main loop. It combines the use of the GF2 and SBOX substitution instructions and replaces all of the processing for each iteration of the main loop.

The SBOX substitution lookup may be implemented in hardware to perform the lookups as soon as the data is loaded into the accelerator registers. The SBOX data for the lookup may be held on a ROM as a part of the hardware. When the data comes in, it is immediately used as the offset to the ROM, and the results are saved in a separate register. Hence, the processor can finish loading the key (or data buffer) from memory while the substitution is taking place. The byte merging for each loop will take place automatically as it is a simple step in hardware to place the bytes into the correct positions.

The byte transposition for the beginning and end of the block will be assisted through the use multiplexers to select to perform the transposition. For the first round, the data will be exclusive-or'd with the key and then transposed. For the final round, the GF multiplication hardware will be bypassed and the transposition will take place instead.

The start of an iteration of the main loop using this implementation begins as follows: Four words of the buffer array (or data buffer for the main loop) will be loaded into registers. At this point, the UDI hardware instruction takes a word of the buffer array passed in and uses each byte as the index to the lookup on the ROM. Each resulting byte is placed so that the byte splitting and merging happens automatically. The results are the rows for the next UDI instruction. Then the GF2 and GF3 hardware instructions are carried out in hardware on the results from the byte merging. This happens automatically. The results from the SBOX, GF2, and GF3 are all held in designated internal hardware registers. These registers are then exclusive-or'd with a word from the extended_key to obtain a word of the result.

Using hardware UDI instructions for the substitution lookup, the byte merging, the GF2 multiplication, and the exclusive-or operations, an iteration of the main loop would execute as follows:

| | |
|---|---|
| // main loop | |
| aes_enc_rnd_in_1 $buffer1, $buffer2 | // supply 8 bytes at a |
| | time into AES |
| | accelerator |
| aes_enc_rnd_in_2 $buffer3, $buffer4 | |
| lw $key1 from $extended_key with offset 0 | |
| lw $key2 from $extended_key with offset 4 | |
| lw $key3 from $extended_key with offset 8 | |
| lw $key4 from $extended_key with offset 12 | |
| add $extended_key, $extended_key, 16 | |
| aes_enc_rnd_out_1 $buffer1, $key1 | // perform the multiple |
| | byte based xor's |
| aes_enc_rnd_out_2 $buffer2, $key2 | |
| aes_enc_rnd_out_3 $buffer3, $key3 | |
| aes_enc_rnd_out_4 $buffer4, $key4 | |
| // end of iteration of main loop | |

The aes_enc_in_{—}1/2 instructions would be issued to start the SBOX substitution, the byte merging, the GF2_MULT, and the GF3_MULT. Next, the key can be loaded into registers. Once the key is loaded, the final exclusive-or can be performed using the aes_enc_out_{—}1/2/3/4 UDI instructions giving the results for the loop iteration.

The code for this implementation is as follows:

// start of AES encode round accelerator
// the key is assumed to already be expanded and permuted according to the key expansion routine
// outside loop for each block of data
loop:
// perform preamble

lw $key1, 0($extended_key)
lw $key2, 4($extended_key)
lw $key3, 8($extended_key)
lw $key4, 12($extended_key)
add $extended_key, $extended_key, 16
lw $data1, 0($buffer)
lw $data2, 4($buffer)
lw $data3, 8($buffer)
lw $data4, 12($buffer)
aes_enc_rnd_pre_in_1 $data1, $key1
aes_enc_rnd_pre_in_2 $data2, $key2
aes_enc_rnd_pre_in_3 $data3, $key3
aes_enc_rnd_pre_in_4 $data4, $key4
move $inner_loop_counter, 9

// inner loop 9× per block
inner_loop:

| lw $key1, 0($extended_key) | |
|---|---|
| lw $key2, 4($extended_key) | |
| lw $key3, 8($extended_key) | |
| lw $key4, 12($extended_key) | |
| add $extended_key, $extended_key, 16 | |
| aes_enc_rnd_out_1 $data1, $key1 | // in hardware xor extkey1 with |
| | // GF2_row1\hat{ }GF3_row2\hat{ }row4\hat{ }row3 |
| | // (all buried state, 32-bit words) |
| | // answer in $buffer1 |
| aes_enc_rnd_out_2 $data2, $key2 | // in hardware xor extkey1 with |
| | // GF2_row2\hat{ }GF3_row3\hat{ }row1\hat{ }row4 |
| aes_enc_rnd_out_3 $data3, $key3 | // in hardware xor extkey1 with |
| | // GF2_row3\hat{ }GF3_row4\hat{ }row2\hat{ }row1 |
| aes_enc_rnd_out_4 $data4, $key4 | // in hardware xor extkey1 with |
| | // GF2_row4\hat{ }GF3_row1\hat{ }row2\hat{ }row3 |
| aes_enc_rnd_in_1 $data1, $data2 | // splits word into bytes and does the SBOX lookup |
| aes_enc_rnd_in_2 $data3, $data4 | // from rom on each byte, result is in internal registers |

sub $inner_loop_counter, $inner_loop_counter, 1
bne $inner_loop_counter, inner_loop
// end of main loop

// perform postamble

| lw $key1, 0($extended_key) | |
|---|---|
| lw $key2, 4($extended_key) | |
| lw $key3, 8($extended_key) | |
| lw $key4, 12($extended_key) | |
| aes_enc_rnd_post_out_1 $data1, $extkey1 | |
| aes_enc_rnd_post_out_2 $data2, $extkey2 | |
| aes_enc_rnd_post_out_3 $data3, $extkey3 | |
| aes_enc_rnd_post_out_4 $data4, $extkey4 | |
| sub $extended_key, $extended_key, 40; | |
| add $buffer, $buffer, 16 | // increment the data pointer to the next block |

sub $num_of_blocks, $num_of_blocks, 1
bne $num_of_blocks, loop

// end of AES encode round accelerator

The main loop consumes only 10 cycles. For a 128-bit key, the main loop will be executed 9 times per block for a total of 117 cycles and a megabit only consumes 0.91 MIPS. For a 192-bit key, a block consumes 137 cycles and 1.1 MIPS. A 256-bit key implementation consumes 157 cycles and 1.2 MIPS.

3.4 UDI AES Encode 32-bit Block Accelerator

An additional improvement to the encoder may be obtained by using the AES Encode 32-bit Block Accelerator hardware. The block accelerator implementation operates with all key sizes as longer keys simply involve executing more iterations of the main loop. The block accelerator operates almost the same as the round accelerator. The difference from the round accelerator is that the result from the end of each round is kept in the accelerator hardware and forwarded to start the next round without leaving the hardware.

The SBOX substitution lookup, byte merging, byte transposition, and GF multiplication will be performed as in the implementation of the round accelerator. When a 32-bit result is obtained at the end of a round, it is fed as an input to the beginning of the round, and the hardware will continue until all four results are obtained. Each of the first three results are double buffered to protect them from corrupting the later results which the hardware is still calculating. This puts less stress on the processor since it is no longer loading and reading data from the dedicated hardware.

During each block, the key will be fed into the accelerator two words at a time. The key will also be double buffered allowing for the key to be loaded into the engine at the same time as the key from the previous round is still being used. The GF multiplications are executed immediately, and the 32-bit result is fed back to the beginning. The substitution lookup and byte rotation is then performed. Since the processor is not performing any operations with the destination register during this time, a single load from the key memory into a register may be performed at the same time. This helps decrease the amount time the processor is idle.

After the initial round where the data and key are written to the hardware, a single round executes as follows:

// main loop

| | |
|---|---|
| aes_enc_blk_key_1 $key_c, $key_d | // write two key words |
| | to hardware |
| lw $key_b from $extended_key | // key_a and key_c |
| | have already been |
| | loaded into |

registers

| | |
|---|---|
| aes_enc_blk_key_2 $key_a, $key_b | // write two key words |
| | to hardware |
| lw $key_d from $extended_key | |
| // end of iteration | |

The aes_enc_blk_key1/2 instructions are used to write 2 key words to the hardware. One of those key words would be exclusive-or'd during that instruction cycle to obtain a result. The other key word would be used during the next cycle (during the 2nd load from $extended_key).

This code for this implementation is as follows:

// start of AES 32-bit encode block accelerator
// extended key is assumed to be already
calculated according to key expansion routine
// and has been permuted
// start by loading 17 of the keys into registers

lw $key_0, 0($extended_key)
lw $key_8, 8($extended_key)
lw $key_16, 16($extended_key)
lw $key_24, 24($extended_key)
lw $key_32, 32($extended_key)
lw $key_40, 40($extended_key)
lw $key_48, 48($extended_key)
lw $key_56, 56($extended_key)
lw $key_64, 64($extended_key)
lw $key_72, 72($extended_key)
lw $key_80, 80($extended_key)
lw $key_88, 88($extended_key)
lw $key_96, 96($extended_key)
lw $key_104, 104($extended_key)
lw $key_112, 112($extended_key)
lw $key_120, 120($extended_key)
lw $key_128, 128($extended_key)
lw $key_136, 136($extended_key)

loop:

lw $key_b, 4($extended_key)
lw $key_d, 12($extended_key)

// xor key and data

| lw $data1, 0($buffer) | |
|---|---|
| lw $data2, 4($buffer) | |
| aes_enc_blk_in_1 $data1, $key_0 | // put data |
| | word into |
| | hw engine |
| aes_enc_blk_in_2 $data2, $key_b | // and xor w/ key |
| lw $data3, 8($buffer) | |
| lw $data4, 12($buffer) | |
| aes_enc_blk_in_3 $data3, $key_b | |
| aes_enc_blk_in_4 $data4, $key_d | |
| lw $key_b, 20($extended_key) | |
| lw $key_d, 28($extended_key) | |

// 1st round - end of preamble

| | |
|---|---|
| aes_dec_blk_key_1 $key_16, $key_b | // row1 |
| lw $key_b, 36($extended_key) | // row2 |
| aes_dec_blk_key_2 $key_24, $key_d | // row3 |
| lw $key_d, 44($extended_key) | // row4 |

// 2nd round

aes_dec_blk_key_1 $key_32, $key_b
lw $key_b, 52($extended_key)
aes_dec_blk_key_2 $key_40, $key_d
lw $key_d, 60($extended_key)

// 3rd round

aes_dec_blk_key_1 $key_48, $key_b
lw $key_b, 68($extended_key)
aes_dec_blk_key_2 $key_56, $key_d
lw $key_d, 76($extended_key)

// 4th round

aes_dec_blk_key_1 $key_64, $key_b
lw $key_b, 84($extended_key)
aes_dec_blk_key_2 $key_72, $key_d
lw $key_d, 92($extended_key)

// 5th round

aes_dec_blk_key_1 $key_80, $key_b
lw $key_b, 100($extended_key)
aes_dec_blk_key_2 $key_88, $key_d
lw $key_d, 108($extended_key)

// 6th round

aes_dec_blk_key_1 $key_96, $key_b
lw $key_b, 116($extended_key)
aes_dec_blk_key_2 $key_104, $key_d
lw $key_d, 124($extended_key)

// 7th round

aes_dec_blk_key_1 $key_112, $key_b
lw $key_b, 132($extended_key)
aes_dec_blk_key_2 $key_120, $key_d
lw $key_c, 136($extended_key)
lw $key_d, 140($extended_key)

// 8th round

aes_dec_blk_key_1 $key_128, $key_b
lw $key_a, 144($extended_key)
lw $key_b, 148($extended_key)
aes_dec_blk_key_2 $key_c, $key_d
lw $key_c, 152($extended_key)
lw $key_d, 156($extended_key)

// 9th round

aes_dec_blk_key_1 $key_a, $key_b
lw $key_a, 160($extended_key)
lw $key_b, 164($extended_key)
aes_dec_blk_key_2 $key_c, $key_d
lw $key_c, 168($extended_key)
lw $key_d, 172($extended_key)

// postamble

aes_enc_blk_out_1 $result1, $key_a
sw $result1, 0($buffer)
aes_enc_blk_out_2 $result2, $key_b
sw $result2, 4($buffer)
aes_enc_blk_out_3 $result3, $key_c
sw $result3, 8($buffer)
aes_enc_blk_out_4 $result4, $key_d
sw$result4, 12($buffer)
addi $buffer, $buffer, 16
sub $num_of_blocks, $num_of_blocks, 1
bne $num_of_blocks, loop

// end of AES 32-bit encode block accelerator

Using this implementation requires only 4 instructions for most of the rounds where the key is already held in a register. For a 128-bit key, a block consumes 64 cycles and encoding a megabit of data requires 0.50 MIPS. For a 192-bit key, a block consumes 76 cycles and requires 0.59 MIPS. For a 256-bit key, a block consumes 88 cycles and 0.69 MIPS. For each step in key size this implementation requires an additional 0.09 MIPS.

3.5 AES Encode 32-bit Co-Processor

The UDI AES Encode 32-bit Co-Processor hardware is a full-scale algorithm implementation. The hardware acceleration implementation requires only the key and data to be processed. It operates with all key sizes as longer keys simply involve initializing the loop counter for more iterations of the main loop. The co-processor implementation operates almost the same as the block accelerator except that the entire key is in already held in AES Encode local memory. The advantage over the block accelerator is that there is no need to feed the key into the hardware during round of the block being processed. (This approach may also be more secure in specific applications, as the key is not stored in any off chip memory.)

The SBOX substitution lookup, byte merging, byte transposition, and GF multiplications will be performed as in the implementation of the block and round accelerator. When a 32-bit result is obtained at the end of a round, it is fed as an input to the beginning of the next round, and the hardware will continue until all four results are obtained. Each of the first three results of a round are double buffered to protect them from corrupting the fourth result while the hardware is still calculating it. This puts less stress on the processor since it is no longer loading and receiving data to and from the dedicated hardware.

At the start of the first block, the key will be fed into the accelerator two words at a time. The key is stored in RAM where it will reside until the software needs to change to a different key. While processing a block, during each cycle, a key word is read from RAM. The CF multiplications are executed immediately and the 32-bit result is fed back to the beginning. The substitution lookup and byte rotation is then performed.

Once the data and the key have been written into the hardware, a single round will execute as follows:

// start of AES 32-bit encode co-processor
// extended key is already calculated according to key expansion
routine and permuted

| aes_enc_cop_key_rst | // resets key_addr_p to 0 |
|---|---|
| lw $key_a, 0($extended_key) | |
| lw $key_b, 4($extended_key) | |
| lw $key_c, 8($extended_key) | |
| lw $key_d, 12($extended_key) | |
| aes_enc_cop_key $key_a, $key_b | // stores key to RAM and |
| | inc key_addr_p by 1 |
| lw $key_a, 16($extended_key) | |
| lw $key_b, 20($extended_key) | |
| aes_enc_cop_key $key_c, $key_d | |
| lw $key_c, 24($extended_key) | |
| lw $key_d, 28($extended_key) | |
| aes_enc_cop_key $key_a, $key_b | |
| lw $key_a, 32($extended_key) | |
| lw $key_b, 36($extended_key) | |
| aes_enc_cop_key $key_c, $key_d | |
| lw $key_c, 40($extended_key) | |
| lw $key_d, 44($extended_key) | |
| aes_enc_cop_key $key_a, $key_b | |
| lw $key_a, 48($extended_key) | |
| lw $key_b, 52($extended_key) | |
| aes_enc_cop_key $key_c, $key_d | |
| lw $key_c, 56($extended_key) | |
| lw $key_d, 60($extended_key) | |
| aes_enc_cop_key $key_a, $key_b | |
| lw $key_a, 64($extended_key) | |
| lw $key_b, 68($extended_key) | |
| aes_enc_cop_key $key_c, $key_d | |
| lw $key_c, 72($extended_key) | |
| lw $key_d, 76($extended_key) | |
| aes_enc_cop_key $key_a, $key_b | |
| lw $key_a, 80($extended_key) | |
| lw $key_b, 84($extended_key) | |
| aes_enc_cop_key $key_c, $key_d | |
| lw $key_c, 88($extended_key) | |
| lw $key_d, 92($extended_key) | |
| aes_enc_cop_key $key_a, $key_b | |
| lw $key_a, 96($extended_key) | |
| lw $key_b, 100($extended_key) | |
| aes_enc_cop_key $key_c, $key_d | |
| lw $key_c, 104($extended_key) | |
| lw $key_d, 108($extended_key) | |
| aes_enc_cop_key $key_a, $key_b | |
| lw $key_a, 112($extended_key) | |
| lw $key_b, 116($extended_key) | |
| aes_enc_cop_key $key_c, $key_d | |
| lw $key_c, 120($extended_key) | |
| lw $key_d, 124($extended_key) | |
| aes_enc_cop_key $key_a, $key_b | |
| lw $key_a, 128($extended_key) | |
| lw $key_b, 132($extended_key) | |
| aes_enc_cop_key $key_c, $key_d | |
| lw $key_c, 136($extended_key) | |
| lw $key_d, 140($extended_key) | |
| aes_enc_cop_key $key_a, $key_b | |
| lw $key_a, 144($extended_key) | |
| lw $key_b, 148($extended_key) | |
| aes_enc_cop_key $key_c, $key_d | |
| lw $key_c, 152($extended_key) | |
| lw $key_d, 156($extended_key) | |
| aes_enc_cop_key $key_a, $key_b | |
| lw $key_a, 160($extended_key) | |
| lw $key_b, 164($extended_key) | |
| aes_enc_cop_key $key_c, $key_d | |
| lw $key_c, 168($extended_key) | |
| lw $key_d, 172($extended_key) | |
| aes_enc_cop_key $key_a, $key_b | |
| aes_enc_cop_loop 9 | // initialize hdw |

loop counter

aes_enc_cop_key $key_c, $key_d
// main loop

loop:

| lw $data1, 0($buffer) | |
|---|---|
| lw $data2, 4($buffer) | |
| aes_enc_cop_in_1 $data1 | // reset the key and put |
| | data into hw engine |
| lw $data3, 8($buffer) | |
| aes_enc_cop_in_2 $data2 | |
| lw $data4, 12($buffer) | |
| aes_enc_cop_in_3 $data3 | |
| aes_enc_cop_in_4 $data4 | |
| 36 nops | // processor needs to wait |
| | 36 cycles for results |
| aes_enc_cop_out_1 $result1 | // obtain resulting |

encoded words

aes_enc_cop_out_2 $result2
aes_enc_cop_out_3 $result3
aes_enc_cop_out_4 $result4
sw $result1, 0($buffer)
sw $result2, 4($buffer)
sw $result3, 8($buffer)
sw $result4, 12($buffer)
addi $buffer, $buffer, 16
sub $num_of_blocks, $num_of_blocks, 1
bne $num_of_blocks
// end of iteration

// end of AES encode 32-bit co-processor

Since the processor is not performing any functions while it is waiting for the results, it can begin loading up the data for the next block and store the encoded data from the previous block. This allows the processor to do some work and save cycles. The code for this implementation beginning with the start of the block processing would be as follows:

| | |
|---|---|
| aes_enc_cop_loop 9 | // initialize hdw |

loop counter

// start of first block

| lw $data1, 0($buffer) | |
|---|---|
| lw $data2, 4($buffer) | |
| lw $data3, 8($buffer) | |
| lw $data4, 12($buffer) | |
| aes_enc_cop_in_1 $data1 | // put data into |
| | hw engine |
| aes_enc_cop_in_2 $data2 | |
| aes_enc_cop_in_3 $data3 | |
| aes_enc_cop_in_4 $data4 | |
| lw $data1, 16($buffer) | // start of 36 |
| | cycles |
| lw $data2, 20($buffer) | |
| lw $data3, 24($buffer) | |
| lw $data4, 28($buffer) | |
| sub $num_of_blocks, $num_of_blocks, 1 | |
| 31 nops | // end of 36 cycles |
| aes_enc_cop_out_1 $result1 | // obtain resulting |

encoded words

aes_enc_cop_out_2 $result2
aes_enc_cop_out_3 $result3
aes_enc_cop_out_4 $result4

loop:

| aes_enc_cop_in_1 $data1 | // resets key_addr_p to 0 |
|---|---|
| aes_enc_cop_in_2 $data2 | |
| aes_enc_cop_in_3 $data3 | |
| aes_enc_cop_in_4 $data4 | |
| sw $result1, 0($buffer) | // start of 36 cycles |
| sw $result2, 4($buffer) | |
| sw $result3, 8($buffer) | |
| sw $result4, 12($buffer) | |
| addi $buffer, $buffer, 16 | |
| lw $data1, 16($buffer) | |
| lw $data2, 20($buffer) | |
| lw $data3, 24($buffer) | |
| lw $data4, 28($buffer) | |
| sub $num_of_blocks, $num_of_blocks, 1 | |
| 26 nops | // end of 36 cycles |
| aes_enc_cop_out_1 $result1 | |
| aes_enc_cop_out_2 $result2 | |
| aes_enc_cop_out_3 $result3 | |
| aes_enc_cop_out_4 $result4 | |
| bne $num_of_blocks, loop | |
| sw $result1, 0($buffer) | // store final four |

encoded words

sw $result2, 4($buffer)
sw $result3, 8($buffer)
sw $result4, 12($buffer)

// end of AES encode 32-bit co-processor

The aes_enc_cop_key instructions would be used to write 2 key words at a time to hardware. The aes_enc_cop_loop instruction takes in an integer in the form of loop_cnt=num_of_main_loops+1. In this case, the loop_cnt should be initialized to 9 for a 128-bit key.

This implementation requires only 4 cycles per round. For a 128-bit key a block consumes 45 cycles and encoding a megabit of data only requires 0.35 MIPS. For a 192-bit key, a block consumes 53 cycles and requires 0.41 MIPS. For a 256-bit key, a block consumes 61 cycles and 0.48 MIPS. For each step in key size this implementation requires an additional 0.07 MIPS

3.6 AES Encode 64-bit Co-Processor

The UDI AES Encode 64-bit Co-Processor hardware is also a full-scale algorithm implementation. The hardware acceleration implementation requires only the key and data to be processed. It operates with all key sizes as longer keys simply involve initializing the loop counter for more iterations of the main loop. The 64-bit version of the co-processor implementation operates almost identically to the 32-bit version except that during each clock cycle two 32-bit results are obtained.

The SBOX substitution lookup, byte merging, byte transposition, and GF multiplication will be performed as in the implementation of the block accelerator. When the two 32-bit results are obtained at the end of a round, they are fed as part of the input to the beginning of the next round. The first two results of a round are double buffered to protect them from corrupting the third and fourth results, which the hardware is still calculating.

At the start of the first block, the key will be fed into the co-processor two words at a time. The key is stored in RAM where it will reside until the software needs to use a different key. During each cycle, two key words are read from RAM. The GF multiplications are executed immediately and two 32-bit results are fed back to the beginning. The substitution lookup and byte rotation is then performed, and the data is store in dedicated registers for the next clock cycle.

The code for this implementation, starting with the block processing is as follows:

| | |
|---|---|
| aes_enc_cop_loop 9 | // initialize hdw |
| | loop counter |
| // main loop | |

loop:

| lw $data1, 0($buffer) | |
|---|---|
| lw $data2, 4($buffer) | |
| lw $data3, 8($buffer) | |
| lw $data4, 12($buffer) | |
| aes_enc_cop_in_1 $result1, $data1, $data2 | // reset the key |
| | and put data |
| | into hw engine |
| aes_enc_cop_in_2 $result2, $data3, $data4 | |
| 18 nops | // processor needs |
| | to wait 18 cycles |
| | for results |
| // obtain resulting encoded words | |
| aes_enc_cop_out_3 $result3 | |
| aes_enc_cop_out_4 $result4 | |
| sw $result1, 0($buffer) | |
| sw $result2, 4($buffer) | |
| sw $result3, 8($buffer) | |
| sw $result4, 12($buffer) | |
| add $buffer, $buffer, 16 | |
| sub $num_of_blocks, $num_of_blocks, 1 | |
| bne $num_of_blocks, loop | |
| // end of iteration | |

// end of AES encode 64-bit co-processor

Since the processor is not performing any operations while it is waiting for the results, it can begin loading up the data for the next block and store the encoded data from the previous block. This allows the processor to do some work and save cycles instead of executing nops. The optimized code for this implementation would be as follows:

| | |
|---|---|
| aes_enc_cop_loop 9 | // initialize hdw loop counter |

// start of block

| lw $data1, 0($buffer) | |
|---|---|
| lw $data2, 4($buffer) | |
| lw $data3, 8($buffer) | |
| lw $data4, 12($buffer) | |
| aes_enc_cop_in_1 $zero, $data1, $data2 | // resets key_addr_p to 0 and puts data into hw |

engine

| aes_enc_cop_in_2 $zero, $data3, $data4 | |
|---|---|
| lw $data1, 16($buffer) | // start of 18 cycles |
| lw $data2, 20($buffer) | |
| lw $data3, 24($buffer) | |
| lw $data4, 28($buffer) | |
| sub $num_of_blocks, $num_of_blocks, 1 | |
| 13 nops | // end of 18 cycles |

loop:

| | |
|---|---|
| aes_enc_cop_in_1 $result1, $data1, $data2 | // resets key_addr_p to 0 |

| aes_enc_cop_in_2 $result2, $data3, $data4 | |
|---|---|
| aes_enc_cop_out_1 $result3 | |
| aes_enc_cop_out_2 $result4 | |
| sw $result1, 0($buffer) | // start of 18 cycles |
| sw $result2, 4($buffer) | |
| sw $result3, 8($buffer) | |
| sw $result4, 12($buffer) | |
| add $buffer, $buffer, 16 | |
| lw $data1, 16($buffer) | |
| lw $data2, 20($buffer) | |
| lw $data3, 24($buffer) | |
| lw $data4, 28($buffer) | |
| sub $num_of_blocks, $num_of_blocks, 1 | |
| 8 nops | // end of 18 cycles |
| aes_enc_cop_out_1 $result1 | |
| aes_enc_cop_out_2 $result2 | |
| aes_enc_cop_out_3 $result3 | |
| aes_enc_cop_out_4 $result4 | |
| bne $num_of_blocks, loop | |
| sw $result1, 0($buffer) | |
| sw $result2, 4($buffer) | |
| sw $result3, 8($buffer) | |
| sw $result4, 12($buffer) | |

// end of AES encode 64-bit co-processor

The aes_enc_blk_key instructions are used to write 2 key words to hardware as in the 32-bit co-processor implementation. The aes_enc_cop_loop instruction takes in an integer according to loop_cnt=num_of_main_loops+1. In this case, the loop_cnt should be initialized to 9 for a 128-bit key.

This implementation requires now only 2 cycles per round. For a 128-bit key, a block consumes 20 cycles and encoding a megabit of data requires only 0.16 MIPS. For a 192-bit key, a block consumes only 24 cycles and requires only 0.19 MIPS. For a 256-bit key, a block consumes 28 cycles and 0.22 MIPS. For each step in key size this implementation requires an additional 0.03 MIPS

3.7 AES Encode 128-bit Co-Processor

In the same fashion, the UDI AES Encode 64-bit Co-Processor can be modified to produce 128-bit results every clock cycle. Extending the Co-Processor to 128-bits results in a cleaner, straight through design. In this implementation, data is held in registers until an entire block is input into the hardware. The data is exclusive-or'd with the key on the first round and transposed. The data is then substituted from values in the SBOX ROM's and exclusive-or'd with values from the Galois Field blocks. At the end of each clock cycle one round of AES encryption is finished. The results are fed back to the beginning of the Co-Processor until all of the rounds are completed.

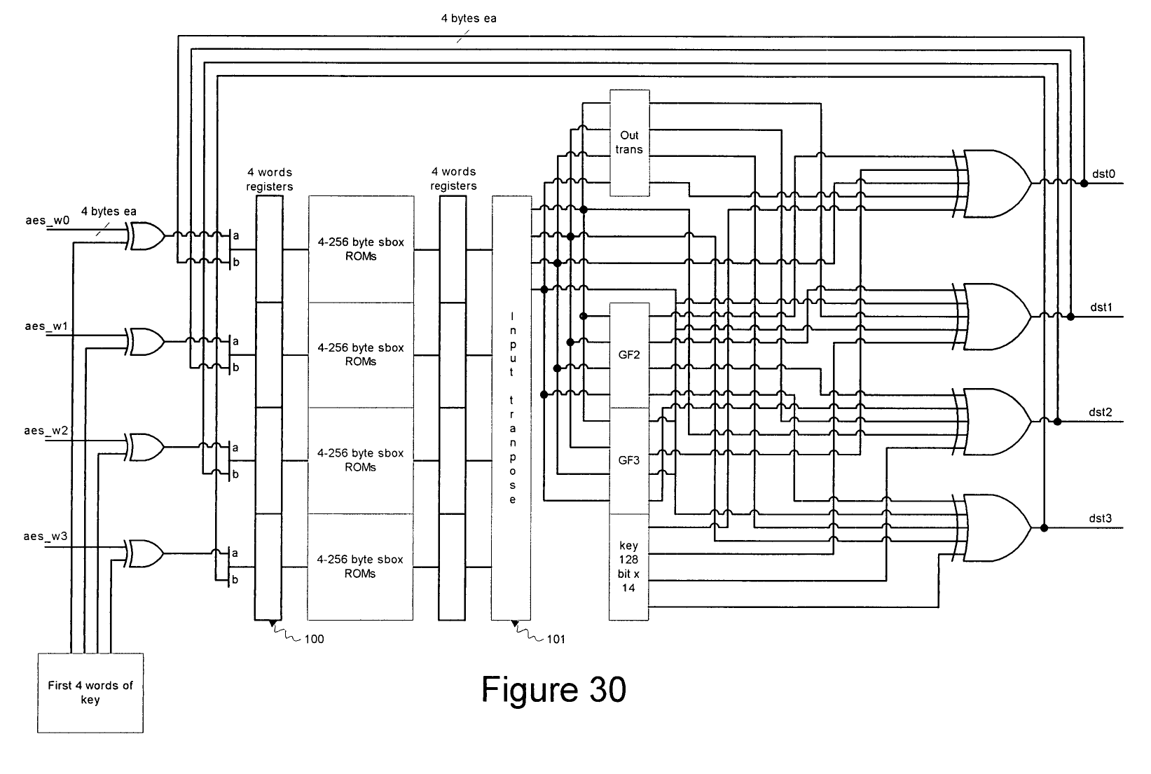

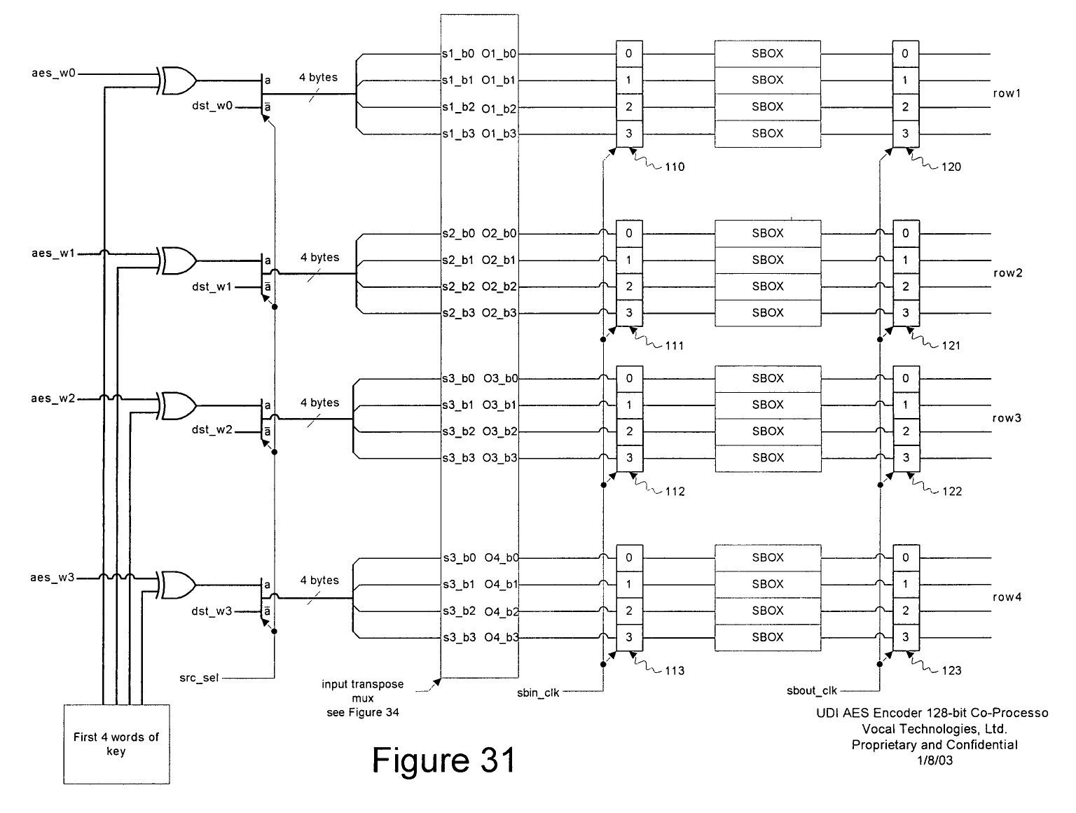

An alternative to this approach is to interleave the processing of AES blocks coming into the hardware by adding additional registers to create a pipelined architecture. The AES algorithm typically does not tolerate pipeline delays since all the data from one round must be completed prior to the computation of the next round. We exploit this fact as we perform the AES algorithm on two blocks of information to be encrypted. The two blocks may be similar, identical, sequential, or very different. (In the case of CCMP the blocks are similar in the fact that one block of data is used for both data sets, the only difference being that the second block is encrypting in CBC-MAC mode.) The first two blocks of data are loaded into the hardware two words at a time to prepare the Co-Processor for encryption. When the last of the data is input into the hardware, the next cycle starts the AES encryption on the first block. The data is exclusive-or'd with the key, transposed, and stored inside registers (sbin registers), which are the inputs to the SBOX ROM's. These registers are shown together as a group on FIG. 30 as element 100 and also individually on FIG. 31 as elements 110 through 113. On the second cycle of the encryption, the first block is sent to the SBOX ROM's where the results are stored to registers (sbout registers). These registers are shown together as a group on FIG. 30 as element 101 and also individually on FIG. 31 as elements 120 to 123. In the meantime, the second block begins its first cycle, the result of which is stored inside the sbin registers. The processing of the blocks continue in this way as the first block loops back to the beginning of the hardware and the second block goes to the SBOX ROM's. The data is interleaved to allow for higher clock rates because the SBOX ROM's consume the most amount of time and are the biggeset contributor to the critical path. This is an optimal time order for the combined computation of two AES blocks using interleaved hardware.

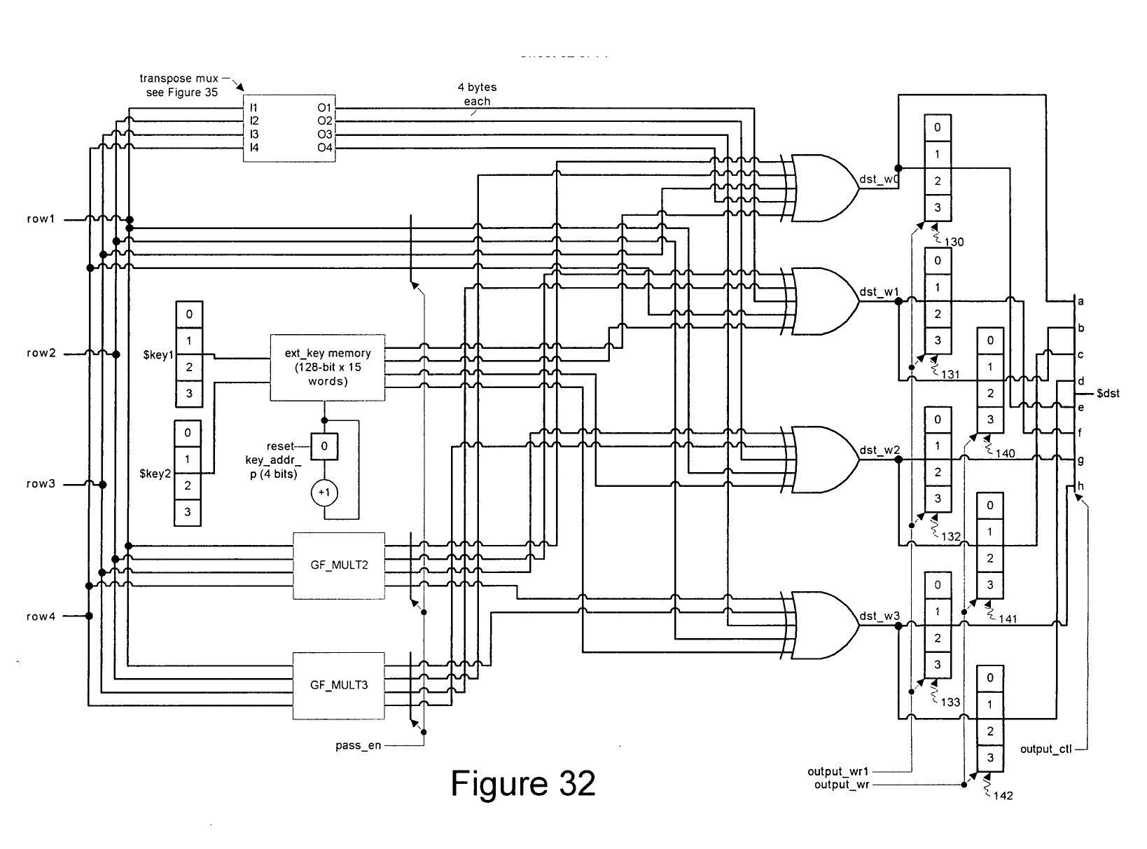

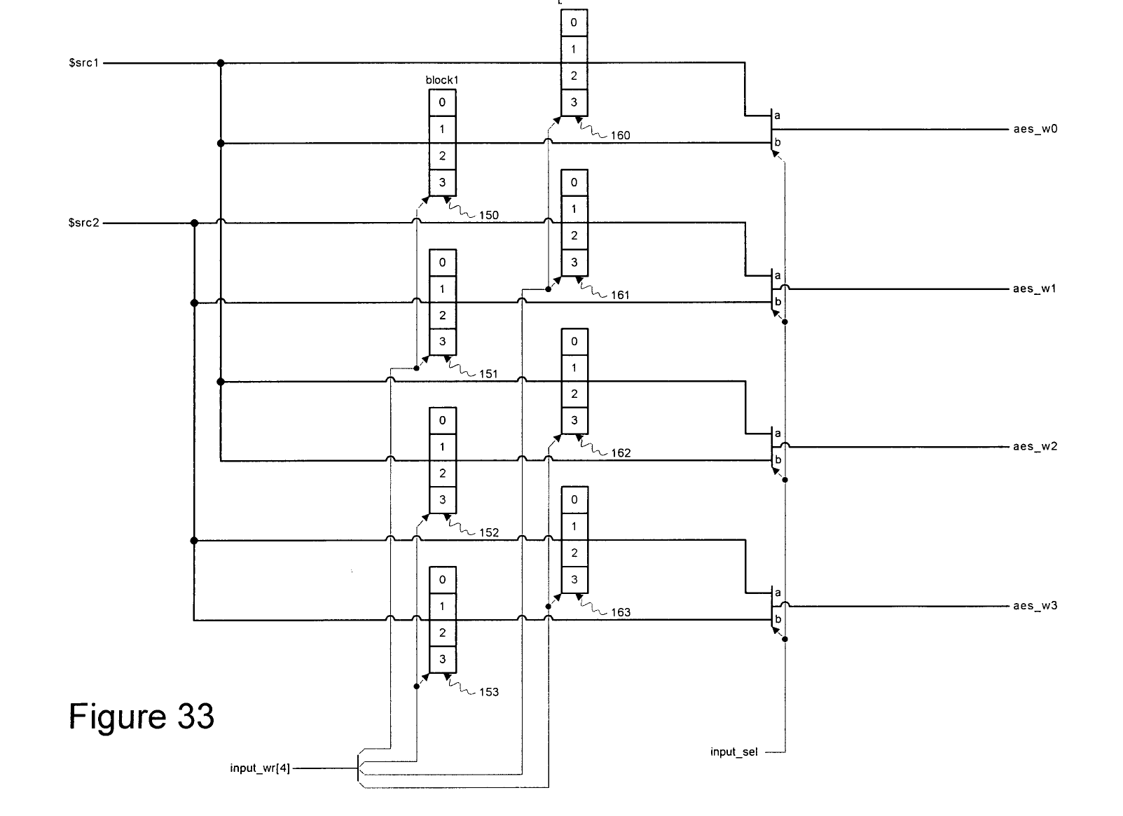

Using the interleaved implementation allows the processor to make use of 18 delay cycles during the AES encryption. During this time the processor can load new data from memory into registers, input the new data into the hardware, and also receive and store the results from the previous blocks. Additional internal registers are necessary at the beginning and at the end of the co-processor to buffer data transferred between the hardware and the processor. The registers at the beginning (or input) of the co-processor are shown on FIG. 33, where elements 150 through 153 are registers to hold a first new data set and elements 160 to 163 are registers to hold a second new data set. The registers at the end (or result or output) of the co-processor are shown on FIG. 32, where elements 130 through 133 are registers to hold a first set of results and elements 140 to 142 are registers to hold a second set of results.

If the main loop for this implementation is unrolled to process 4 blocks, an entire block only consumes 12.5 cycles for a 128-bit key and a megabit only consumes 0.10 MIPS. For a 192-bit key, a block would consume 12.5 cycles and 0.10 MIPS. A 256-bit key would consume 14 cycles and 0.11 MIPS. For each step in key size this implementation requires approximately an additional 0.01 MIPS.

4 The AES Decode Algorithm

4.1 The Inverse Round Transform

Since the transforms of a ROUND are invertible, the decipher is just the inverse transforms of the cipher.

INV_ROUND (state, round_key) {

AddRoundKey (state, round_key);
InvMixColumn (state);
InvShiftRow (state);
InvByteSub (state);

}

The final round is as follows:

INV_FINAL_ROUND (state, round_key) {

AddRoundKey (state, round_key);
InvShiftRow (state);
InvByteSub (state);

}

4.1.1 The InvByteSub Transform

The inverse of the ByteSub transform for the decipher is

InvByteSub (byte* state) {

for (int i = 0; i < 16; i++)

state [i] = INV_SBOX [state [i]];

}

4.1.2 The InvShiftRow Transform

The state consists of 128-bits (block of 16 bytes) and can be thought of as a matrix as follows:

$$[ \begin{matrix}state [ 0 ] & state [ 1 ] & state [ 2 ] & state [ 3 ] \\ state [ 4 ] & state [ 5 ] & state [ 6 ] & state [ 7 ] \\ state [ 8 ] & state [ 9 ] & state [ 10 ] & state [ 11 ] \\ state [ 12 ] & state [ 13 ] & state [ 14 ] & state [ 15 ]\end{matrix} ]$$

The shift rows transform permutes the above matrix into the matrix below:

$$[ \begin{matrix}state [ 0 ] & state [ 1 ] & state [ 2 ] & state [ 3 ] \\ state [ 5 ] & state [ 6 ] & state [ 7 ] & state [ 4 ] \\ state [ 10 ] & state [ 11 ] & state [ 8 ] & state [ 9 ] \\ state [ 15 ] & state [ 12 ] & state [ 13 ] & state [ 14 ]\end{matrix} ]$$

4.1.3 The InvMixColumn Transform

The inverse of the MixColumn transform is below:

$$NEWSTATE = [ \begin{matrix}14 & 11 & 13 & 9 \\ 9 & 14 & 11 & 13 \\ 13 & 9 & 14 & 11 \\ 11 & 13 & 9 & 14\end{matrix} ] [ \begin{matrix}state [ 0 ] & state [ 1 ] & state [ 2 ] & state [ 3 ] \\ state [ 4 ] & state [ 5 ] & state [ 6 ] & state [ 7 ] \\ state [ 8 ] & state [ 9 ] & state [ 10 ] & state [ 11 ] \\ state [ 12 ] & state [ 13 ] & state [ 14 ] & state [ 15 ]\end{matrix} ]$$

4.1.4 The Round Key Addition

The final step in the inverse round transformation is to add the current round key to the state. Note that addition and subtraction over GF(28) is the same, so the same function from the cipher can be used for the decipher:

AddRoundKey (state, round_key) {

for(int i = 0; i < 16; i++)

state [i] \hat{ }= round_key [i];

}

5 Decode Implementation

In a table look-up implementation it was essential that the only non-linear step (ByteSub) be at the beginning of a round. Unfortunately, this non-linear step is last in the inverse round, making a quick table look-up implementation impossible. The index of the INV_SBOX table look-up is dependent on the calculations from the other 3 steps of the round, whereas the encoder's SBOX look-up was not. By rewriting the inverse round this problem can be avoided.

InvShiftRow and InvByteSub do not affect each other and are hence commutable, so the inverse round an be rewritten as:

INV_ROUND (state, round_key) {

AddRoundKey (state, round_key);
InvMixColumn (state);
InvByteSub (state);
InvShiftRow (state);

}

The math behind AddRoundKey and InvMixColumn is as follows:

$$\begin{matrix}NEWSTATE = [ \begin{matrix}14 & 11 & 13 & 9 \\ 9 & 14 & 11 & 13 \\ 13 & 9 & 14 & 11 \\ 11 & 13 & 9 & 14\end{matrix} ] \\ \{ [ \begin{matrix}state [ 0 ] & state [ 1 ] & state [ 2 ] & state [ 3 ] \\ state [ 4 ] & state [ 5 ] & state [ 6 ] & state [ 7 ] \\ state [ 8 ] & state [ 9 ] & state [ 10 ] & state [ 11 ] \\ state [ 12 ] & state [ 13 ] & state [ 14 ] & state [ 15 ]\end{matrix} ] ⊕ \\ [ \begin{matrix}key [ 0 ] & key [ 1 ] & key [ 2 ] & key [ 3 ] \\ key [ 4 ] & key [ 5 ] & key [ 6 ] & key [ 7 ] \\ key [ 8 ] & key [ 9 ] & key [ 10 ] & key [ 11 ] \\ key [ 12 ] & key [ 13 ] & key [ 14 ] & key [ 15 ]\end{matrix} ] \}\end{matrix}$$

This is equal to:

$$\begin{matrix}NEWSTATE = [ \begin{matrix}14 & 11 & 13 & 9 \\ 9 & 14 & 11 & 13 \\ 13 & 9 & 14 & 11 \\ 11 & 13 & 9 & 14\end{matrix} ] \\ [ \begin{matrix}state [ 0 ] & state [ 1 ] & state [ 2 ] & state [ 3 ] \\ state [ 4 ] & state [ 5 ] & state [ 6 ] & state [ 7 ] \\ state [ 8 ] & state [ 9 ] & state [ 10 ] & state [ 11 ] \\ state [ 12 ] & state [ 13 ] & state [ 14 ] & state [ 15 ]\end{matrix} ] ⊕ \\ [ \begin{matrix}14 & 11 & 13 & 9 \\ 9 & 14 & 11 & 13 \\ 13 & 9 & 14 & 11 \\ 11 & 13 & 9 & 14\end{matrix} ] [ \begin{matrix}key [ 0 ] & key [ 1 ] & key [ 2 ] & key [ 3 ] \\ key [ 4 ] & key [ 5 ] & key [ 6 ] & key [ 7 ] \\ key [ 8 ] & key [ 9 ] & key [ 10 ] & key [ 11 ] \\ key [ 12 ] & key [ 13 ] & key [ 14 ] & key [ 15 ]\end{matrix} ]\end{matrix}$$

If the key is multiplied by the mixcolumns matrix, the inverse round now can be written as:

INV_ROUND (state, round_key) {

InvMixColumn (state);
AddRoundKey (state, M * round_key); // M is the
mixcolumns matrix
InvByteSub (state);
InvShiftRow (state);

}

The inverse round does not seem manageable in this form, but it is actually split with the bottom half of the round on top and the top half on the bottom If the loop is unrolled to process 2 Rounds (or more) then it will look like this:

INV_2_ROUNDS(state, round_key)
{

| InvMixColumn(state); | |
|---|---|
| AddRoundKey (state, M * round_key); | // M is the mixcolumns matrix |
| InvByteSub (state); | |
| InvShiftRow (state); | |
| InvMixColumn (state); | |
| AddRoundKey (state, M * round_key); | // M is the mixcolumns matrix |
| InvByteSub (state); | |
| InvShiftRow (state); | |

}

Note that

InvByteSub (state);
InvShiftRow (state);
InvMixColumn (state);
AddRoundKey (state, M * round_key); // M is the mixcolumns matrix

is the same structure as the cipher's round. Hence, almost the identical optimizations can be used.

The math for this is as follows:

$$\begin{matrix}ROUNDSTATE = [ \begin{matrix}14 & 11 & 13 & 9 \\ 9 & 14 & 11 & 13 \\ 13 & 9 & 14 & 11 \\ 11 & 13 & 9 & 14\end{matrix} ] \\ [ \begin{matrix}invsbox [ x [ 0 ] ] & invsbox [ x [ 1 ] ] & invsbox [ x [ 2 ] ] & invsbox [ x [ 3 ] ] \\ invsbox [ x [ 7 ] ] & invsbox [ x [ 4 ] ] & invsbox [ x [ 5 ] ] & invsbox [ x [ 6 ] ] \\ invsbox [ x [ 10 ] ] & invsbox [ x [ 11 ] ] & invsbox [ x [ 8 ] ] & invsbox [ x [ 9 ] ] \\ invsbox [ x [ 13 ] ] & invsbox [ x [ 14 ] ] & invsbox [ x [ 15 ] ] & invsbox [ x [ 12 ] ]\end{matrix} ] ⊕ \\ M [ \begin{matrix}key [ 0 ] & key [ 1 ] & key [ 2 ] & key [ 3 ] \\ key [ 4 ] & key [ 5 ] & key [ 6 ] & key [ 7 ] \\ key [ 8 ] & key [ 9 ] & key [ 10 ] & key [ 11 ] \\ key [ 12 ] & key [ 13 ] & key [ 14 ] & key [ 15 ]\end{matrix} ]\end{matrix}$$

and the same table optimization can be done with the decipher as with the cipher.

$$T1 [ i ] = [ \begin{matrix}14 * invsbox [ i ] \\ 9 * invsbox [ i ] \\ 13 * invsbox [ i ] \\ 11 * invsbox [ i ]\end{matrix} ] , T2 [ i ] = [ \begin{matrix}11 * invsbox [ i ] \\ 14 * invsbox [ i ] \\ 9 * invsbox [ i ] \\ 13 * invsbox [ i ]\end{matrix} ] , \\ T3 [ i ] = [ \begin{matrix}13 * invsbox [ i ] \\ 11 * invsbox [ i ] \\ 14 * invsbox [ i ] \\ 9 * invsbox [ i ]\end{matrix} ] , T4 [ i ] = [ \begin{matrix}9 * invsbox [ i ] \\ 13 * invsbox [ i ] \\ 11 * invsbox [ i ] \\ 14 * invsbox [ i ]\end{matrix} ] \\ [ c1 ] = T1 [ x [ 0 ] ] ⊕ T2 [ x [ 7 ] ] ⊕ T3 [ x [ 10 ] ] ⊕ T4 [ x [ 13 ] ⊕ M [ \begin{matrix}key [ 0 ] \\ key [ 4 ] \\ key [ 8 ] \\ key [ 12 ]\end{matrix} ] \\ [ c2 ] = T1 [ x [ 1 ] ] ⊕ T2 [ x [ 4 ] ] ⊕ T3 [ x [ 11 ] ] ⊕ T4 [ x [ 14 ] ⊕ M [ \begin{matrix}key [ 1 ] \\ key [ 5 ] \\ key [ 9 ] \\ key [ 13 ]\end{matrix} ] \\ [ c3 ] = T1 [ x [ 2 ] ] ⊕ T2 [ x [ 5 ] ] ⊕ T3 [ x [ 8 ] ] ⊕ T4 [ x [ 15 ] ⊕ M [ \begin{matrix}key [ 2 ] \\ key [ 6 ] \\ key [ 10 ] \\ key [ 14 ]\end{matrix} ] \\ [ c4 ] = T1 [ x [ 3 ] ] ⊕ T2 [ x [ 6 ] ] ⊕ T3 [ x [ 9 ] ] ⊕ T4 [ x [ 12 ] ⊕ M [ \begin{matrix}key [ 3 ] \\ key [ 7 ] \\ key [ 11 ] \\ key [ 15 ]\end{matrix} ]$$

5.1 Optimized Software

The optimized software implementation of the decoder is almost identical to the encoder's implementation. The decoder utilizes a main loop, which is executed essentially 9 times. Each iteration of the loop performs a round. The loop begins by splitting the block into bytes and performing the non-linear inverse transformation of the data. Table lookup for Galois field multiplication by 9, 11, 13, and 14 is performed on each word. The expanded key is then exclusive-or'd with the results from the non-linear-transformation. The end results are saved into a buffer and the whole loop starts from the beginning using the new results for input. After the main loop is finished a final smaller round is preformed which completes the decoding and the final results are obtained.

If the key length is changed, the algorithm requires an increased number of rounds performed per block. The optimized software requires 837 instructions per block of 16 bytes of data using a 128-bit key. For a 192-bit key, the optimized software requires 987 instructions per block. Each step to the next higher key size requires two additional iterations of the main loop. Therefore, an increase in key size for this implementation will require an additional 1.2 MIPS.

There are 7812.5 blocks required to transmit a megabit of data. Therefore, for a 128-bit key, a block would consume 837 cycles and decoding a megabit of data would take 6.5 MIPS. For a 192-bit key, the implementation consumes 987 cycles and takes 7.7 MIPS. For a 256-bit key, the implementation consumes 1137 cycles and requires 8.9 MIPS.

5.2 UDI AES Decode Primitives

The Galois Field multiplication, non-linear inverse bytes substitution, and the byte transposition operations may be assisted with UDI instructions on the MIPS processor. The effectiveness and use of these instructions are described in this section.

One of the complexities of the decoder algorithm is the multiplication over a finite field (the Galois Field). Without a GF hardware instruction, the multiplications are performed in software by table lookup to simulate Galois Field hardware instructions:

GF9_SIMD (x, result, tmp) {

result = x;
/* multiply by 2 first - bit1 */
flag = ((x & (u32)GF_MASK) >> 7);
tmp = (x & (u32)(GF_MASK_NOT)) << 1;
tmp \hat{ }= (u32)(flag * 0x1b);
/* next power of y - bit2 */
flag = ((tmp & (u32)GF_MASK) >> 7);
tmp = (tmp & (u32)(GF_MASK_NOT)) << 1;
tmp \hat{ }= (u32)(flag * 0x1b);
/* next power of y - bit3 */
flag = ((tmp & (u32)GF_MASK) >> 7);
tmp = (tmp & (u32)(GF_MASK_NOT)) << 1;
tmp \hat{ }= (u32)(flag * 0x1b);
result \hat{ }= tmp;

}
GF11_SIMD (x, result, tmp) {

result = x;
/* next power of y */
flag = ((x & (u32)GF_MASK) >> 7);
tmp = (x & (u32)(GF_MASK_NOT)) << 1;
tmp \hat{ }= (u32)(flag * 0x1b);
result \hat{ }= tmp;
/* next power of y - bit2 */
flag = ((tmp & (u32)GF_MASK) >> 7);
tmp = (tmp & (u32)(GF_MASK_NOT)) << 1;
tmp \hat{ }= (u32)(flag * 0x1b);
/* next power of y - bit3 */

flag = ((tmp & (u32)GF_MASK) >> 7);

tmp = (tmp & (u32)(GF_MASK_NOT)) << 1;
tmp \hat{ }= (u32)(flag * 0x1b);
result \hat{ }= tmp;

}
GF13_SIMD (x, result, tmp) {

result = x;
/* next power of y - bit1 */
flag = ((x & (u32)GF_MASK) >> 7);
tmp = (x & (u32)(GF_MASK_NOT)) << 1;
tmp \hat{ }= (u32)(flag * 0x1b);
/* next power of y - bit2 */
flag = ((tmp & (u32)GF_MASK) >> 7);

tmp = (tmp & (u32)(GF_MASK_NOT)) << 1;

tmp \hat{ }= (u32)(flag * 0x1b);
result \hat{ }= tmp;
/* next power of y - bit3 */
flag = ((tmp & (u32)GF_MASK) >> 7);
tmp = (tmp & (u32)(GF_MASK_NOT)) << 1;
tmp \hat{ }= (u32)(flag * 0x1b);
result \hat{ }= tmp;

}

GF14_SIMD(x, result, tmp) {
/* multiply by 2 first - bit1 */
flag = ((x & (u32)GF_MASK) >> 7);
tmp = (x & (u32)(GF_MASK_NOT)) << 1;
tmp \hat{ }= (u32)(flag * 0x1b);
result = tmp;
/* next power of y - bit2 */
flag = ((tmp & (u32)GF_MASK) >> 7);
tmp = (tmp & (u32)(GF_MASK_NOT)) << 1;
tmp \hat{ }= (u32)(flag * 0x1b);
result \hat{ }= tmp;

/* next power of y - bit3 */

flag = ((tmp & (u32)GF_MASK) >> 7);
tmp = (tmp & (u32)(GF_MASK_NOT)) << 1;
tmp \hat{ }= (u32)(flag * 0x1b);
result \hat{ }= tmp;

}

The software implementation of GF multiplication requires 1 addition and 2 table lookups (1 table lookup for loading the data byte by byte) consuming 3 clock cycles. Thus, with the GF multiplications being performed 9 out of 10 rounds, 4 times per round, it results in 108 clocks per block being consumed for the GF multiplication in software (assuming a key size of 128 bits.) GF multiplication may be replaced by a UDI instruction. Additionally, the UDI instruction can take a 32-bit register, compute GF9, GF11, GF13, or GF14 for it, and output the answer to a register. The GF_SIMD function would be replaced by a UDI instruction in the software and would be executed like the following:

GF9 ($dest1, $input1);
GF11 ($dest2, $input2);
GF13 ($dest3, $input3);
GF14 ($dest4, $input4);

Each result would be obtained after 1 clock cycle replacing 16 clock cycles per GF. Using a 128-bit key, the GF instruction for the decoder will be issued 36 times per block replacing the original:

1) 288 table lookups

2) 144 additions

3) 144 exclusive-ors

Another significant processing burden is the non-linear inverse substitution lookup performed on 16 data bytes at the start of each round. The MIPS architecture is a RISC architecture employing an instruction set which only performs operations on data in registers. Without being able to operate on memory directly, the software implementation suffers due to the constant load/store action occurring from the inverse substitution lookup and byte manipulation:

row1[0] = INV_SBOX[buffer[0]];
row1[1] = INV_SBOX[buffer[1]];
row1[2] = INV_SBOX[buffer[2]];
row1[3] = INV_SBOX[buffer[3]];
row2[0] = INV_SBOX[buffer[7]];
row2[1] = INV_SBOX[buffer[4]];
row2[2] = INV_SBOX[buffer[5]];
row2[3] = INV_SBOX[buffer[6]];
row3[0] = INV_SBOX[buffer[10]];
row3[1] = INV_SBOX[buffer[11]];
row3[2] = INV_SBOX[buffer[8]];
row3[3] = INV_SBOX[buffer[9]];
row4[0] = INV_SBOX[buffer[13]];
row4[1] = INV_SBOX[buffer[14]];
row4[2] = INV_SBOX[buffer[15]];
row4[3] = INV_SBOX[buffer[12]];

Before the substitution lookup, each byte must be moved into a specific position in each row. All together, the inverse substitution and byte merging accounts for over half of the processing per round. This may be improved through UDI instructions, which would perform the INV_SBOX lookup 4 bytes at a time and the byte manipulation in hardware.

The byte manipulation may be split into 2 groups of instructions. The first form of manipulation involves byte transposition. These instructions are exactly the same as the transposition instructions for the encoder. They will be used to shift the data from being held as rows to being held as columns or vice-versa. For example, at the start of the decoder algorithm, the data must shifted from a normal buffer to the state array:

| | |
|---|---|
| Data | State Array |

| | | | | | | | |
|---|---|---|---|---|---|---|---|
| s0 | s1 | s2 | s3 | s0 | s4 | s8 | s12 |
| s4 | s5 | s6 | s7 | s1 | s5 | s9 | s13 |
| s8 | s9 | s10 | s11 | s2 | s6 | s10 | s14 |
| s12 | s13 | s14 | s15 | s3 | s7 | s11 | s15 |

To perform this transposition, UDI instructions may be implemented in the following fashion to increase performance by saving cycles consumed by the transposition:

| d0-d15 are 16 bytes of data to be transposed | | | | | |
|---|---|---|---|---|---|
| d0 | d1 | d2 | d3 | ≡ | $s0 |
| d4 | d5 | d6 | d7 | ≡ | $s1 |
| d8 | d9 | d10 | d11 | ≡ | $s2 |
| d12 | d13 | d14 | d15 | ≡ | $s3 |

| | | | |
|---|---|---|---|
| T2A | $t0, $s0, $s1 | // d0, d4, d2, d6 ≡ $t0 | 1st and 3rd bytes |
| T2B | $s1, $s0, $s1 | // d1, d5, d3, d7 ≡ $s1 | 2nd and 4th bytes |
| T2A | $t1, $s2, $s3 | // d8, d12, d10, d14 ≡ $t1 | 1st and 3rd bytes |
| T2B | $s3, $s2, $s3 | // d9, d13, d11, d15 ≡ $s3 | 2nd and 4th bytes |
| T4A | $s0, $t0, $t1 | // d0, d4, d8, d12 ≡ $s0 | 1st two bytes |
| | | | from each register |
| T4B | $s2, $t0, $t1 | // d2, d6, d10, d14 ≡ $s2 | 2nd two bytes from |
| | | | each register |
| T4A | $t1, $s1, $s3 | // d1, d5, d9, d13 ≡ $t1 | |
| T4B | $s3, $s1, $s3 | // d3, d7, d11, d15 ≡ $s3 | |

The C-code for the transposition looks like this:

ByteTransposition (char* data, char* state) {

state [0] = data [0];
state [1] = data [4];
state [2] = data [8];
state [3] = data [12];
state [4] = data [1];
state [5] = data [5];
state [6] = data [9];
state [7] = data [13];
state [8] = data [2];
state [9] = data [6];
state [10] = data [10];
state [11] = data [14];
state [12] = data [3];
state [13] = data [7];
state [14] = data [11];
state [15] = data [15];

}

The second type of byte manipulation requires a byte rotation by l, 2, or 3 bytes to the left (versus to the right for the encoder). The MIPS instruction set contains a simulated bit rotation to the left, but at compile time the simulated instruction expands to 4 hardware instructions. Note that the rbr UDI instruction from the encoder could be used here because a rotate by 1 byte to the left is the same as a rotate by 3 bytes to the right when operating on a 32-bit word. A UDI instruction, rbl, is defined to handle byte rotation according to the following example:

| | | |
|---|---|---|
| rbl $d1, $s1, 1 | // d7, d4, d5, d6 ≡ $d1 | rotate left by 1 byte |
| rbl $d1, $s1, 2 | // d10, d11, d8, d9 ≡ $d2 | rotate left by 2 bytes |
| rbl $d1, $s1, 3 | // d13, d14, d15, d12 ≡ $d3 | rotate left by 3 bytes |

The C-code for the byte rotation looks like this:

ByteRotation (unsigned char* data, unsigned char* state) {

state [0] = data [0];
state [1] = data [1];
state [2] = data [2];
state [3] = data [3];
state [4] = data [7];
state [5] = data [4];
state [6] = data [5];
state [7] = data [6];
state [8] = data [10];
state [9] = data [11];
state [10] = data [8];
state [11] = data [9];
state [12] = data [13];
state [13] = data [14];
state [14] = data [15];
state [15] = data [12];

}

The INV_SBOX substitution lookup may be implemented in hardware to perform the lookups for the data as a UDI instruction. The INV_SBOX data for the lookup may be held in a ROM as a part of the hardware. When each byte comes in, it is immediately used as the offset to the ROM and the results are saved to a destination register specified in the UDI instruction. Using this technique, the INV_SBOX lookup is able to operate on 4 bytes at a time in parallel. The C-code for this UDI instruction would look like:

unsigned long INV_SBOX (unsigned long src) {

unsigned long tmp;
unsigned char tmp_mem [4], tmp_src [4];
unsigned long* ptr_src;
ptr_src = (unsigned long*)tmp_src;
*ptr_src = src;
tmp_mem [0] = INV_SBOX [tmp_src [0]];
tmp_mem [1] = INV_SBOX [tmp_src [1]];
tmp_mem [2] = INV_SBOX [tmp_src [2]];
tmp_mem [3] = INV_SBOX [tmp_src [3]];
return *ptr_src;

}

The code for this implementation using the AES primitives is as follows:

// start of AES decode primitives
// extended key is assumed to be already calculated according to key expansion routine
// and has been permuted

| | |
|---|---|
| add $extended_key, $extended_key, 160 | // start extended_key at end and move backward |

// loop for each block of data
loop:

// xor key
lw $data1, 0($buffer)
lw $data2, 4($buffer)
lw $data3, 8($buffer)
lw $data4, 12($buffer)
lw $key1, 0($extended_key)
lw $key2, 4($extended_key)
lw $key3, 8($extended_key)
lw $key4, 12($extended_key)
xor $data1, $data1, $key1
xor $data2, $data2, $key2
xor $data3, $data3, $key3
xor $data4, $data4, $key4
sub $extended_key, $extended_key, 16

// perform preamble

| // 8 transpose UDI instructions | |
|---|---|
| t2a $t0, $data1, $data2 | // 1st and 3rd bytes |
| t2b $data2, $data1, $data2 | // 2nd and 4th bytes |
| t2a $t1, $data3, $data4 | // 1st and 3rd bytes |
| t2b $data4, $data3, $data4 | // 2nd and 4th bytes |
| t4a $data1, $t0, $t1 | // 1st two bytes from each register |
| t4b $data3, $t0, $t1 | // 2nd two bytes from each register |
| t4a $t1, $data2, $data4 | // 1st two bytes from each register |
| t4b $data4, $data2, $data4 | // 2nd two bytes from each register |
| // 3 rotate UDI instructions | |
| rbl1 $data2, $data2 | |
| rbl2 $data3, $data3 | |
| rbl3 $data4, $data4 | |
| inv_sbox $data1, $data1 | |
| inv_sbox $data2, $data2 | // splits word into bytes and does s_box lookup |
| | // 4 bytes at a time into same positions |
| inv_sbox $data3, $data3 | |
| inv_sbox $data4, $data4 | // from rom on each byte |
| lw $key1, 0($extended_key) | // xor key |
| lw $key2, 4($extended_key) | |
| lw $key3, 8($extended_key) | |
| lw $key4, 12($extended_key) | |
| xor $data1, $data1, $key1 | |
| xor $data2, $data2, $key2 | |
| xor $data3, $data3, $key3 | |
| xor $data4, $data4, $key4 | |

sub $extended_key, $extended_key, 16
gf14 $GF14_data1, $data1
gf11 $GF11_data2, $data2
gf13 $GF13_data3, $data3
gf9 $GF9_data4, $data4
xor $tmp, $GF14_data1, $GF11_data2
xor $tmp, $tmp, $GF13_data3
xor $result1, $tmp, $GF9_data4
gf9 $GF14_data1, $data1
gf14 $GF11_data2, $data2
gf11 $GF13_data3, $data3
gf13 $GF9_data4, $data4
xor $tmp, $GF9_data1, $GF14_data2
xor $tmp, $tmp, $GF11_data3
xor $result2, $tmp, $GF13_data4
gf13 $GF13_data1, $data1
gf9 $GF9_data2, $data2
gf14 $GF14_data3, $data3
gf11 $GF11_data4, $data4
xor $tmp, $GF13_data1, $GF9_data2
xor $tmp, $tmp, $GF14_data3
xor $result3, $tmp, $GF11_data4
gf11 $GF11_data1, $data1
gf13 $GF13_data2, $data2
gf9 $GF9_data3, $data3
gf14 $GF14_data4, $data4
xor $tmp, $GF11_data1, $GF13_data2
xor $tmp, $tmp, $GF9_data3
xor $result4, $tmp, $GF14_data4
move $inner_loop_counter, 8

// main loop (8×)
inner_loop:

| // shift data 3 rotate instructions | |
|---|---|
| rbl1 $data2, $result2 | |
| rbl2 $data3, $result3 | |
| rbl3 $data4, $result4 | |
| inv_sbox $data1, $result1 | |
| inv_sbox $data2, $data2 | // splits word into bytes and does s_box lookup |
| | // 4 bytes at a time into same positions |
| inv_sbox $data3, $data3 | |
| inv_sbox $data4, $data4 | // from rom on each byte |
| lw $key1, 0($extended_key) | // xor key with data |

lw $key2, 4($extended_key)
lw $key3, 8($extended_key)
lw $key4, 12($extended_key)
sub $extended_key, $extended_key, 16
xor $data1, $data1, $key1
xor $data2, $data2, $key2
xor $data3, $data3, $key3
xor $data4, $data4, $key4
gf14 $GF14_data1, $data1
gf11 $GF11_data2, $data2
gf13 $GF13_data3, $data3
gf9 $GF9_data4, $data4
xor $tmp, $GF14_data1, $GF11_data2
xor $tmp, $tmp, $GF13_data3
xor $result1, $tmp, $GF9_data4
gf9 $GF14_data1, $data1
gf14 $GF11_data2, $data2
gf11 $GF13_data3, $data3
gf13 $GF9_data4, $data4
xor $tmp, $GF9_data1, $GF14_data2
xor $tmp, $tmp, $GF11_data3
xor $result2, $tmp, $GF13_data4
gf13 $GF13_data1, $data1
gf9 $GF9_data2, $data2
gf14 $GF14_data3, $data3
gf11 $GF11_data4, $data4
xor $tmp, $GF13_data1, $GF9_data2
xor $tmp, $tmp, $GF14_data3
xor $result3, $tmp, $GF11_data4
gf11 $GF11_data1, $data1
gf13 $GF13_data2, $data2
gf9 $GF9_data3, $data3
gf14 $GF14_data4, $data4
xor $tmp, $GF11_data1, $GF13_data2
xor $tmp, $tmp, $GF9_data3
xor $result4, $tmp, $GF14_data4
sub $inner_loop_counter, $inner_loop_counter, 1
bne $inner_loop_counter, inner_loop
// end of main loop

// perform postamble

| // shift data - 3 rotate instructions | |
|---|---|
| rbl1 $data2, $result2 | |
| rbl2 $data3, $result3 | |
| rbl3 $data4, $result4 | |
| inv_sbox $data1, $result1 | |
| inv_sbox $data2, $data2 | |
| inv_sbox $data3, $data3 | |
| inv_sbox $data4, $data4 | |
| lw $key1, 0($extended_key) | |
| lw $key2, 4($extended_key) | |
| lw $key3, 8($extended_key) | |
| lw $key4, 12($extended_key) | |
| sub $extended_key, $extended_key, 16 | |
| xor $data1, $data1, $key1 | |
| xor $data2, $data2, $key2 | |
| xor $data3, $data3, $key3 | |
| xor $data4, $data4, $key4 | |
| // transpose - 8 instructions | |
| t2a $t0, $data1, $data2 | |
| t2b $result2, $data1, $data2 | |
| t2a $t1, $data3, $data4 | |
| t2b $result4, $data3, $data4 | |
| t4a $result1, $t0, $t1 | |
| t4b $result3, $t0, $t1 | |
| t4a $t1, $result2, $result4 | |
| t4b $result4, $result2, $result4 | |
| sw $result1, 0($buffer) | // store results |
| sw $result1, 4($buffer) | |
| sw $result1, 8($buffer) | |
| sw $result1, 12($buffer) | |
| add $buffer, $buffer, 16 | // increment the data pointer to the next block |

sub $num_of_blocks, $num_of_blocks, 1
bne $num_of_blocks, loop

// end of AES decode primitives

As in the encoder, the number of cycles saved for this implementation is substantial because there are enough registers to eliminate the need to save data to memory. For a 128-bit key, a block consumes 460 cycles and decoding a megabit of data requires 3.6 MIPS. For a 192-bit key, a block consumes 552 cycles and 4.3 MIPS. A 256-bit key implementation consumes 644 cycles and 5.0 MIPS. For each additional step in key size, this implementation requires an additional 0.6 MIPS.

5.3 UDI AES Decode Round Accelerator

The major part of the processing of the AES algorithm may be executed almost entirely using UDI instructions accessing an UDI AES Decode Round Accelerator hardware. This implementation is much the same as the encode round accelerator. The main difference between the two is that all four words of the key are needed before a result may be obtained. This implementation operates with all key sizes as longer keys only involve additional iterations of the main loop. It combines the use of the GFM and INV_SBOX substitution instructions and replaces all of the processing of each iteration of the main loop.

The INV_SBOX substitution lookup may be implemented in hardware to perform the substitution as soon as the data is loaded into the accelerator registers. The INV_SBOX data for the lookup may be held in a ROM as a part of the hardware. When the data comes in, it is immediately used as the offset to the ROM and the results are saved in a separate register. Hence, the processor can finish loading the key (or data) from memory while the substitution is taking place. The byte transposition for each loop will take place automatically as it is a simple step in hardware to place the bytes into the correct positions.

The byte transposition for the beginning and end of the block will be assisted through the use of multiplexers to select whether or not to perform the transposition. For the first round, the data will be exclusive-or'd with the key and then transposed. For the final round, the GF multiplication hardware will be bypassed and the transposition will take place instead.

The start of an iteration of the main loop using this implementation begins as follows: Four words of the buffer array (or data buffer for the main loop) will be loaded into registers. At this point, the UDI hardware instruction takes each byte of the buffer array passed in and uses it as the index to the lookup on the INV_SBOX ROM. Each resulting byte is placed so that the byte splitting and merging happens automatically. The results from the INV_SBOX substitution are all held in designated internal hardware registers. Next, the extended key will be loaded into registers and the GF hardware will exclusive-or the data with the extended key. From these results, GF9, GF11, GF13, and GF14 are computed in parallel. The results from the GF multiplication are exclusive-or'd by the hardware and the final result is placed in the destination register.

Using a hardware UDI instruction for the substitution lookup, the byte merging, the GF multiplication, and the exclusive-or operations, an iteration of the main loop would execute as follows:

| | |
|---|---|
| // main loop | |
| aes_dec_rnd_in_1 $data1, $data2 | // supply 8 bytes at a time into AES accelerator |
| aes_dec_rnd_in_2 $data3, $data4 | |
| lw $key1, 0($extended_key) | |
| lw $key2, 4($extended_key) | |
| lw $key3, 8($extended_key) | |
| lw $key4, 12($extended_key) | |
| aes_dec_rnd_key_1 $key1, $key2 | |
| aes_dec_rnd_out_1 $data1, $key3, $key4 | // perform the xor and |
| aes_dec_rnd_out_2 $data2 | // GF multiplication to get results |
| aes_dec_rnd_out_3 $data3 | |
| aes_dec_rnd_out_4 $data4 | |
| // end of iteration of main loop | |

The aes_dec_rnd_in_{—}1/2 instructions are issued to start the INV_SBOX substitution and the byte merging. In the meantime, the key is loaded up into the processor's registers. The aes_dec_rnd_key_{—}1 will write the first two key words into hardware. The aes_dec_rnd_out_{—}1 will load 2 more words and obtain the first result. Once the key is loaded, aes_dec_rnd_out_{—}2/3/4 will perform the exclusive-or with the data, followed by the GF multiplication, and the exclusive-or's to yield the last three results.

The code for this implementation is as follows:

// start of AES decode round accelerator
// the key is assumed to already be expanded and permuted according to the key expansion routine

| | |
|---|---|
| add $extended_key, $extended_key, 160 | // start at end of key and work backwords |
| loop: | |
| // perform preamble | |

lw $key1, 0($extended_key)
lw $key2, 4($extended_key)
lw $key3, 8($extended_key)
lw $key4, 12($extended_key)
sub $extended_key, $extended_key, 16
aes_dec_rnd_key_1 $key1, $key2
aes_dec_rnd_key_2 $key3, $key4
lw $data1, 0($buffer)
lw $data2, 4($buffer)
lw $data3, 8($buffer)
lw $data4, 12($buffer)
aes_dec_rnd_pre_in_1 $data1, $data2
aes_dec_rnd_pre_in_2 $data3, $data4
move $inner_loop_counter, 9

// main loop (9×)
inner_loop:

| lw $key1, 0($extended_key) | |
|---|---|
| lw $key2, 4($extended_key) | |
| lw $key3, 8($extended_key) | |
| lw $key4, 12($extended_key) | |
| sub $extended_key, $extended_key, 16 | |
| aes_dec_rnd_key_1 $key1, $key2 | // write 1st two keys |
| aes_dec_rnd_out_1 $data1, $key3, $key4 | // write 2nd two keys and obtain one result |
| aes_dec_rnd_out_2 $data2 | |
| aes_dec_rnd_out_3 $data3 | |
| aes_dec_rnd_out_4 $data4 | |
| aes_dec_in_1 $data1, $data2 | // supply 8 bytes at a time into AES accelerator |
| aes_dec_in_2 $data3, $data4 | |

sub $inner_loop_counter, $inner_loop_counter, 1
bne $inner_loop_counter, inner_loop
// end of main loop

// perform postamble

| lw $key1, 0($extended_key) | |
|---|---|
| lw $key2, 4($extended_key) | |
| lw $key3, 8($extended_key) | |
| lw $key4, 12($extended_key) | |
| aes_dec_rnd_key_1 $key1, $key2 | |
| aes_dec_rnd_post_out_1 $data1, $key3, $key4 | |
| aes_dec_rnd_post_out_2 $data2 | |
| aes_dec_rnd_post_out_3 $data3 | |
| aes_dec_rnd_post_out_4 $data4 | |
| add $extended_key, $extended_key, 40 | |
| sub $num_of_blocks, $num_of_blocks, 1 | |
| addi $buffer, $buffer, 16 | // increment the data pointer to the next block |
| bne $num_of_blocks, outside_loop | |

// end of AES decode round accelerator

If unrolled, the main loop only consumes 11 cycles. For a 128-bit key, the hardware assisted loop is executed 9 times per block, and consumes 127 cycles. Encoding a megabit of data requires 1.0 MIPS. For a 192-bit key, a block consumes 149 cycles and requires 1.2 MIPS per megabit. A 256-bit key implementation consumes 171 cycles and requires 1.3 MIPS per megabit. For each additional step in key size, this implementation requires approximately 0.16 additional MIPS.

5.4 UDI AES Decode 32-bit Block Accelerator

An additional improvement to the decoder may be obtained by using the AES Decode 32-bit Block Accelerator hardware. The hardware acceleration implementation operates with all key sizes as longer keys simply involve executing more iterations of the main loop. The decode block accelerator operates almost the same as the encode block accelerator. The result from the end of each round is kept in the accelerator hardware and forwarded to the start of the next round without leaving the hardware.

The INV_SBOX substitution lookup, byte merging, byte transposition, and GF multiplication will be performed as in the implementation of the decode round accelerator. When a 32-bit result is obtained at the end of a round, it is fed as an input to the beginning of the next round, and the hardware will continue until all four results are obtained. Each of the first three results are double buffered to protect them from corrupting the later results while the hardware is still calculating. This puts less stress on the processor since it is no longer loading and receiving data to and from the dedicated hardware.

While the processor is working on each block, the key will be fed into the accelerator two words at a time. Once four key words are in place, the GF multiplications are executed immediately and a 32-bit result is fed back to the beginning. The inverse substitution lookup and byte rotation is then performed. The data is stored in buried state registers for the next cycle. Since the processor is not performing any operations during this time, a single load from the key memory into a register may be performed at the same time.

Once the data and the first four key words have been written into the hardware. a single round executes as follows:

| | |
|---|---|
| // main loop | |
| aes_dec_blk_key_1 $key_c, $key_d | // write two key |
| | words to hardware |
| lw $key_b from $extended_key | // key_a and key_c |
| | are already |
| | // loaded and saved |
| | in registers |
| aes_dec_blk_key_2 $key_a, $key_b | // write two key words |
| | to hardware |
| lw $key_d from $extended_key | |
| // end of iteration | |

The aes_dec_blk_key_{—}1/2 instructions would be used to write 2 key words each into the UDI hardware. One of those key words is exclusive-or'd during that cycle to obtain a result. The other key word is used during the next cycle (during the 2nd load from $extended_key). At the begining of a round, the last two of four key words are placed into the engine from the aes_dec_blk_out_{—}1 instruction. The aes_dec_blk_out_{—}3 instruction places the first two key words into the engine to get ready for the next round in order to save unnecessary cycles.

The code for this implementation is as follows:
// start of AES decode 32-bit block accelerator
// extended key is assumed to be already calculated according to key expansion routine
// and has been permuted
// start by loading 17 of the keys into registers

lw $key_36, 36($extended_key)
lw $key_44, 44($extended_key)
lw $key_52, 52($extended_key)
lw $key_60, 60($extended_key)
lw $key_68, 68($extended_key)
lw $key_76, 76($extended_key)
lw $key_84, 84($extended_key)
lw $key_92, 92($extended_key)
lw $key_100, 100($extended_key)
lw $key_108, 108($extended_key)
lw $key_116, 116($extended_key)
lw $key_124, 124($extended_key)
lw $key_132, 132($extended_key)
lw $key_140, 140($extended_key)
lw $key_148, 148($extended_key)
lw $key_156, 156($extended_key)
lw $key_164, 164($extended_key)
lw $key_172, 172($extended key)

loop:
// xor key and data

| lw $data1, 0($buffer) | |
|---|---|
| lw $data2, 4($buffer) | |
| lw $key_b, 168($extended_key) | |
| aes_dec_blk_in_1 $data1, $key_172 | // have to get 4 keys first |
| aes_dec_blk_in_2 $data2, $key_b | |
| lw $key_d, 152($extended_key) | |
| lw $data3, 8($buffer) | |
| lw $data4, 12($buffer) | |
| lw $key_b, 160($extended_key) | |
| aes_dec_blk_in_3 $data3, $key_164 | |
| aes_dec_blk_in_4 $data4, $key_b | |
| aes_dec_blk_key_1 $key_156, $key_d | // GF to get row1 |
| lw $key_b, 144($extended_key) | |
| lw $key_d, 136($extended_key) | |

// 1st round - end of preamble

| aes_dec_blk_key_2 $key_148, $key_b | |
|---|---|
| lw $key_b, 128($extended_key) | // GF to get row2 |
| aes_dec_blk_key_1 $key_140, $key_d | // GF to get row3 |
| lw $key_d, 120($extended_key) | // GF to get row4 |

// 2nd round

| | |
|---|---|
| aes_dec_blk_key_2 $key_132, $key_b | // GF to get row1 |
| lw $key_b, 112($extended_key) | // GF to get row2 |
| aes_dec_blk_key_1 $key_124, $key_d | // GF to get row3 |
| lw $key_d, 104($extended_key) | // GF to get row4 |

// 3rd round

aes_dec_blk_key_2 $key_116, $key_b
lw $key_b, 96($extended_key)
aes_dec_blk_key_1 $key_108, $key_d
lw $key_d, 88($extended_key)

// 4th round

aes_dec_blk_key_2 $key_100, $key_b
lw $key_b, 80($extended_key)
aes_dec_blk_key_1 $key_92, $key_d
lw $key_d, 72($extended_key)

// 5th round

aes_dec_blk_key_2 $key_84, $key_b
lw $key_b, 64($extended_key)
aes_dec_blk_key_1 $key_76, $key_d
lw $key_d, 56($extended_key)

// 6th round

aes_dec_blk_key_2 $key_68, $key_b
lw $key_b, 48($extended_key)
aes_dec_blk_key_1 $key_60, $key_d
lw $key_d, 40($extended_key)

// 7th round

aes_dec_blk_key_2 $key_52, $key_b
lw $key_b, 32($extended_key)
aes_dec_blk_key_1 $key_44, $key_d
lw $key_d, 24($extended_key)
lw $key_c, 28($extended_key)

// 8th round

aes_dec_blk_key_2 $key_36, $key_b
lw $key_a, 20($extended_key)
lw $key_b, 16($extended_key)
aes_dec_blk_key_1 $key_c, $key_d
lw $key_c, 12($extended_key)
lw $key_d, 8($extended_key)

// 9th round

| | |
|---|---|
| aes_dec_blk_key_2 $key_a, $key_b | // GF to get row1 |
| lw $key_a, 4($extended_key) | // GF to get row2 |
| lw $key_b, 0($extended_key) | // GF to get row3 |
| aes_dec_blk_key_1 $key_c, $key_d | // GF to get row4 |

// postamble

| | |
|---|---|
| aes_dec_blk_out_1 $data1, $key_a, $key_b | // write key3 and 4 - last keys for this block |

// get first result in $data1

sw $data1, 0($buffer)
aes_dec_blk_out_2 $data2
sw $data2, 4($buffer)
aes_dec_blk_out_3 $data3
sw $data3, 8($buffer)
aes_dec_blk_out_4 $data4
sw $data4, 12($buffer)
add $buffer, $buffer, 16
sub $num_of_blocks, $num_of_blocks, 1
bne $num_of_blocks, loop

// end of AES decode 32-bit block accelerator

The main loop only consumes 4 cycles. For a 128-bit key, the hardware assisted loop is executed 9 times per block, and a block consumes 65 cycles. Encoding a megabit of data requires 0.51 MIPS. For a 192-bit key, a block consumes 77 cycles and requires 0.60 MIPS per megabit. A 256-bit key consumes 89 cycles and requires 0.70 MIPS per megabit. For each additional step in key size, this implementation requires approximately an additional 0.10 MIPS.

5.5 UDI AES Decode 32-bit Co-Processor

The AES Decode 32-bit Co-Processor hardware is a full-scale algorithm implementation. The decode co-processor is based on the same design as the encode co-processor design. As inputs, it requires only the data and the key. The co-processor holds the key in AES Decode Local memory, making no need to feed the key into the hardware except at the beginning of the first block. (This approach may also be more secure in specific applications as the key is not stored in any off chip memory.) The result from the end of each round is kept in the hardware accelerator and forwarded to the start of the next until the final decoded words are obtained.

The INV_SBOX substitution lookup, byte merging, byte transposition, and GF multiplications will be performed as in the implementation of the decode block accelerator. When a 32-bit result is obtained at the end of a round, it is fed as an input to the beginning of the next round and the hardware will continue until all four results are obtained. Each of the first three results are double buffered to protect them from corrupting the later results while the hardware is still calculating. This puts less stress on the processor since it is no longer loading and receiving data to and from the dedicated hardware at the end of each round.

The code for this implementation is as follows:

// start of AES decode 32-bit co-processor
// extended key is assumed to already be calculated according to key expansion routine
// and permuted

| | |
|---|---|
| aes_dec_cop_key_rst | //resets key_addr_p to 0 |
| lw $key_a, 0($extended_key) | |
| lw $key_b, 4($extended_key) | |
| lw $key_c, 8($extended_key) | |
| lw $key_d, 12($extended_key) | |
| aes_dec_cop_key $key_a, $key_b | // stores key to RAM and inc key_addr_p by 1 |
| lw $key_a, 16($extended_key) | |
| lw $key_b, 20($extended_key) | |
| aes_dec_cop_key $key_c, $key_d | |
| lw $key_c, 24($extended_key) | |
| lw $key_d, 28($extended_key) | |
| aes_dec_cop_key $key_a, $key_b | |
| lw $key_a, 32($extended_key) | |
| lw $key_b, 36($extended_key) | |
| aes_dec_cop_key $key_c, $key_d | |
| lw $key_c, 40($extended_key) | |
| lw $key_d, 44($extended_key) | |
| aes_dec_cop_key $key_a, $key_b | |
| lw $key_a, 48($extended_key) | |
| lw $key_b, 52($extended_key) | |
| aes_dec_cop_key $key_c, $key_d | |
| lw $key_c, 56($extended_key) | |
| lw $key_d, 60($extended_key) | |
| aes_dec_cop_key $key_a, $key_b | |
| lw $key_a, 64($extended_key) | |
| lw $key_b, 68($extended_key) | |
| aes_dec_cop_key $key_c, $key_d | |
| lw $key_c, 72($extended_key) | |
| lw $key_d, 76($extended_key) | |
| aes_dec_cop_key $key_a, $key_b | |
| lw $key_a, 80($extended_key) | |
| lw $key_b, 84($extended_key) | |
| aes_dec_cop_key $key_c, $key_d | |
| lw $key_c, 88($extended_key) | |
| lw $key_d, 92($extended_key) | |
| aes_dec_cop_key $key_a, $key_b | |
| lw $key_a, 96($extended_key) | |
| lw $key_b, 100($extended_key) | |
| aes_dec_cop_key $key_c, $key_d | |
| lw $key_c, 104($extended_key) | |
| lw $key_d, 108($extended_key) | |
| aes_dec_cop_key $key_a, $key_b | |
| lw $key_a, 112($extended_key) | |
| lw $key_b, 116($extended_key) | |
| aes_dec_cop_key $key_c, $key_d | |
| lw $key_c, 120($extended_key) | |
| lw $key_d, 124($extended_key) | |
| aes_dec_cop_key $key_a, $key_b | |
| lw $key_a, 128($extended_key) | |
| lw $key_b, 132($extended_key) | |
| aes_dec_cop_key $key_c, $key_d | |
| lw $key_c, 136($extended_key) | |
| lw $key_d, 140($extended_key) | |
| aes_dec_cop_key $key_a, $key_b | |
| lw $key_a, 144($extended_key) | |
| lw $key_b, 148($extended_key) | |
| aes_dec_cop_key $key_c, $key_d | |
| lw $key_c, 152($extended_key) | |
| lw $key_d, 156($extended_key) | |
| aes_dec_cop_key $key_a, $key_b | |
| lw $key_a, 160($extended_key) | |
| lw $key_b, 164($extended_key) | |
| aes_dec_cop_key $key_c, $key_d | |
| lw $key_c, 168($extended_key) | |
| lw $key_d, 172($extended_key) | |
| aes_dec_cop_key $key_a, $key_b | |
| aes_dec_cop_loop 9 | // initialize loop counter |
| aes_dec_cop_key $key_c, $key_d | |

// start of block
loop:

| | lw $data1, 0($buffer) | |
|---|---|---|
| | lw $data2, 4($buffer) | |
| | lw $data3, 8($buffer) | |
| | lw $data4, 12($buffer) | |
| aes_dec_cop_in_1 $data1 | | // reset the key to last 4 keys |
| // and read 4 keys from key memory | | |
| // xor data w/ key in hdw engine | | |
| | aes_dec_cop_in_2 $data2 | |
| | aes_dec_cop_in_3 $data3 | |
| | aes_dec_cop_in_4 $data4 | |
| | 36 nops | // processor needs to wait 36 cycles for results |
| | aes_dec_cop_out_1 $result1 | // obtain resulting decoded words |
| | aes_dec_cop_out_2 $result2 | |
| | aes_dec_cop_out_3 $result3 | |
| | aes_dec_cop_out_4 $result4 | |
| | sw $result1, 0($buffer) | |
| | sw $result2, 4($buffer) | |
| | sw $result3, 8($buffer) | |
| | sw $result4, 12($buffer) | |

sub $num_of_blocks, $num_of_blocks, 1
bne $num_of_blocks, loop

// end of AES decode 32-bit co-processor

The aes_dec_cop_key instructions are used to write 2 key words at a time into the UDI hardware. Once the key is in RAM, the key address pointer is moved automatically, and 4 key words are read from RAM to the engine instead of having to input the key each round.

A more optimized version of the code interleaves the next and previous cycles to make better use of the delay cycles. The code for this optimized implementation beginning with the data processing is as follows:

aes_dec_cop_loop 9

// start of block

| lw $data1, 0($buffer) | |
|---|---|
| lw $data2, 4($buffer) | |
| lw $data3, 8($buffer) | |
| lw $data4, 12($buffer) | |
| aes_dec_cop_in_1 $data1 | // put data |
| | into hw engine |
| aes_dec_cop_in_2 $data2 | |
| aes_dec_cop_in_3 $data3 | |
| aes_dec_cop_in_4 $data4 | |
| lw $data1, 16($buffer) | // start of |
| | 36 cycles |
| lw $data2, 20($buffer) | |
| lw $data3, 24($buffer) | |
| lw $data4, 28($buffer) | |
| sub $num_of_blocks, $num_of_blocks, 1 | |
| 31 nops | // end of 36 |
| | cycles |
| aes_dec_cop_out_1 $result1 | // obtain dataing |

decoded words

aes_dec_cop_out_2 $result2
aes_dec_cop_out_3 $result3
aes_dec_cop_out_4 $result4

loop:

| aes_dec_cop_in_1 $data1 | // resets the |
|---|---|
| | key address |
| aes_dec_cop_in_2 $data2 | |
| aes_dec_cop_in_3 $data3 | |
| aes_dec_cop_in_4 $data4 | |
| sw $result1, 0($buffer) | // start of |
| | 36 cycles |
| sw $result2, 4($buffer) | |
| sw $result3, 8($buffer) | |
| sw $result4, 12($buffer) | |
| addi $buffer, $buffer, 16 | |
| lw $data1, 16($buffer) | |
| lw $data2, 20($buffer) | |
| lw $data3, 24($buffer) | |
| lw $data4, 28($buffer) | |
| sub $num_of_blocks, $num_of_blocks, 1 | |
| 26 nops | // end of |

36 cycles

aes_dec_cop_out_1 $result1
aes_dec_cop_out_2 $result2
aes_dec_cop_out_3 $result3
aes_dec_cop_out_4 $result4
bne $num_of_blocks, loop
sw $result1, 0($buffer)
sw $result2, 4($buffer)
sw $result3, 8($buffer)
sw $result4, 12($buffer)

// end of AES decode 32-bit co-processor

The main loop only consumes 4 cycles. For a 128-bit key, the hardware assisted loop is executed 9 times per block, and a block consumes only 45 cycles. Encoding a megabit of data requires only 0.35 MIPS. For a 192-bit key, a block consumes 53 cycles and requires 0.41 MIPS per megabit. A 256-bit key consumes 61 cycles and requires 0.48 MIPS per megabit. For each additional step in key size, this implementation requires approximately 0.06 additional MIPS.

5.6 UDI AES Decode 64-bit Co-Processor

Even greater improvement to the decoder may be obtained by using the AES Decode 64-bit Co-Processor hardware. This implementation is based on the same design as the AES 64-bit Encode Co-Processor design. It is also almost the identical to the decode 32-bit version, but it processes two 32-bit results per round in a single clock cycle. It requires only the data and the key to calculate the results of the decryption. The 64-bit co-processor hardware acceleration implementation operates with all key sizes as longer keys simply involve executing more iterations of the main loop. The result from the end of each round is kept in the accelerator hardware and forwarded to the start of the next round without leaving the hardware until the final decoded data words are obtained.

The INV_SBOX substitution lookup, byte merging, byte transposition, and GF multiplication will be performed as in the implementation of the decode 32-bit co-processor. The two 32-bit results obtained at the end of each round are fed back to the beginning similar to the other co-processor and block accelerator implementations.

The code for this implementation is as follows:

// start of AES decode 64-bit co-processor
// extended key is assumed to already be calculated according to key expansion routine
// and permuted

| | |
|---|---|
| aes_dec_cop_key_rst | // resets key_addr_p to 0 |
| lw $key_a, 0($extended_key) | |
| lw $key_b, 4($extended_key) | |
| lw $key_c, 8($extended_key) | |
| lw $key_d, 12($extended_key) | |
| aes_dec_cop_key $key_a, $key_b | // stores key to RAM and inc key_addr_p by 1 |
| lw $key_a, 16($extended_key) | |
| lw $key_b, 20($extended_key) | |
| aes_dec_cop_key $key_c, $key_d | |
| lw $key_c, 24($extended_key) | |
| lw $key_d, 28($extended_key) | |
| aes_dec_cop_key $key_a, $key_b | |
| lw $key_a, 32($extended_key) | |
| lw $key_b, 36($extended_key) | |
| aes_dec_cop_key $key_c, $key_d | |
| lw $key_c, 40($extended_key) | |
| lw $key_d, 44($extended_key) | |
| aes_dec_cop_key $key_a, $key_b | |
| lw $key_a, 48($extended_key) | |
| lw $key_b, 52($extended_key) | |
| aes_dec_cop_key $key_c, $key_d | |
| lw $key_c, 56($extended_key) | |
| lw $key_d, 60($extended_key) | |
| aes_dec_cop_key $key_a, $key_b | |
| lw $key_a, 64($extended_key) | |
| lw $key_b, 68($extended_key) | |
| aes_dec_cop_key $key_c, $key_d | |
| lw $key_c, 72($extended_key) | |
| lw $key_d, 76($extended_key) | |
| aes_dec_cop_key $key_a, $key_b | |
| lw $key_a, 80($extended_key) | |
| lw $key_b, 84($extended_key) | |
| aes_dec_cop_key $key_c, $key_d | |
| lw $key_c, 88($extended_key) | |
| lw $key_d, 92($extended_key) | |
| aes_dec_cop_key $key_a, $key_b | |
| lw $key_a, 96($extended_key) | |
| lw $key_b, 100($extended_key) | |
| aes_dec_cop_key $key_c, $key_d | |
| lw $key_c, 104($extended_key) | |
| lw $key_d, 108($extended_key) | |
| aes_dec_cop_key $key_a, $key_b | |
| lw $key_a, 112($extended_key) | |
| lw $key_b, 116($extended_key) | |
| aes_dec_cop_key $key_c, $key_d | |
| lw $key_c, 120($extended_key) | |
| lw $key_d, 124($extended_key) | |
| aes_dec_cop_key $key_a, $key_b | |
| lw $key_a, 128($extended_key) | |
| lw $key_b, 132($extended_key) | |
| aes_dec_cop_key $key_c, $key_d | |
| lw $key_c, 136($extended_key) | |
| lw $key_d, 140($extended_key) | |
| aes_dec_cop_key $key_a, $key_b | |
| lw $key_a, 144($extended_key) | |
| lw $key_b, 148($extended_key) | |
| aes_dec_cop_key $key_c, $key_d | |
| lw $key_c, 152($extended_key) | |
| lw $key_d, 156($extended_key) | |
| aes_dec_cop_key $key_a, $key_b | |
| lw $key_a, 160($extended_key) | |
| lw $key_b, 164($extended_key) | |
| aes_dec_cop_key $key_c, $key_d | |
| lw $key_c, 168($extended_key) | |
| lw $key_d, 172($extended_key) | |
| aes_dec_cop_key $key_a, $key_b | |
| aes_dec_cop_key $key_c, $key_d | |
| aes_dec_cop_loop 9 | // initialize hdw loop counter |

// start of block
loop:

| lw $data1, 0($buffer) | |
|---|---|
| lw $data2, 4($buffer) | |
| lw $data3, 8($buffer) | |
| lw $data4, 12($buffer) | |
| aes_dec_cop_in_1 $result1, $data1, $data2 | // put data into hw engine and resets key_addr_p to 0 |
| aes_dec_cop_in_2 $result2, $data3, $data4 | |

| | |
|---|---|
| 18 nops | // processor waits for 18 cycles for UDI instructions to |

finish:

// obtain resulting decoded words
aes_dec_cop_out_1 $result3
aes_dec_cop_out_2 $result4
sw $result1, 0($buffer)
sw $result2, 4($buffer)
sw $result3, 8($buffer)
sw $result4, 12($buffer)
add $buffer, $buffer, 16
sub $num_of_blocks, $num_of_blocks, 1
bne $num_of_blocks, loop

// end of AES decode 64-bit co-processor

The aes_dec_cop_key instruction would be used to write 2 key words at a time into the UDI hardware before the first block. Once the key is in RAM, the key address pointer is moved automatically, and 4 key words are read from RAM instead of inserting the key each round.

A more optimized version of the code interleaves the next and previous blocks to make better use of the time that the processor spends waiting. The code for this optimized implementation beginning with the data processing is as follows:

| | |
|---|---|
| aes_dec_cop_loop 9 | // initialize |

hdw loop counter

// start of block

| lw $data1, 0($buffer) | |
|---|---|
| lw $data2, 4($buffer) | |
| lw $data3, 8($buffer) | |
| lw $data4, 12($buffer) | |
| aes_dec_cop_in_1 $zero, $data1, $data2 | // put data |
| | into hw engine |
| aes_dec_cop_in_2 $zero, $data3, $data4 | |
| lw $data1, 16($buffer) | //start of |
| | 18 cycles |
| lw $data2, 20($buffer) | |
| lw $data3, 24($buffer) | |
| lw $data4, 28($buffer) | |
| sub $num_of_blocks, $num_of_blocks, 1 | |
| 13 nops | // end of |

18 cycles

loop:

| aes_dec_cop_in_1 $result1, $data1, $data2 | // resets key_{—} |
|---|---|
| | addr_p to 0 |
| aes_dec_cop_in_2 $result2, $data3, $data4 | |
| aes_dec_cop_out_1 $result3 | |
| aes_dec_cop_out_2 $result4 | |
| sw $result1, 0($buffer) | // start of |
| | the 18 cycles |
| sw $result2, 4($buffer) | |
| sw $result3, 8($buffer) | |
| sw $result4, 12($buffer) | |
| add $buffer, $buffer, 16 | |
| lw $data1, 16($buffer) | |
| lw $data2, 20($buffer) | |
| lw $data3, 24($buffer) | |
| lw $data4, 28($buffer) | |
| sub $num_of_blocks, $num_of_blocks, 1 | |
| 8 nops | // end of |

18 cycles

aes_dec_cop_out_1 $result1
aes_dec_cop_out_2 $result2
aes_dec_cop_out_3 $result3
aes_dec_cop_out_4 $result4
bne $num_of_blocks, loop
sw $result1, 0($buffer)
sw $result2, 4($buffer)
sw $result3, 8($buffer)
sw $result4, 12($buffer)

// end of AES decode 64-bit co-processor

The main loop only consumes 2 cycles. For a 128-bit key, the hardware assisted loop is executed 9 times per block, and a block consumes only 20 cycles. Encoding a megabit of data requires only 0.16 MIPS. For a 192-bit key, a block consumes 24 cycles and requires 0.19 MIPS per megabit. A 256-bit key consumes 28 cycles and requires 0.22 MIPS per megabit. For each additional step in key size, this implementation requires approximately 0.03 additional MIPS.

5.7 UDI AES Decode 128-bit Co-Processor

In the same fashion, the UDI AES Decode 64-bit Co-Processor can be modified to produce 128-bit results every clock cycle. Extending the Co-Processor to 128-bits results in a cleaner, straight through design. In this fashion, data is held in registers until an entire block is input into the hardware. The data is exclusive-or'd with the key on the first round and transposed. The data is then substituted from values in the SBOX ROM's and exclusive-or'd with values from the Galois Field blocks. At the end of each clock cycle one round of AES encryption is finished. The results are fed back to the beginning of the Co-Processor until all of the rounds are completed.

The main differences between the 128-bit encode and 128-bit decode co-processors are that the decoder uses GF9, 11, 13, and 14 instead of GF2 and 3. The 128-bit decode exclusive-or's a word from the key with each row before the GF multiplies instead of in parallel with the GF multiplies. The shift row and mix column computations are inversed for the decoder as well. Otherwise, the 128-bit encoder and 128-bit decoder are almost identical.

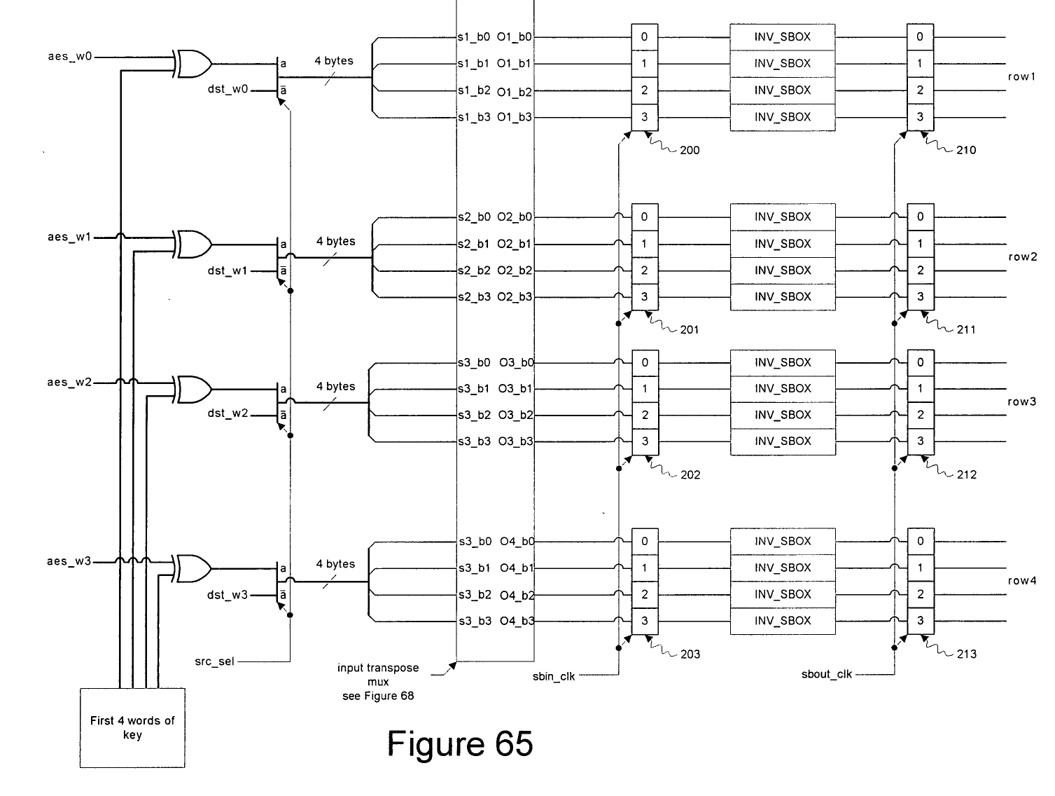

An alternative to this approach is to interleave the processing of AES blocks coming into the hardware by adding additional registers to create a pipelined architecture. The AES algorithm typically does not tolerate pipeline delays since all the data from one round must be completed prior to the computation of the next round. We exploit this fact as we perform the AES algorithm on two blocks of information to be encrypted. The two blocks may be sequential, similar, identical, or very different. The blocks of data are loaded into the hardware two words at a time to prepare the Co-Processor for encryption. When the last of the data is input into the hardware, the next cycle starts the AES encryption on the first block. The data is exclusive-or'd with the key, transposed, and stored inside registers (sbin registers) just before the SBOX ROM's. These registers are shown on FIG. 65 as elements 200 through 203. On the second cycle of the encryption, the first block is sent to the SBOX ROM's where the results are stored inside the registers (sbout registers). These registers are shown on FIG. 65 as elements 210 to 213. The second block begins its first cycle, the result of which is stored inside the sbin registers. The processing of the blocks continues in this way as the first block loops back to the beginning of the hardware and the second block flows into the SBOX ROM's.

The data is interleaved to allow for higher clock rates because the SBOX ROM's consume the most amount of time and are the biggeset contributor to the critical path. This is an optimal time order for the combined computation of two AES blocks using interleaved hardware.

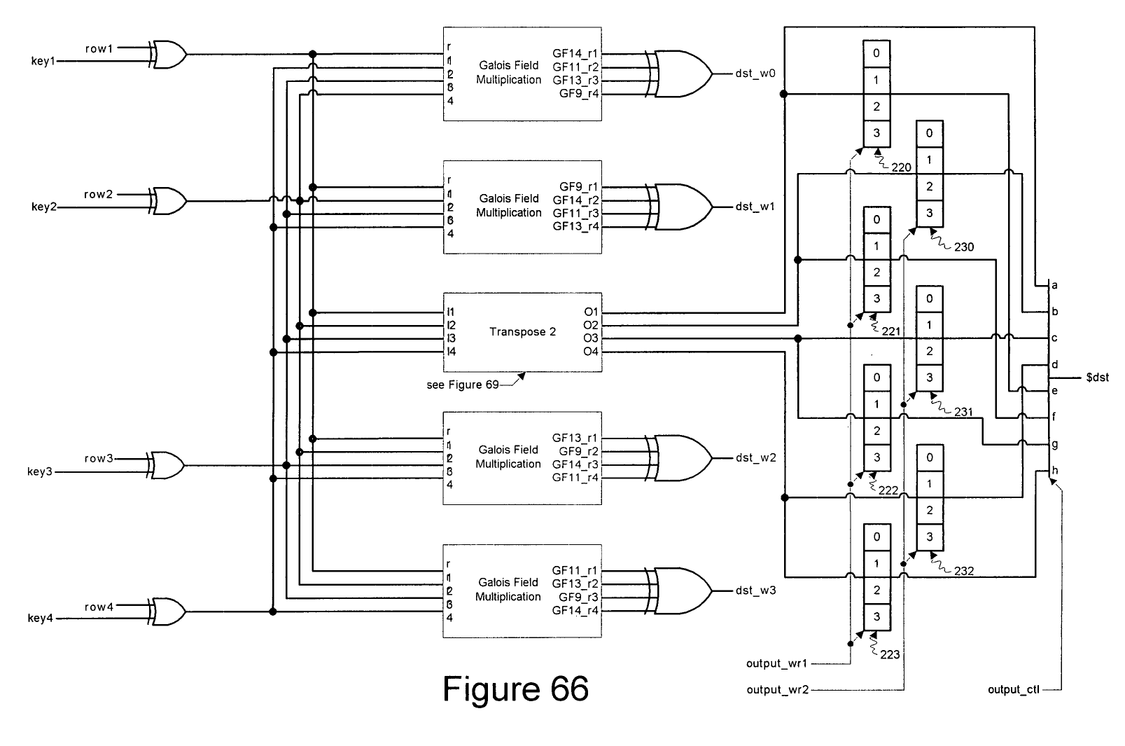

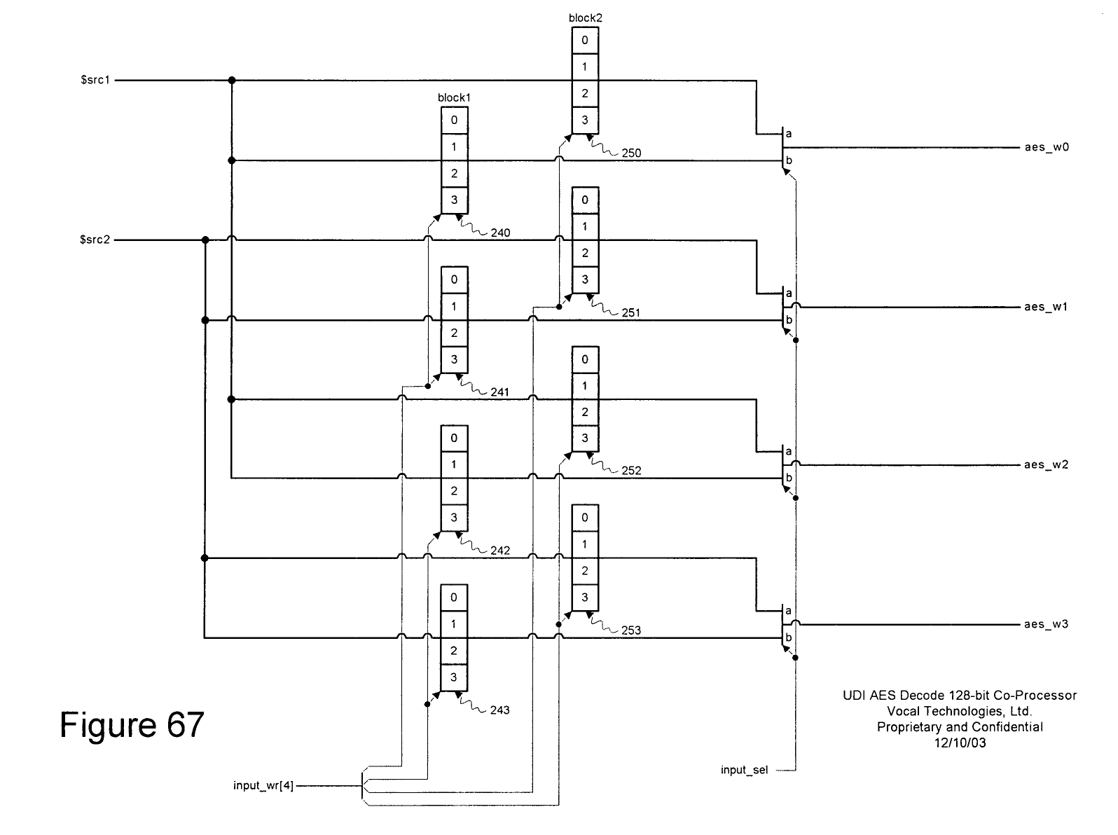

Using the interleaved implementation allows the processor to make use of 18 delay cycles during the AES encryption. During this time the processor can load new data from memory into registers, input the new data into the hardware, and also receive and store the results from the previous blocks. Additional internal registers are necessary at the beginning (or input) and at the end (or result or output) of the co-processor to buffer data transferred between the AES hardware and the processor. The registers at the beginning of the co-processor are shown on FIG. 67, where elements 240 through 243 are registers to hold a first new data set and elements 250 to 253 are registers to hold a second new data set. The registers at the end of the co-processor are shown on FIG. 66, where elements 220 through 223 are registers to hold a first set of results and elements 230 to 232 are registers to hold a second set of results.

If the main loop for this implementation is unrolled to process 4 blocks, an entire block only consumes 12.5 cycles for a 128-bit key and a megabit only consumes 0.10 MIPS. For a 192-bit key, a block would consume 12.5 cycles and 0.10 MIPS. A 256-bit key would consume 14 cycles and 0.11 MIPS. For each step in key size this implementation requires approximately an additional 0.01 MIPS.

5.7 1.28-bit Interleaved CCMP Implementation

The 128-bit AES Interleaved CCMP implementation employs a 128-bit AES Co-Processor to perform all of the AES encryption in CBC-MAC mode. In this implementation the encryption of the data and the MIC (Message Integrity Code) are interleaved. There are registers placed around the SBOX to split up the data processing. While the MIC data is going through the SBOX, the nonce (initialization vector) is going through the rest of the AES Co-Processor. The SBOX substitution is typically created as a ROM. The advantage of this method is that the SBOX ROM is pipelined to have an entire cycle to perform the substitution, which scales better for faster clock rates. Using this method allows for pipelining of the data in the same way as the stand alone 128-bit AES Co-Processor.

At the beginning of the CCMP encryption algorithm, the nonce is created by parsing components of the header and feeding them into the CCMP hardware using the aes_ccmp128_nonce instruction. The nonce is written one halfword at a time into internal hardware registers used for saving the nonce until it is needed by the hardware. This allows the nonce data to be buffered in hardware and the processor is therefore only required to fetch the plaintext data during the encryption of the data.

Next, the nonce is encrypted in preparation for the MIC. The aes_ccmp128_aes instruction is used for the purpose of encrypting the nonce. The encrypted nonce is stored in the registers of the 128-bit AES Co-Processor. The aes_ccmp128_in_{—}1 and aes_ccmp128_in_{—}2 instructions are executed next, writing two words of the AAD (Additional Authentication Data) into the hardware at a time. On the execution of the aes_ccmp128_aad instruction, the four words of the AAD are exclusive-or'd and the AES engine goes to work encrypting the MIC. This process takes 18 delay cycles in which the engine encrypts the data autonomously while the processor is executing useful instructions.

Another form of the AAD instruction is the aes_ccmp128_aad_nonce instruction, which performs the last encryption of the AAD exclusive-or'd with the MIC, and at the same time encrypts the nonce in preparation for the data. The counter inside the nonce is set to 1 using the aes_ccmp128_nonce instruction. The aes_ccmp128_in_{—}1 and aes_ccmp128_in_{—}2 instructions send two words of data each into the s buffers for encryption and for the MIC. If the data starts on a half word boundary aes_ccmp128_align_in_{—}1, aes_ccmp128_align_in_{—}2, and aes_ccmp128_align_in_{—}3 instructions are used in order to align the data when it comes into the hardware. On the execution of the aes_ccmp128_data_mic instruction, the full 128-bits of data is exclusive-or'd with the encrypted nonce. All four of the encrypted data words are sent to the output buffers, and the first word is also sent out to the destination register. Simultaneously, the plaintext data is given to the MIC where it is exclusive-or'd with the current MIC and the MIC is encrypted in preparation to receive the next block of data. The aes_ccmp128_out instruction is used during the 18 delay cycles of the AES encryption of the MIC and the nonce. It is used to fetch the rest of the encrypted words that were saved in the output buffer while the hardware is off encrypting the nonce for the next block.

After the data has gone through the CCMP hardware, the counter of the nonce is set to zero using the aes_ccmp_nonce instruction. The aes_ccmp_data_mic instruction is used to encrypt the nonce and the mic one final time. The aes_ccmp128_mic_{—}1 and aes_ccmp128_mic_{—}2 instructions are used to exclusive-or the MIC with the encrypted nonce to produce the final MIC value. The first word of the final MIC value is output to the destination register and the second word is saved in the output buffers until fetched using the aes_ccmp128_out instruction.

6. Typical Performance

6.1 Encoder Performance

The following table summarizes the number of MIPS required to encode 1 megabit of user data using the three AES key sizes for each of the three implementations:

| Encoder Implementation | 128-bit key | 192-bit key | 256-bit key | ROM | Gates |
|---|---|---|---|---|---|
| Optimized MIPS Assembly | 6.0 | 7.3 | 8.6 | none | none |
| UDI AES Primitives | 3.1 | 3.7 | 4.3 | 1024 bytes | 1,304 |
| UDI AES Round Accelerator | .91 | 1.1 | 1.2 | 2048 bytes | 5,160 |
| UDI AES 32-bit Block Accelerator | .50 | .59 | .69 | 1024 bytes | 5,928 |
| UDI AES 32-bit Co-Processor | .35 | .41 | .48 | 1024 bytes | 7,144 |
| UDI AES 64-bit Co-Processor | .16 | .19 | .22 | 2048 bytes | 10,576 |
| UDI AES 128-bit Co-Processor | .10 | .10 | .11 | 4096 bytes | 18,224 |

Each of the UDI implementations is a hardware block specifically designed for the implementation. ROM space is required to provide table lookup for byte substitution in hardware and for saving results obtained by the hardware blocks. Due to the operand data manipulation requirements, all of the implementations after and including the AES Round Accelerator maintain a state consisting of the 16 bytes of data within each block. All of the co-processor implementations also maintain the state of the entire key. This state would need to be preserved and restored in case of a context switch if other processes would need the same functionality. Encode and decode data are stored in separate state registers to allow for independent encode and decode processes.

6.2 Decoder Performance

The following table summarizes the number of MIPS required to decode 1 megabit of user data using the three AES key sizes for each of the three implementations:

| Decoder Implementation | 128-bit key | 192-bit key | 256-bit key | ROM | Gates |
|---|---|---|---|---|---|
| Optimized MIPS Assembly | 6.5 | 7.7 | 8.9 | none | none |
| UDI AES Primitives | 3.6 | 4.3 | 5.0 | 1024 bytes | 2,606 |
| UDI AES Round Accelerator | 1.0 | 1.2 | 1.3 | 2048 bytes | 6,880 |
| UDI AES 32-bit Block Accelerator | .50 | .59 | .69 | 1024 bytes | 7,872 |
| UDI AES 32-bit Co-Processor | .35 | .41 | .48 | 1024 bytes | 6,976 |
| UDI AES 64-bit Co-Processor | .16 | .19 | .22 | 2048 bytes | 15,632 |
| UDI AES 128-bit Co-Processor | .10 | .10 | .11 | 1024 bytes | 29,584 |

Each of the UDI implementations is a hardware block specifically designed for the implementation. ROM space is required to provide table lookup for byte substitution in hardware and for saving results obtained by the hardware blocks. Due to the operand data manipulation requirements, the AES Acceleration Engine maintains a state consisting of the 16 bytes of data within each block. This state would need to be preserved and restored in case of a context switch if other processes would need the same functionality. Encode and decode data are stored in separate state registers to allow for independent encode and decode processes.

7. Program File Description

The some of actual implementation of the optimized source code is provided in the attachments to this document.

The original implementation of code used was based upon the Advanced Encryption Standard by the Federal Information Processing Standards Publication. The attached files represent an unoptimized version of this original code are the following:

aes_driver.c
cipher.h
cipher32.c
decipher32.c
extended_key.h
inv_sbox.h
s_box.h

The psuedo-assembly files for modeling the optimal encoder hardware implementations are the following:

aes_enc_prim.s
aes_enc_rnd.s
aes_enc_blk_32b.s
aes_enc_32b_cop.s
aes_enc_32b_cop_opt.s
aes_enc_64b_cop.s
aes_enc_64b_cop_opt.s
aes_enc_128b_cop_opt.s

The psuedo-assembly files for modeling the optimal decoder hardware implementations are the following:

aes_dec_prim.s
aes_dec_rnd.s
aes_dec_blk_32b.s
aes_dec_32b_cop.s
aes_dec_32b_cop_opt.s
aes_dec_64b_cop.s
aes_dec_64b_cop_opt.s
aes_dec_128b_cop_opt.s

The hardware design files for modeling the 128-bit CCMP Interleaved Implementation are the following:

aes_encode_128.v
bus_sel_2_1_gates.v
bus_xor2.v
Bus_XOR5.v
byte_ff.v
GF_Mult2.v
GF_Mult3.v
mux_16_1.v
pass_en_word_mux.v
sbox.v
sbox_rom.v
Transpose1st_Mux.v
Transpose_mux.v
word_sel2.v
word_xor2.v
Word_XOR5.v
bit_ff.v
Bus_2XOR.v
bus_sel_3_1_gates.v
bus_sel_5_1_gates.v
byte_fcs.v
ccmp_128.v
ccmp_128_top.v
ccmp_state_128.v
counter_16bit.v
crc32_d8.v
data_alignment_128.v
fcs.v
gf2_word.v
gf3_word.v
ir_ff.v
keys_1234.v
key_ff.v
loop_cnt_ff.v
nonce.v
options.h
readme.txt
sbox.dat
test_ccmp_11.v
word_3_1_sel.v
word_5_1_sel.v

The hardware optimizations extend the instruction base of the MIPS instruction set architecture. The AES algorithm is able to take advantage of these instructions and these optimizations are significant toward the actual implementation of the hardware assisted AES algorithm.

8. Hardware Diagram Description

The diagrams show the hardware implementations for the hardware accelerators and co-processors. The implementations are divided into diagrams as discussed below.

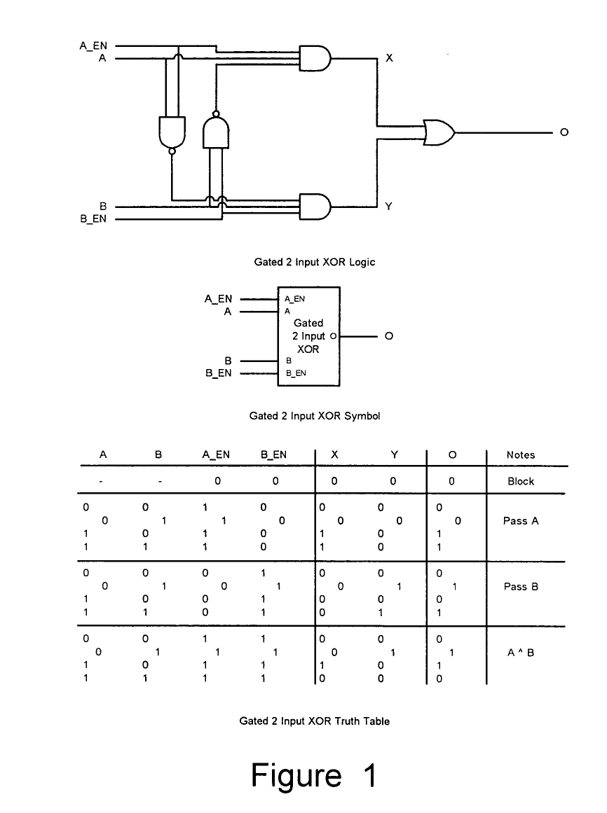

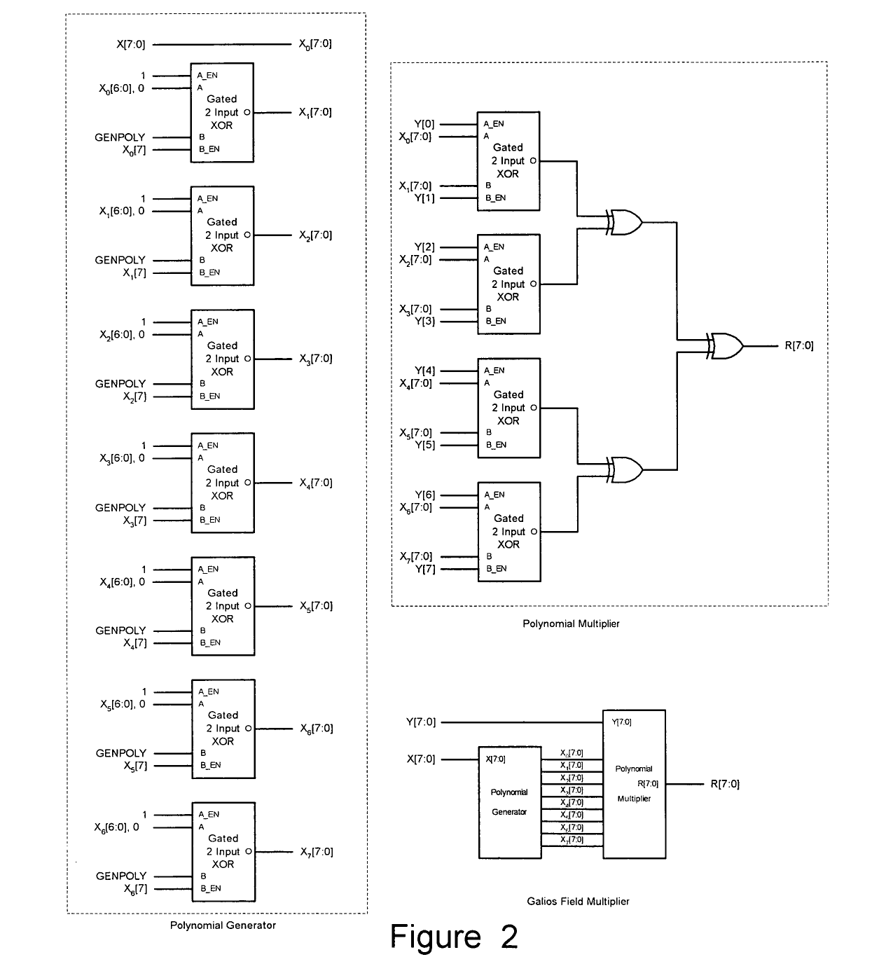

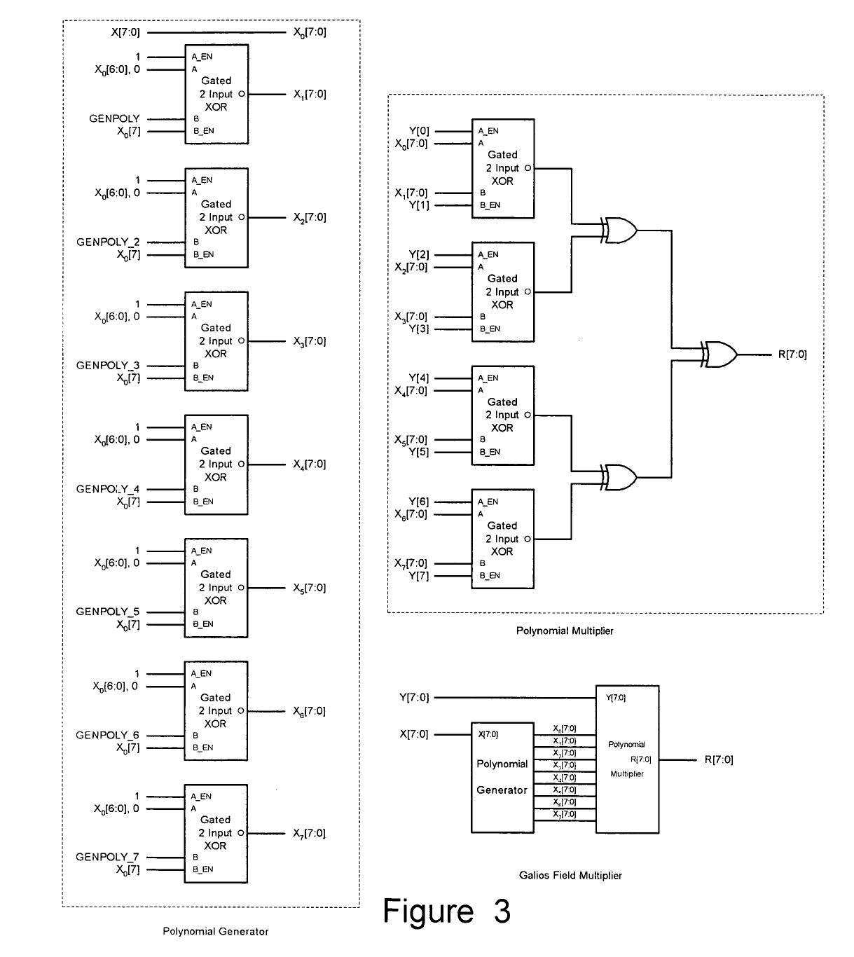

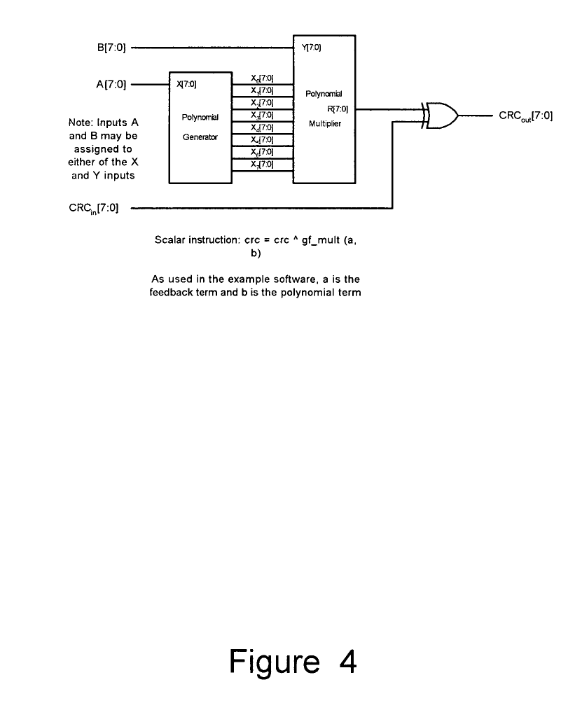

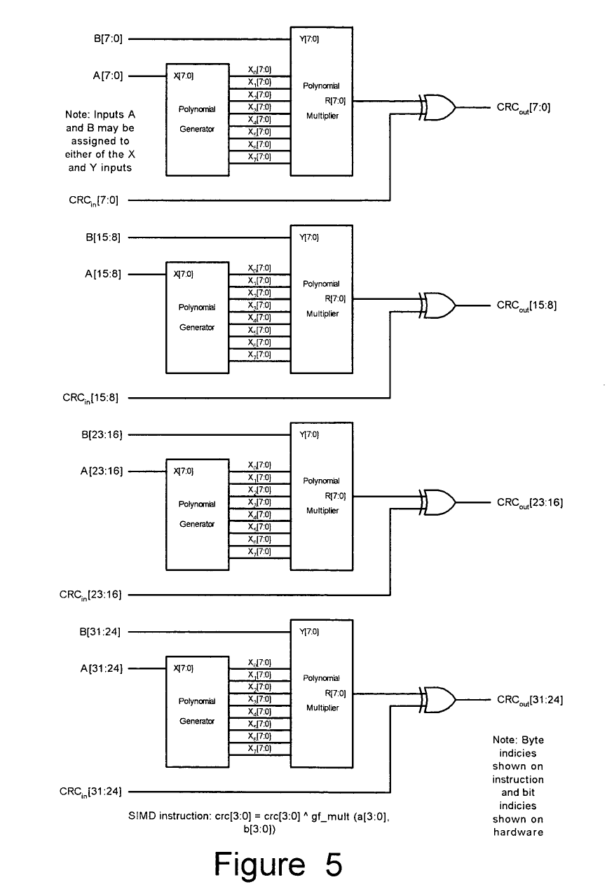

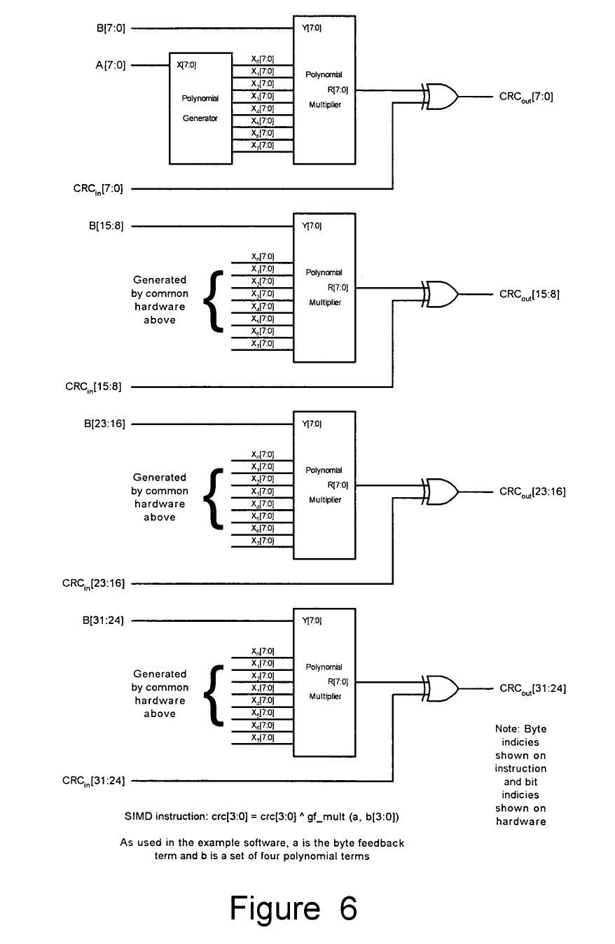

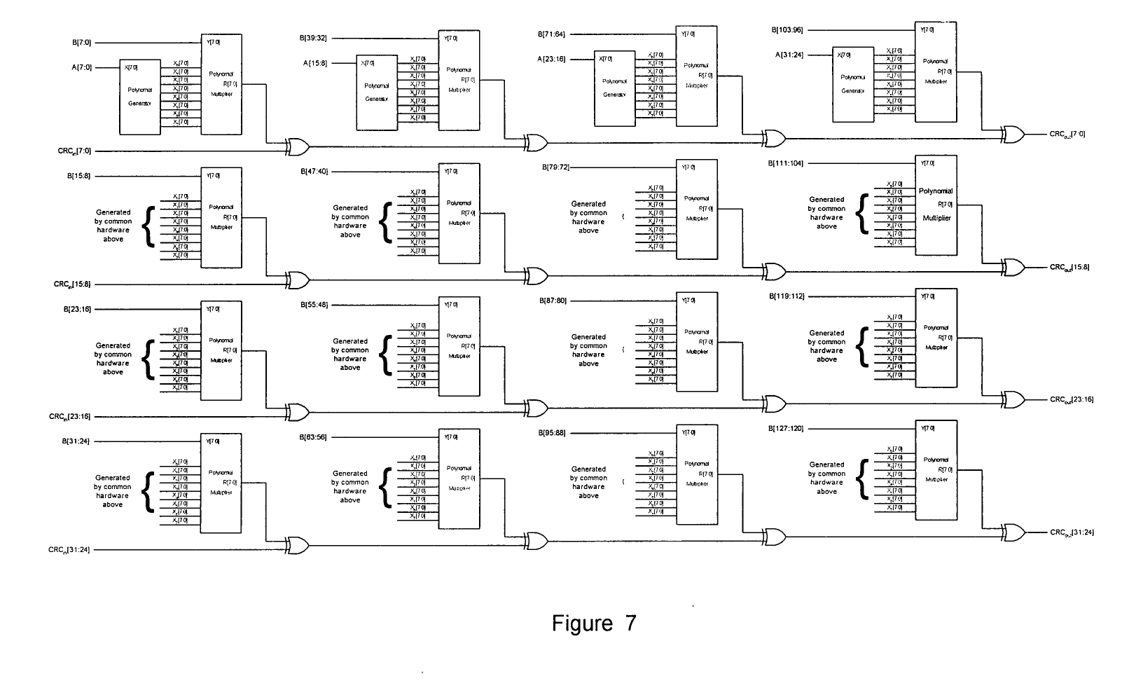

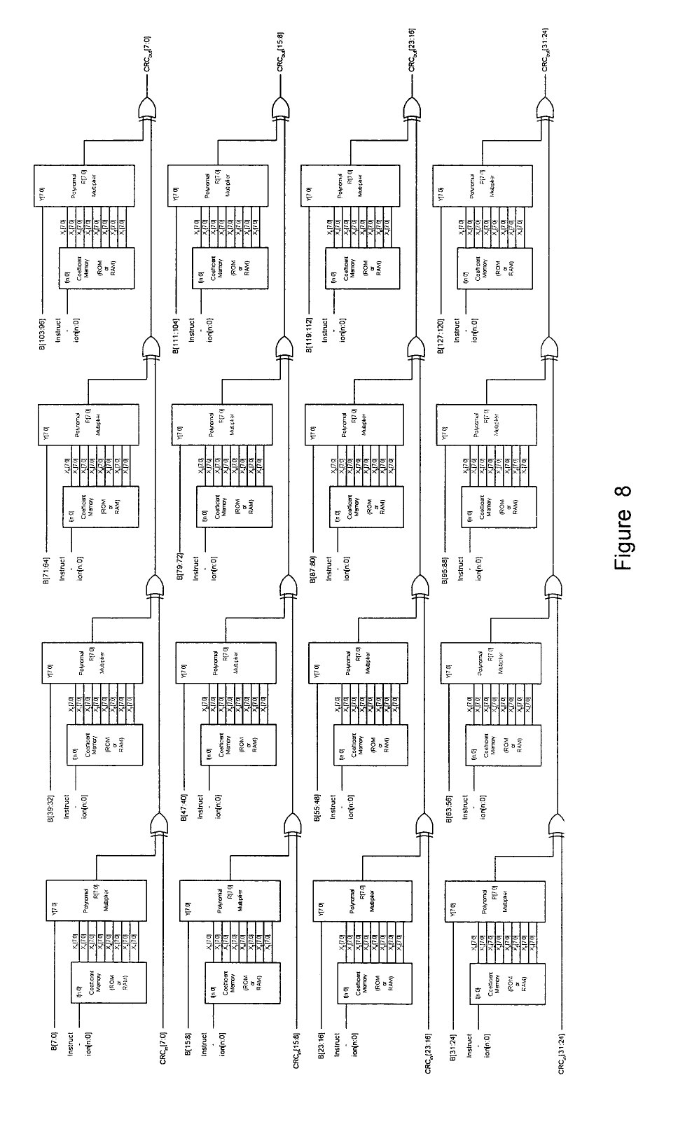

FIG. 1 through 8 illustrate a design of a general purpose Galois Field Scalar and SIMD multiplier circuit. The design may be further optimized knowing that one operand is a constant such as 2, 3, 9, 11, 13, or 14 as used by the AES encoder and decoder algorithms.

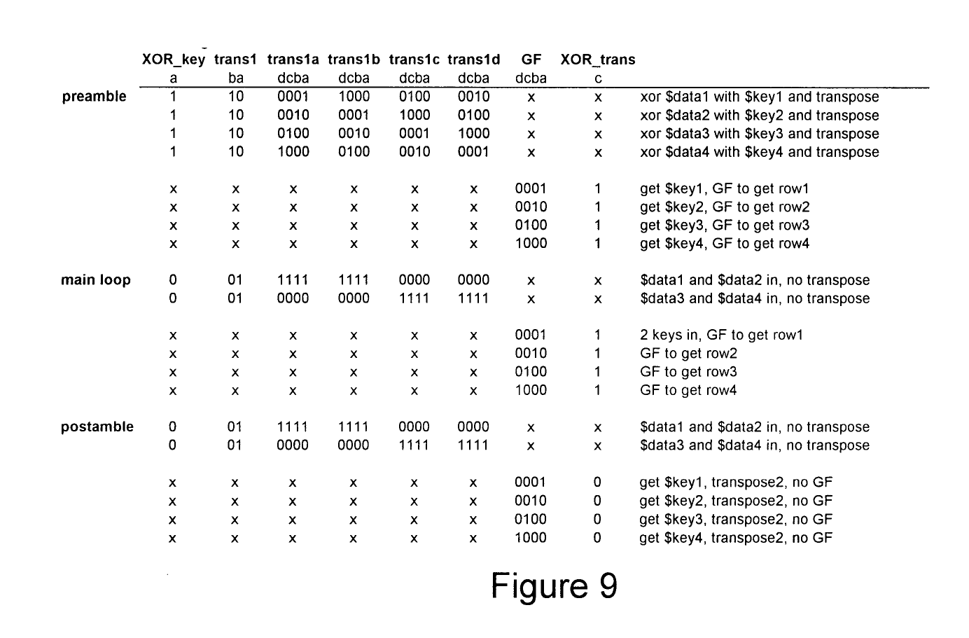

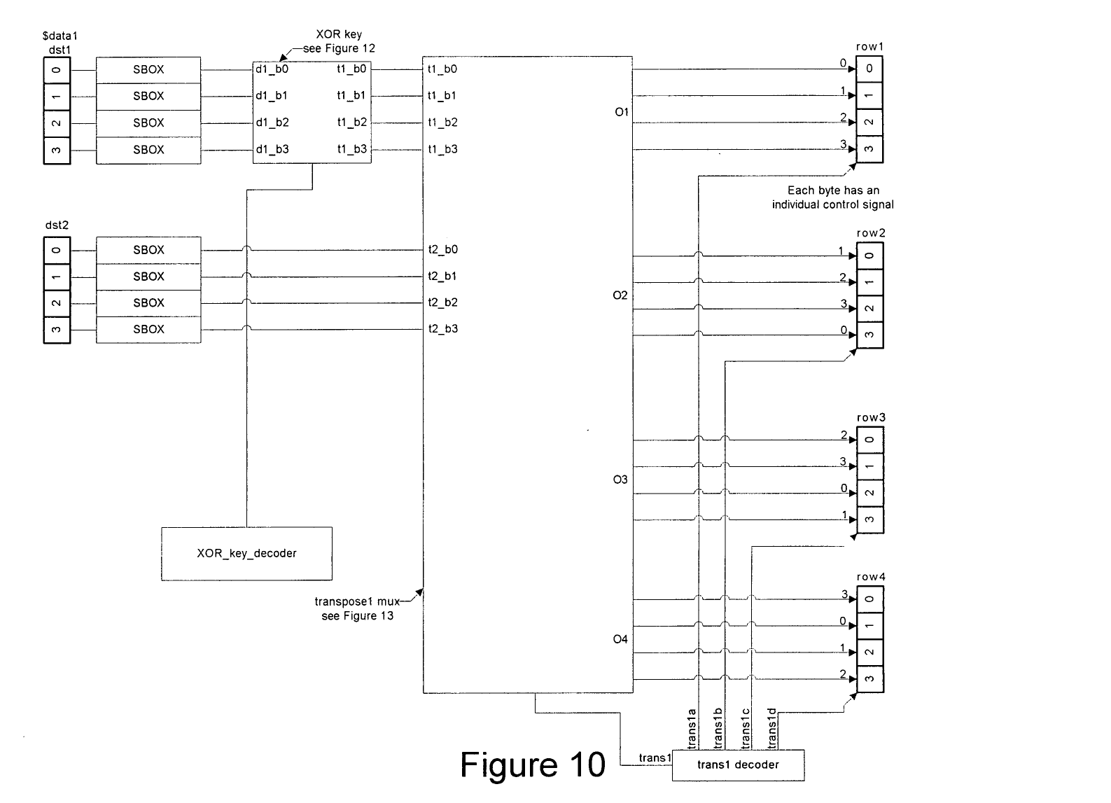

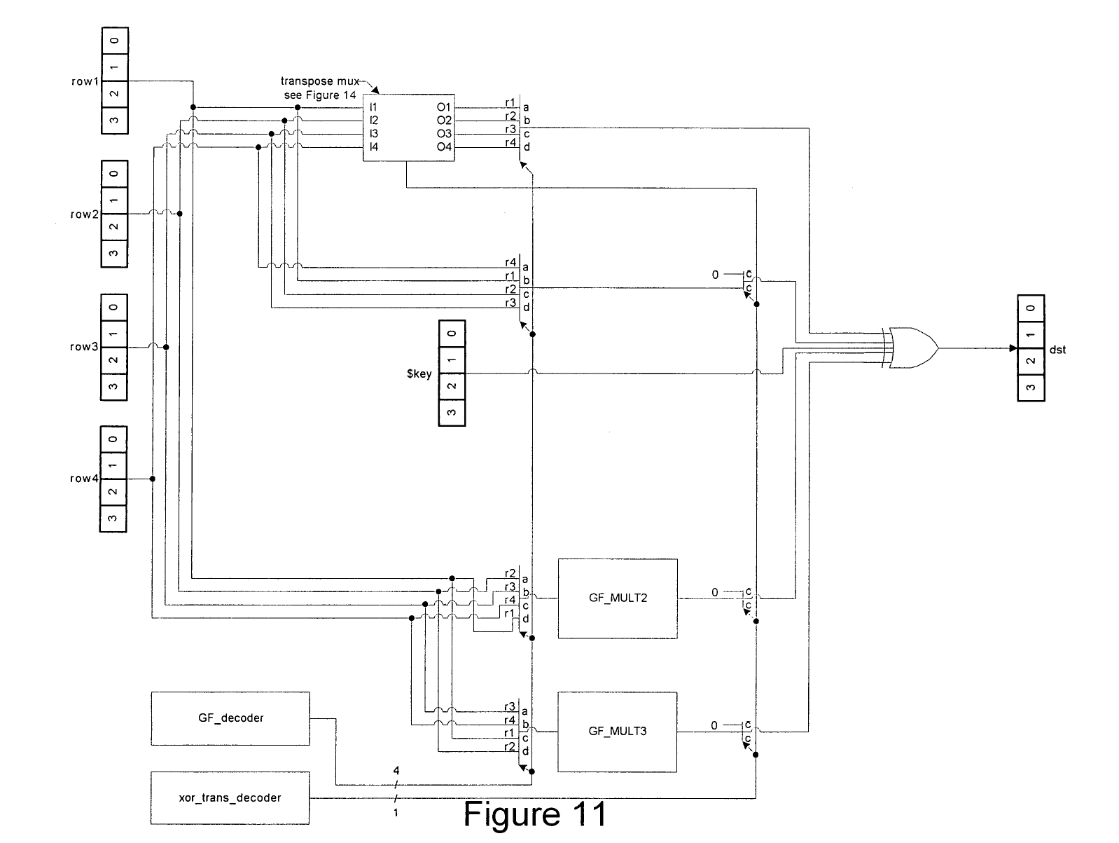

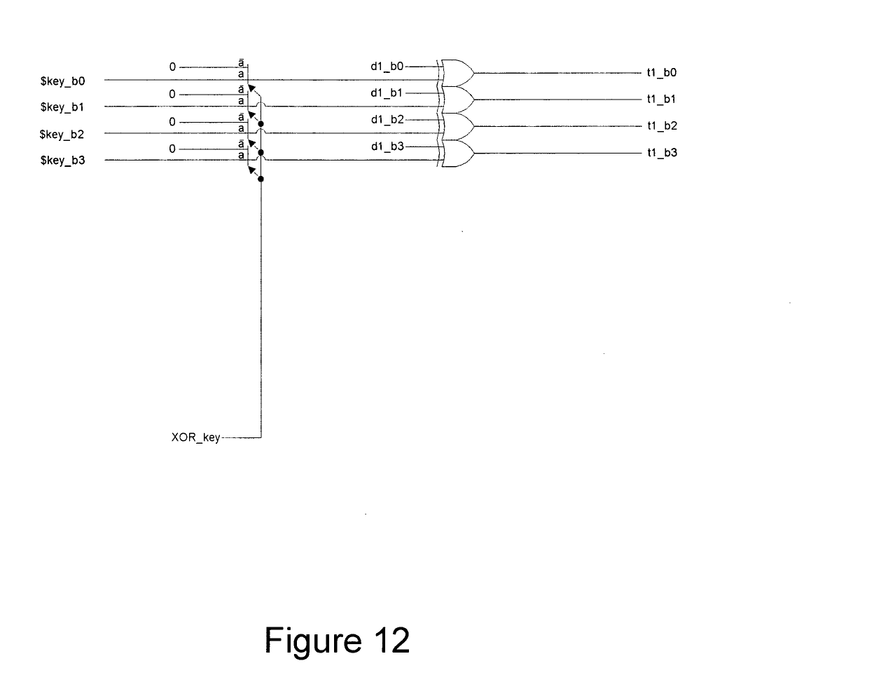

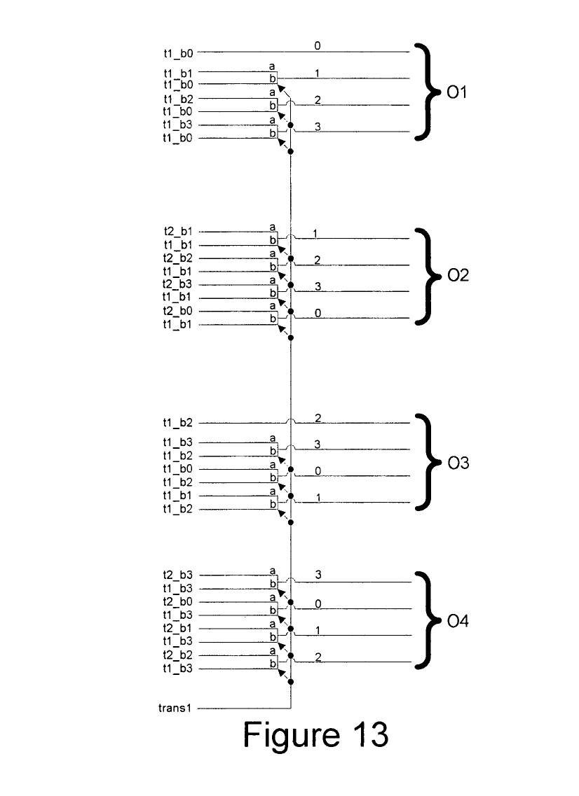

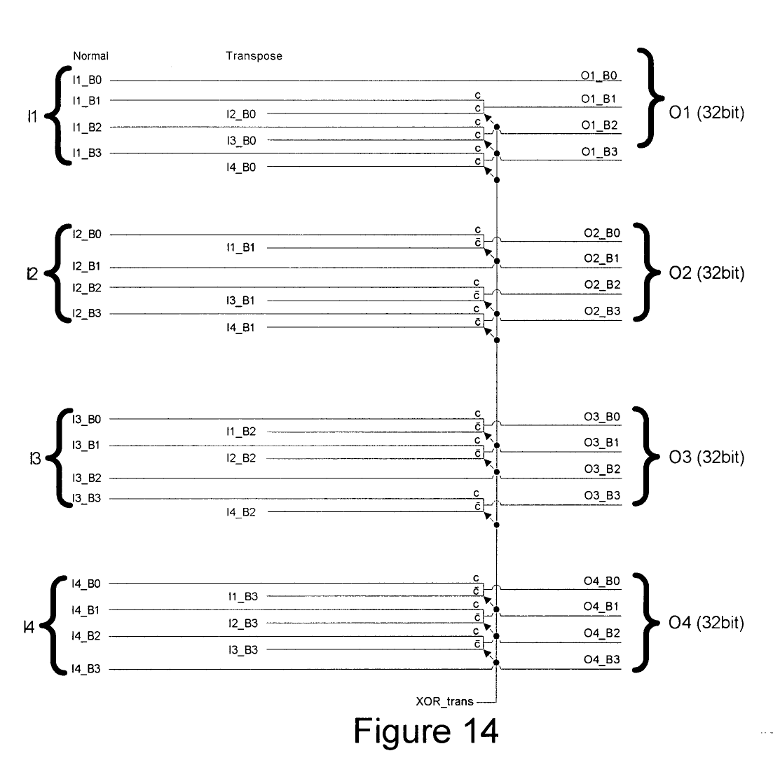

FIG. 9 through 14 displays the hardware necessary for the implementation of the AES Encode Round Accelerator. FIG. 10 shows the hardware for the aes_enc_rnd_pre_in_{—}1/2 and aes_enc_rnd_in_{—}1/2 instructions. There are 2 source registers, $data1 and $data2. As the bytes from the source registers come into the hardware, they are immediately used as the index of each SBOX lookup. All 8 lookups are performed in parallel. The SBOX lookup is held on a ROM inside the hardware. The output from the SBOX lookup is multiplexed in order to distinguish between the different input instructions. The aes_enc_rnd_pre_in_{—}1/2 perform the exclusive-or with the key as shown in FIG. 12. If the instruction being performed is the aes_enc_rnd_in_{—}1, the results from the SBOX lookup are sent to buried state registers, row1 and row2. If the aes_encr_rnd_in_{—}2 instruction is performed, the results are sent to row3 and row4. The results are oriented in such a way that the byte rotation by 0, 1, 2, or 3 bytes is performed on the result as it is being sent to the buried state registers. The buried state registers hold the results until the next half of the engine is executed during the aes_enc_rnd_out_{—}1/2/3/4 instructions. FIG. 11 displays the hardware necessary for the implementation of the aes_enc_rnd_out_{—}1/2/3/4 instructions. There is a single source register for each instruction, which holds the key data. During each output instruction it obtains data from each of the buried state row registers and chooses a single word to perform GF2 multiplication and a single word to perform GF3 multiplication. The data from the two unaltered rows, the GF2 multiplication, the GF3 multiplication, and the $src register is then exclusive-or'd together to form the result that is output to the $dst register. The aes_enc_rnd_post_out_{—}1/2 instructions simply bypass the GF multiplication which is skipped for the last round.

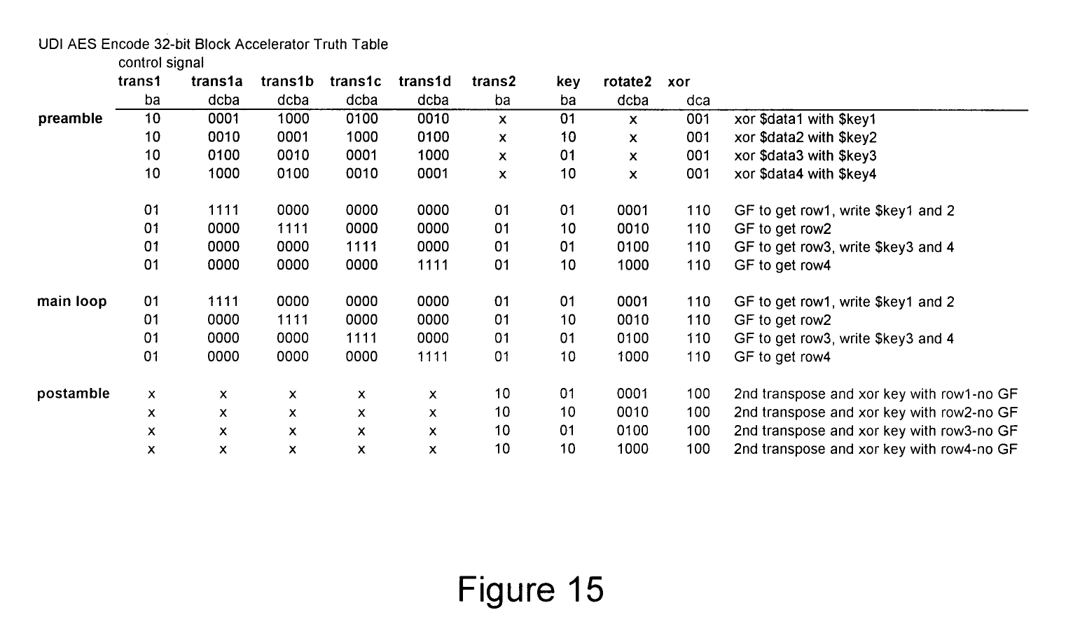

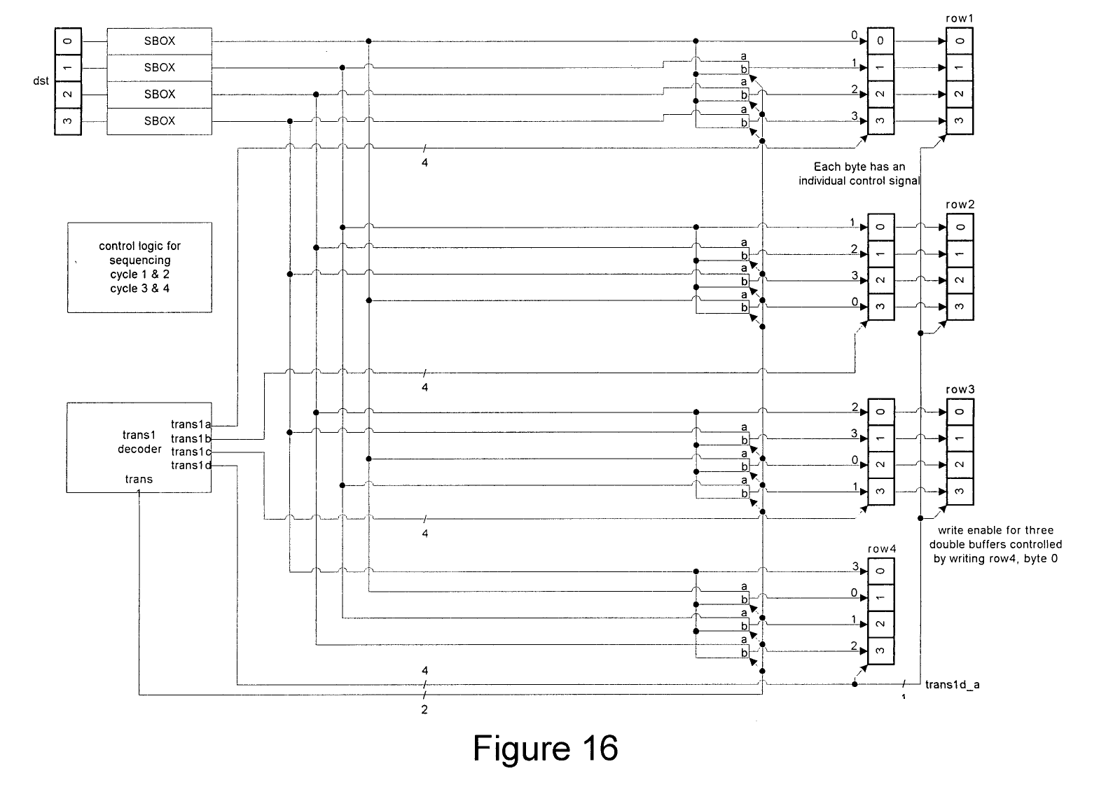

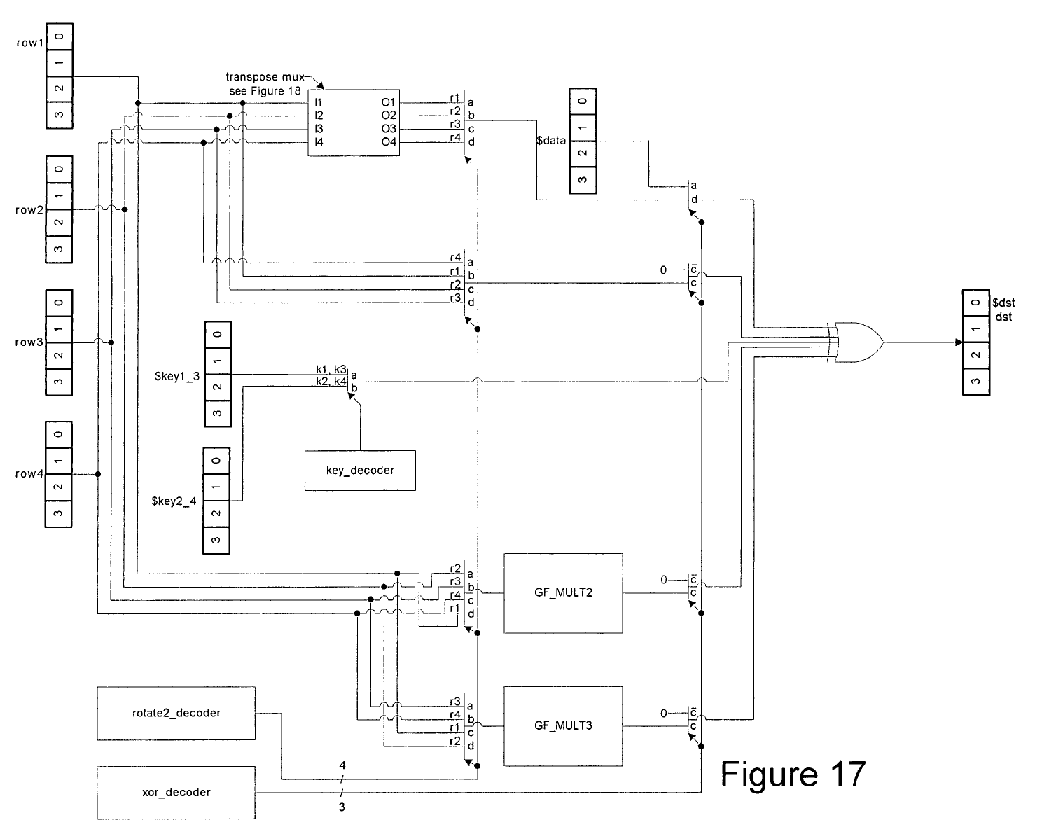

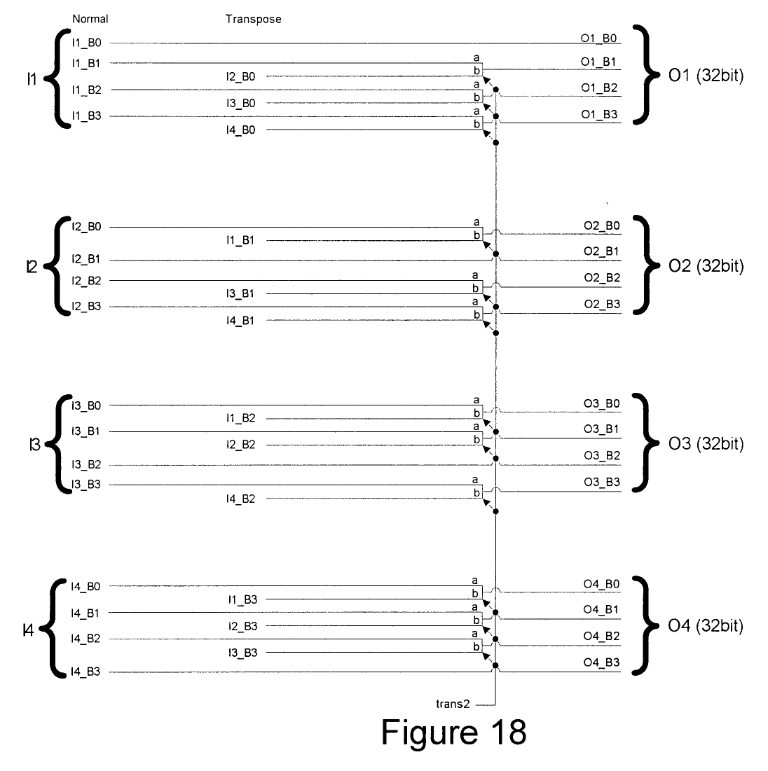

FIG. 15 through 18 display the AES Encode 32-bit Block Accelerator implementation. It is almost the same as the round accelerator except that it routes the data back to the beginning of the hardware for the next round. This implementation starts at $data register in FIG. 17, where the exclusive-or with the key takes place. The key is written into two registers and the hardware chooses the first or the second for each cycle. Each time the aes_enc_blk key instruction puts two keys in, the first key is used right away and the second key is used during the next cycle. This creates a nop as far as the processor is concerned immediately after the aes_enc_blk_key instruction.

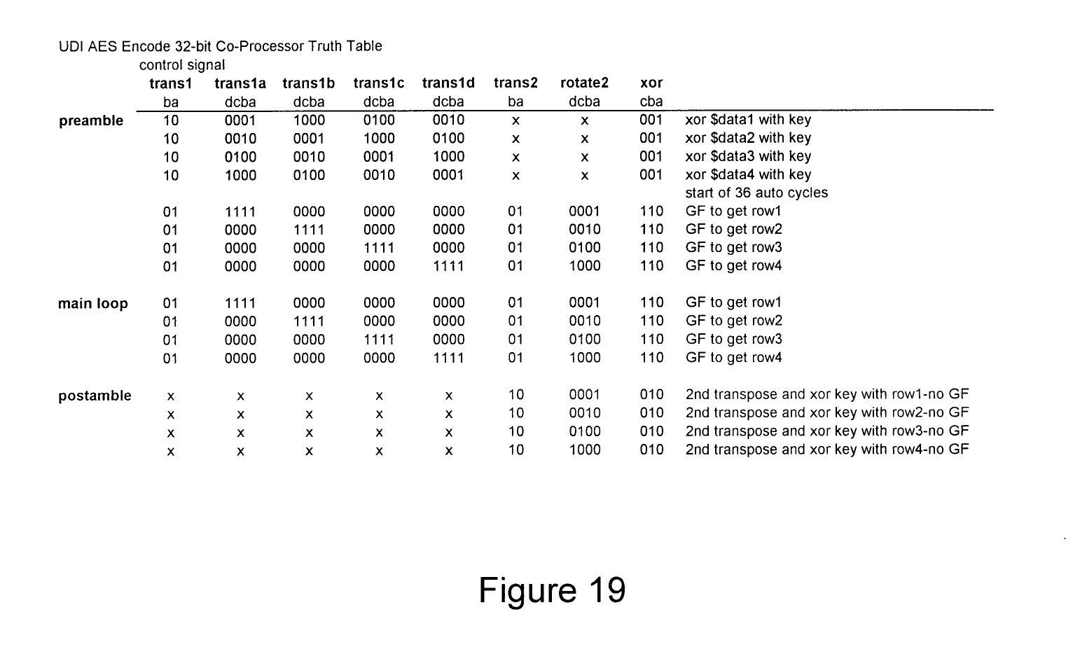

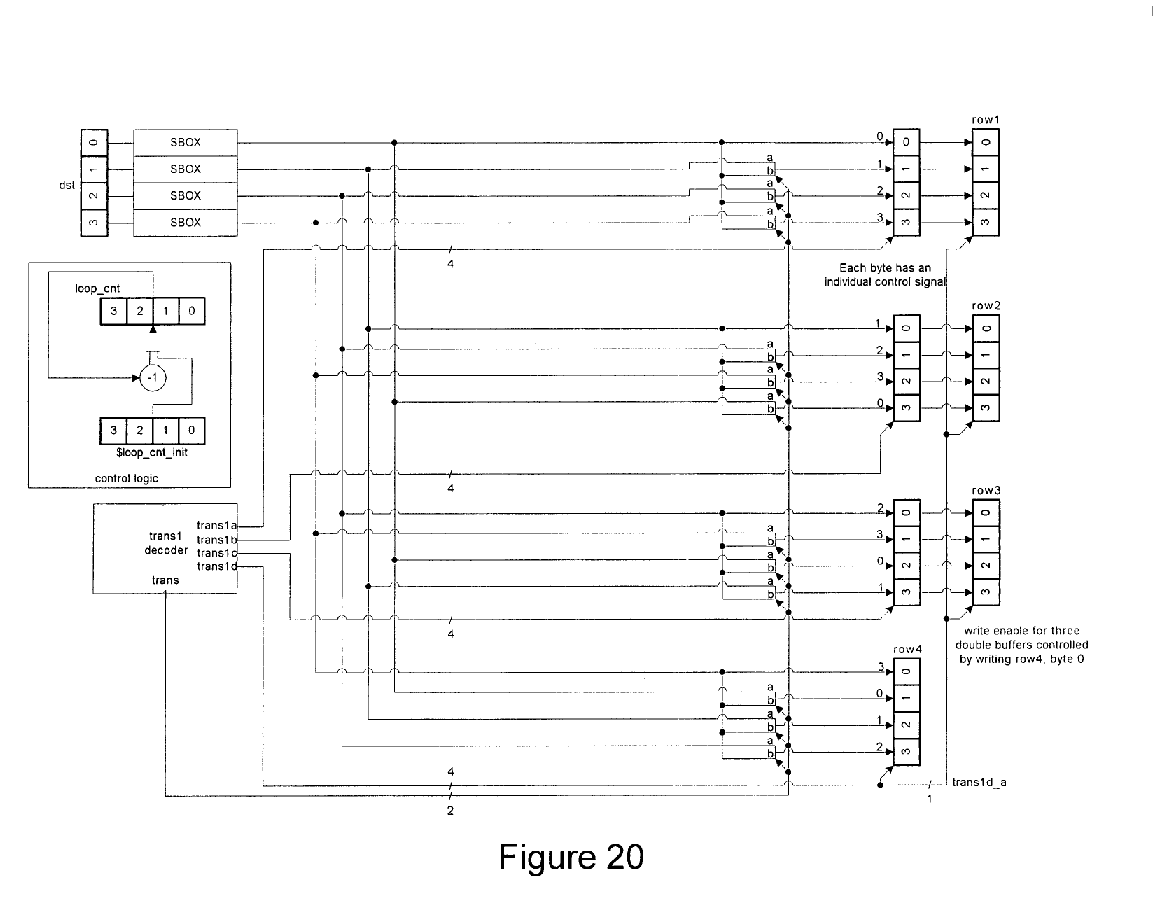

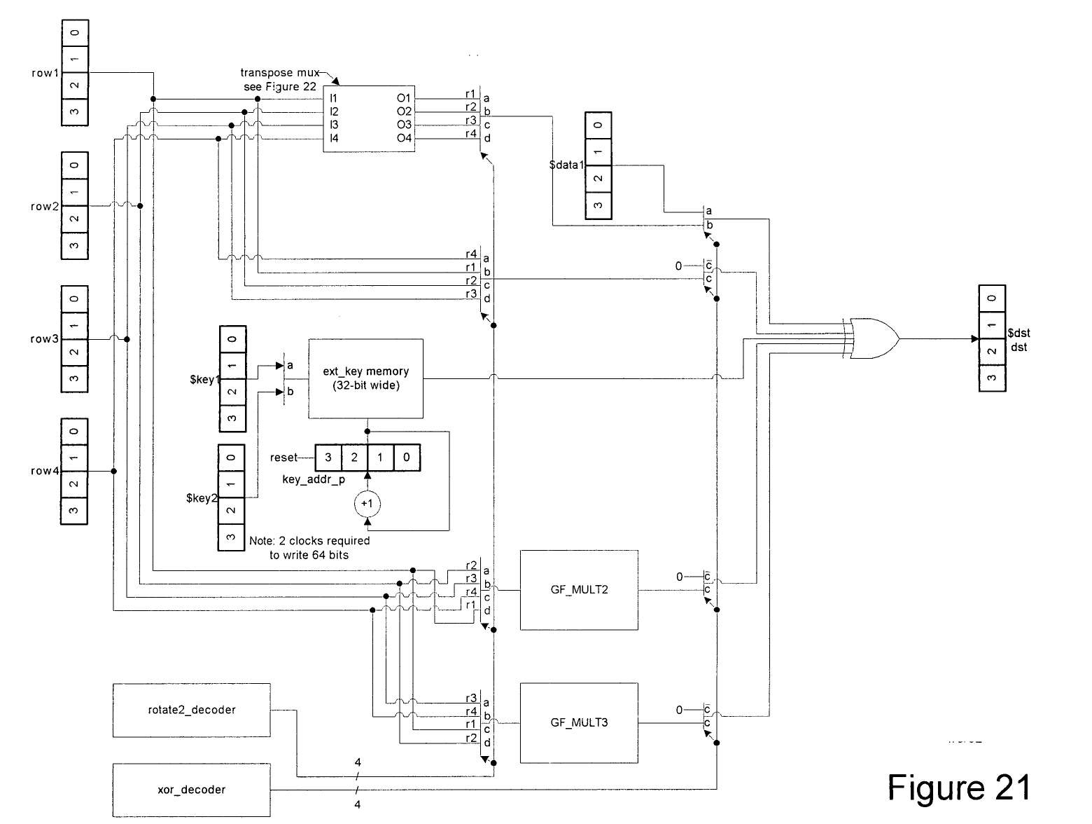

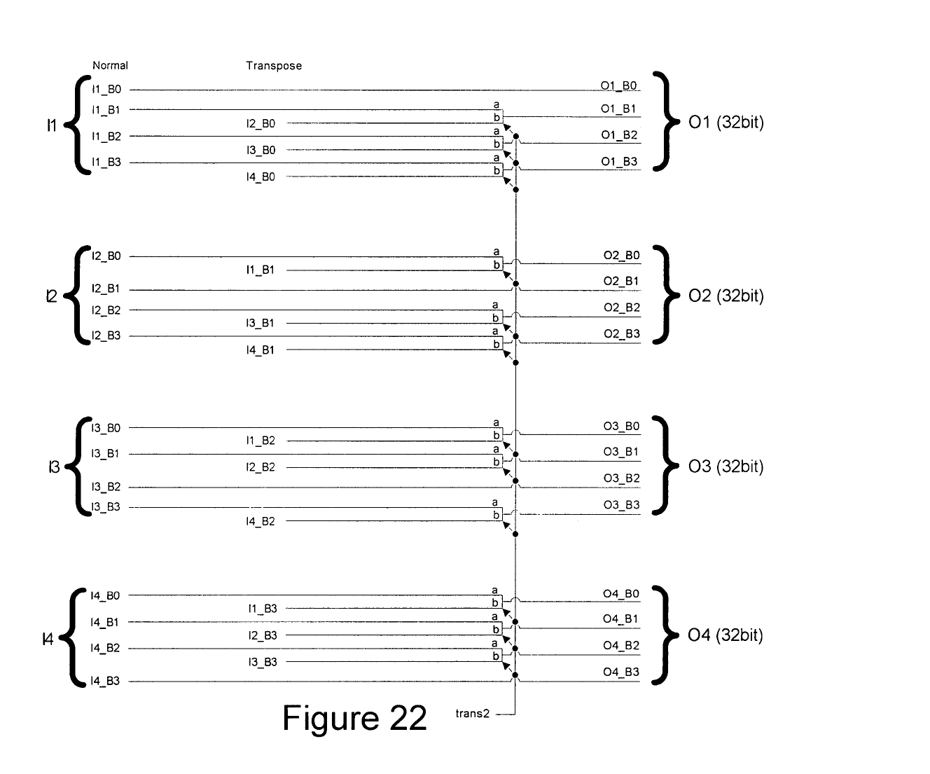

FIG. 19 through 22 display the AES Encode 32-bit Co-Processor implementation. The difference with this implementation is shown in FIG. 21 where the AES local key memory is shown. The key memory is 32 bits wide and large enough to hold the entire key. The other difference is that the aes_enc_cop_in_{—}2 instruction starts a variable number of automatic cycles which depend upon the initial value of the loop_cnt register. While the hardware is going through these cycles a single key word is read from the key memory and exclusive-or'd with the GF results.

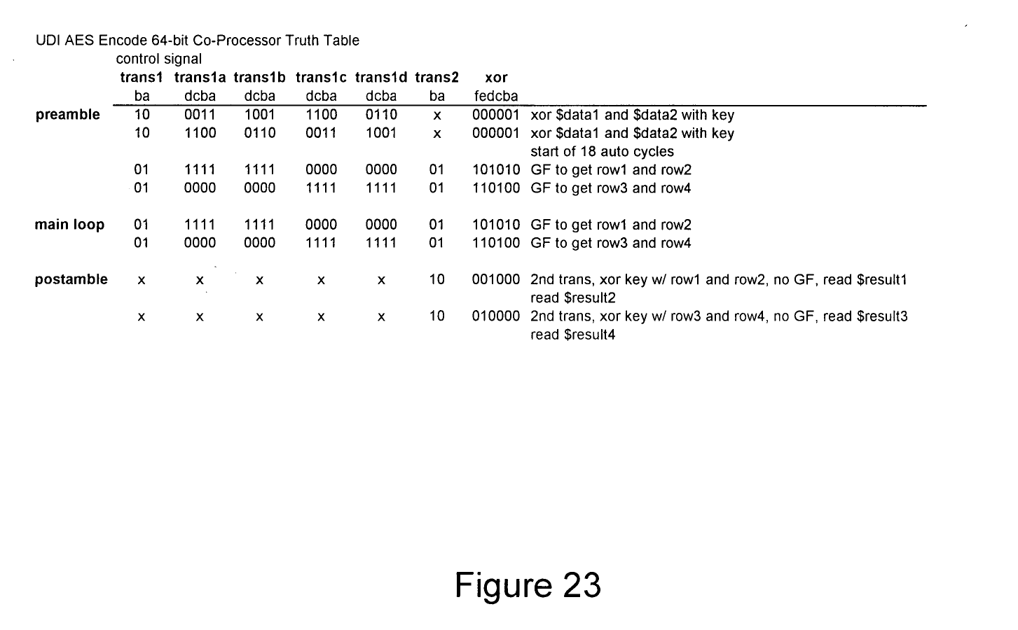

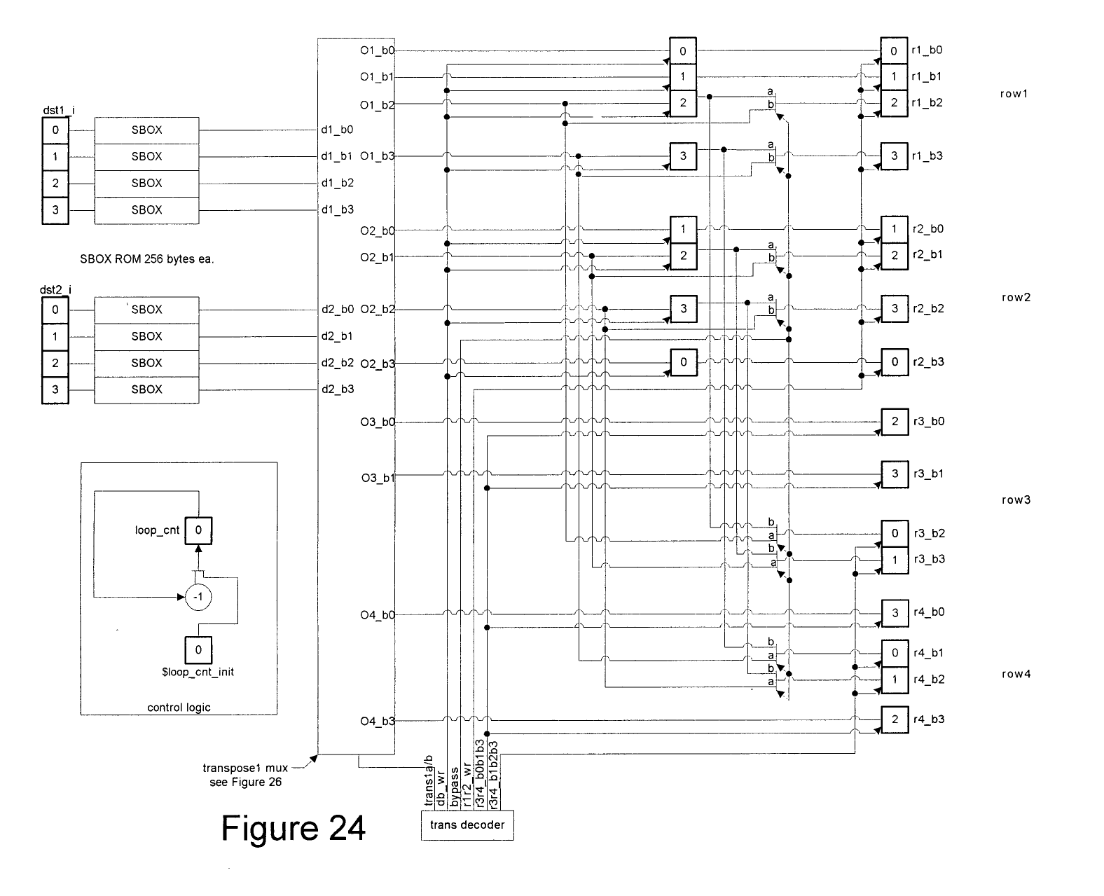

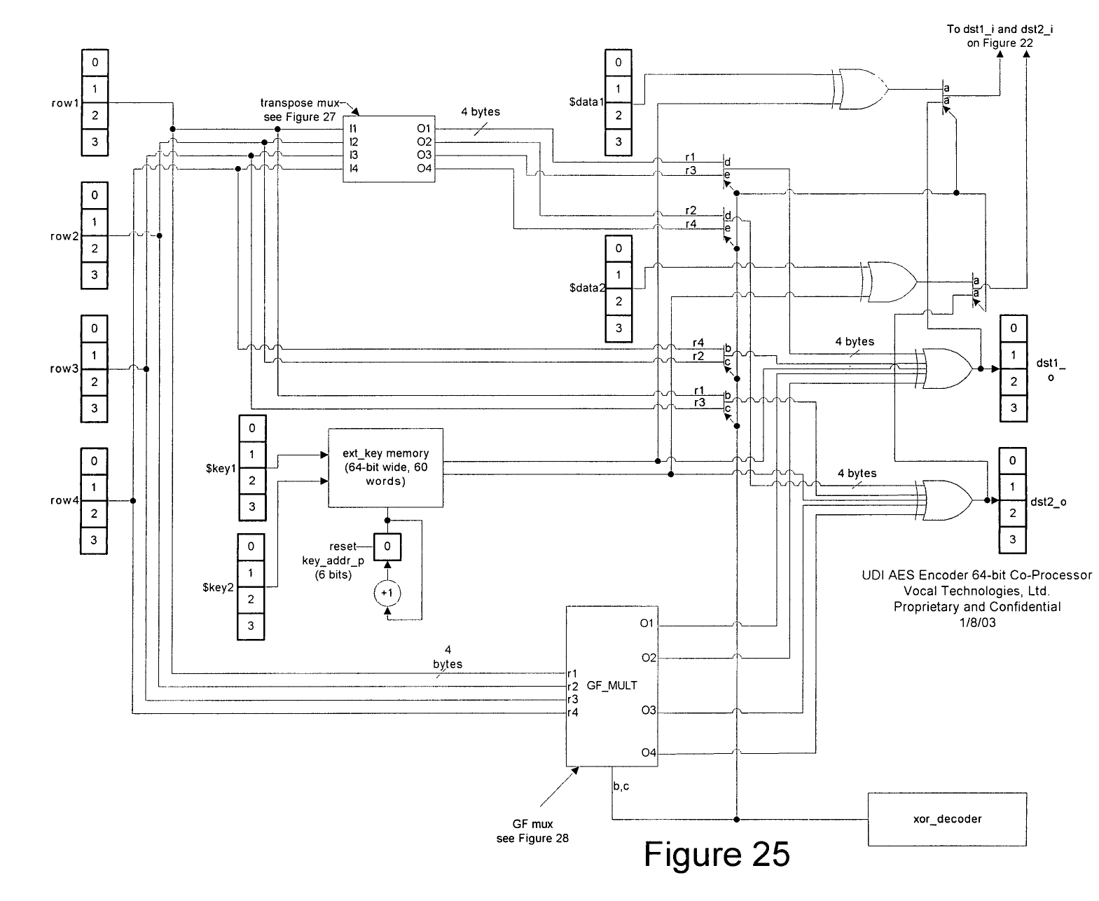

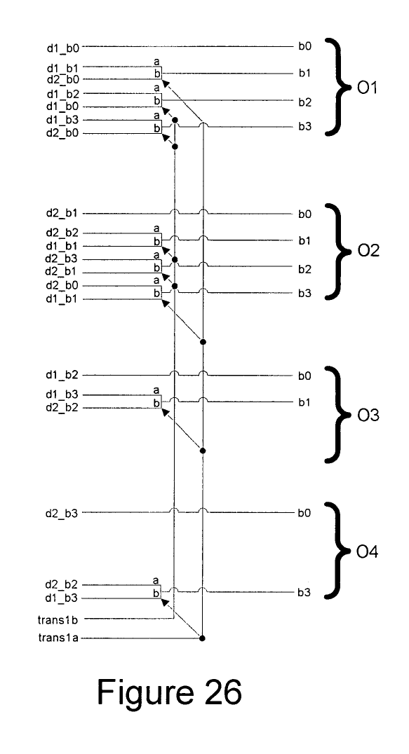

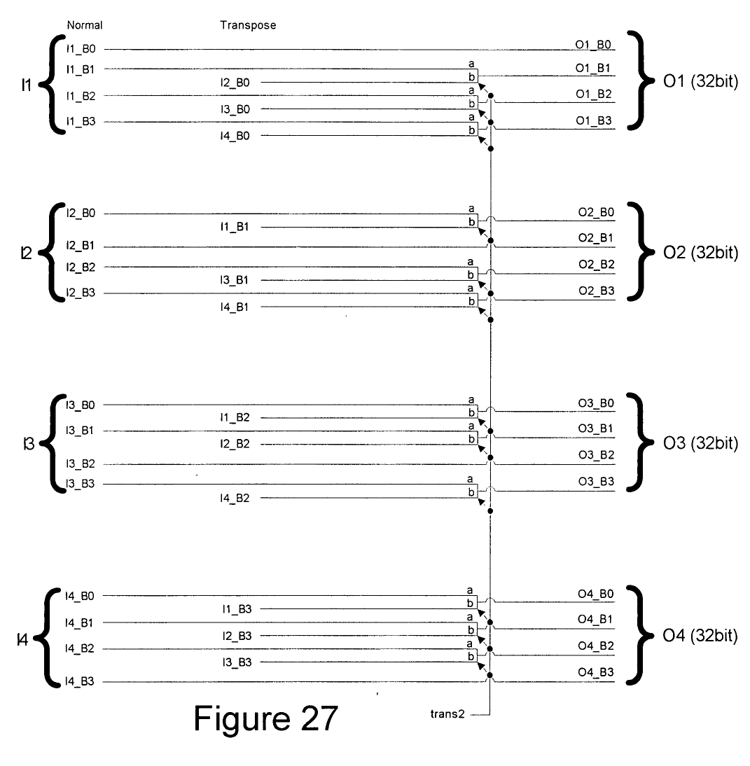

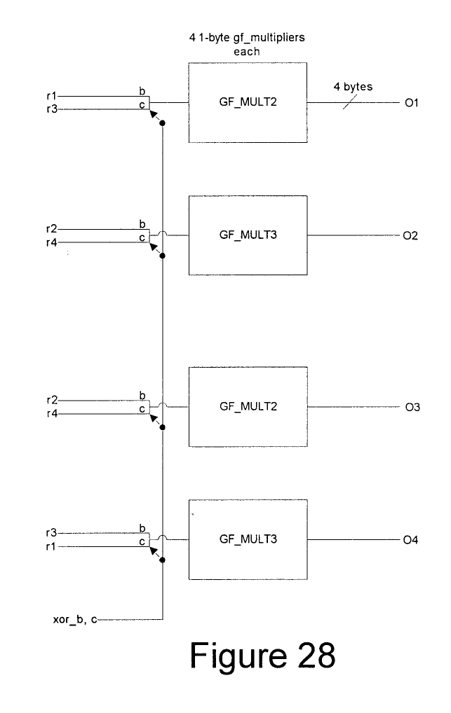

FIG. 23 through 28 display the AES Encode 64-bit Co-Processor which is like the 32-bit version except that it has two dst registers for results and the key memory is 64-bits wide. This allows the implementation to perform 64-bit data processing.

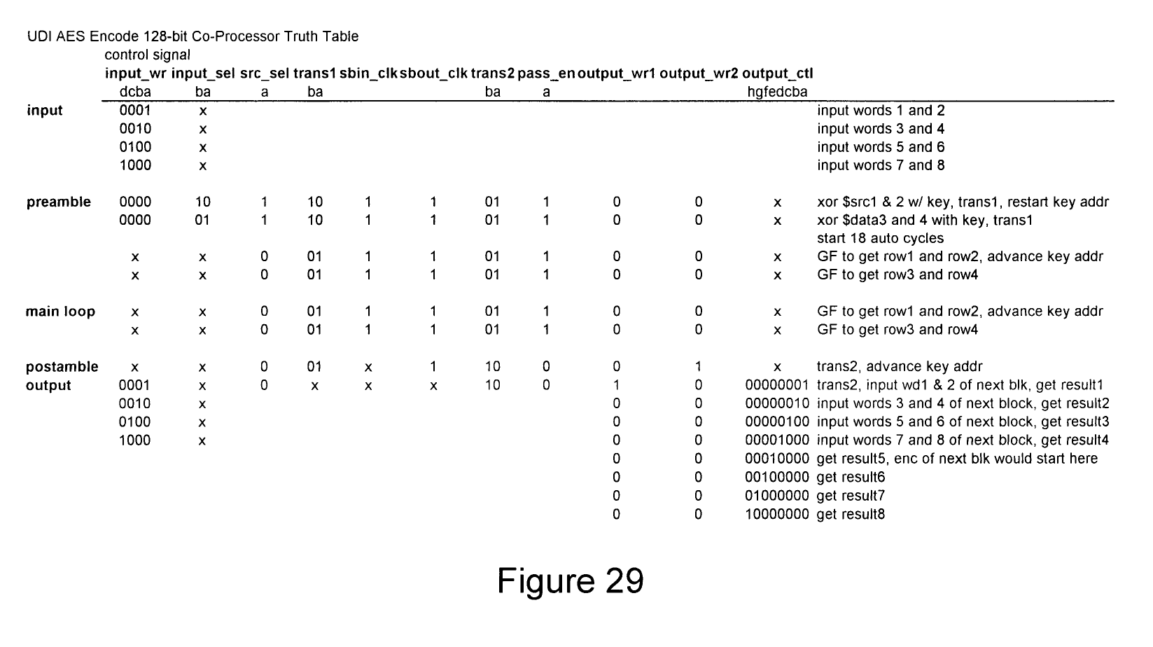

FIG. 29 through 35 display the AES Encode 128-bit Co-Processor which effectively performs 1 round of AES per cycle. FIG. 30 displays the overall layout of the 128-bit AES Co-Processor implementation with support for interleaving. The benefit of interleaving is the presence of an additional pipeline stage. The processing register of the 64-bit implementation has been moved to the SBOX outputs. Further an additional pipeline register has been added to the SBOX ROM inputs. This pipelining allows the pipeline operation speed to be increased to match the speed of the ROM used for the SBOX transformation. A typical small 256 byte ROM (such as used for SBOX), has a typical delay of 3 nsec. This allows a 333 MHz pipeline clock speed. As long as the remaining logic requires less than 3 nsec of propagation delay, this will be the governing factor of this design. Without the additional pipeline register, then the speed of the pipeline would be approximately 6 nsec (assuming a logic delay of nearly 3 nsec) for a 167 MHz pipeline clock.

The AES algorithm typically does not tolerate pipeline delays since all the data from one round must be completed prior to the computation of the next round. We exploit this fact as we perform the AES algorithm on two independent blocks of information to be encrypted. During the first cycle, the generation of the encryption sequence is produced to be exclusive-or'd with the first block and on the second cycle, the second block is computed. Arranged in this order, the second block immediately follows the first block. This is an optimal time order for the computation of the AES encryption using interleaved hardware.

FIG. 31 contains the 1^{st} half of the 128-bit AES Co-Processor. The data comes in and is exclusive-or'd with the first 4 words of the extended key. It then is substituted with a value from the SBOX ROM and finally transposed (if necessary). The results are saved in the first row of 16 bytes of registers. During the same clock cycle the previous data is taken from the first row of registers, SBOX substituted, and saved in the second row of registers. This is how the interleaving is performed.

FIG. 32 contains the 2^{nd} half of the AES 128-bit Co-Processor. The outputs of the first transpose multiplexors are the row inputs. The rows are GF multiplied, transposed if necessary, and finally exclusive-or'd together. The data is fed back to the beginning until is it finished. When the data is finished it is buffered in registers, which allows incoming data to be fed into the engine while the previous results are being output.

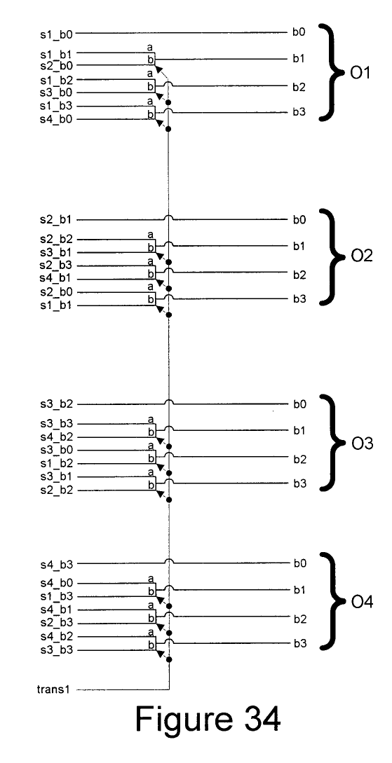

FIG. 34 shows the details of the first transpose multiplexors. They are used to transpose the data as it comes into the engine for the 1^{st} round.

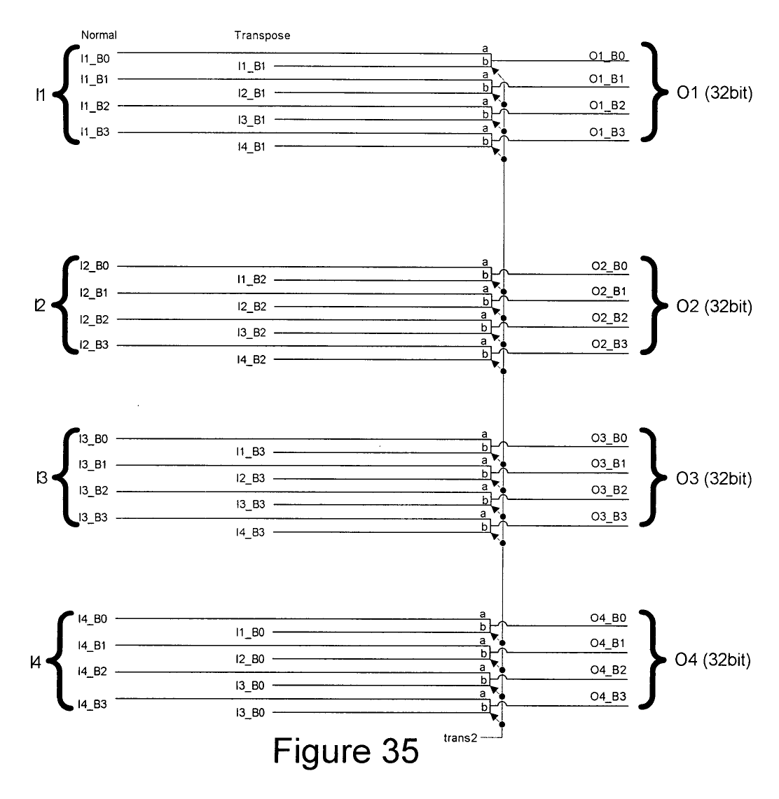

FIG. 35 shows the details of the 2^{nd} transpose multiplexors. These multiplexors are used to transpose the data on the final round of the AES encryption.

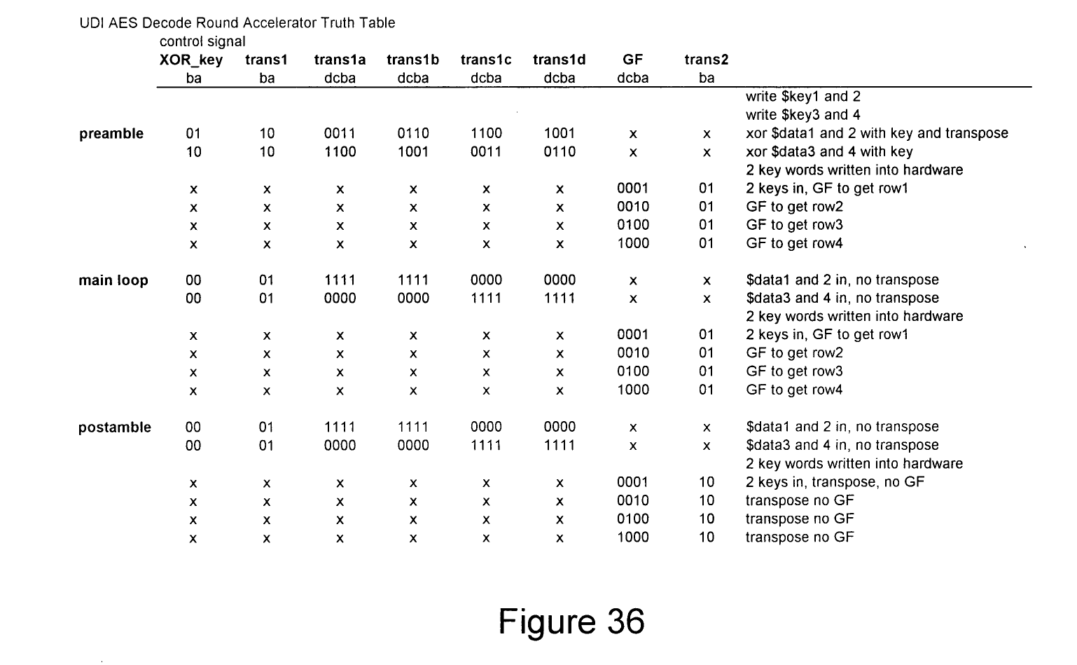

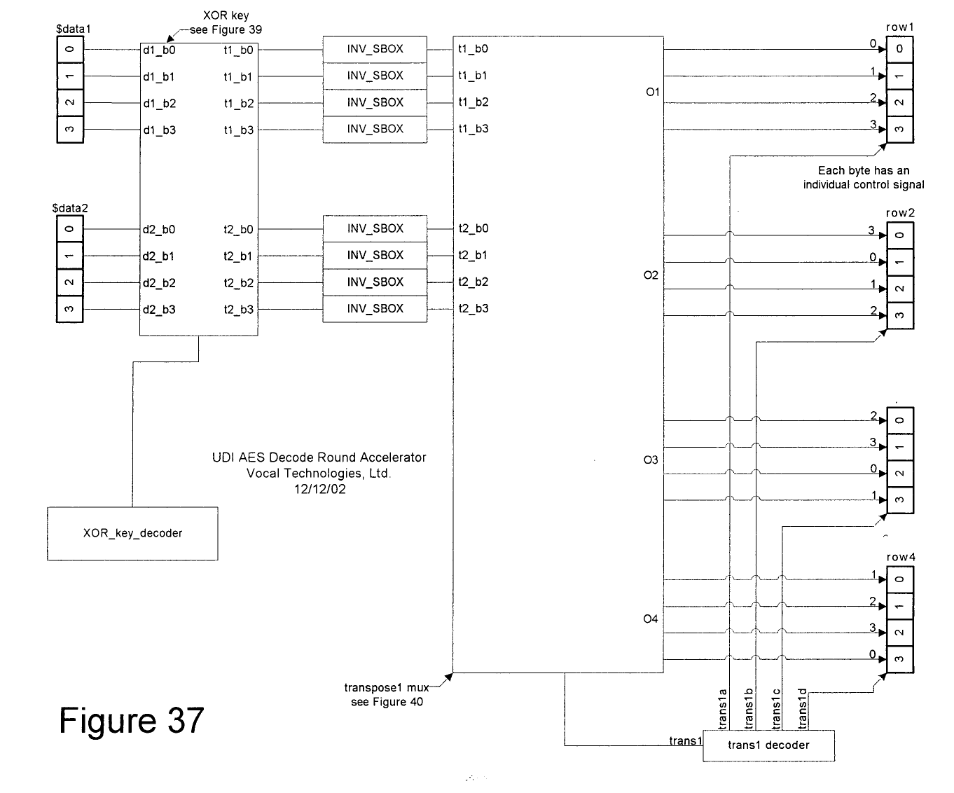

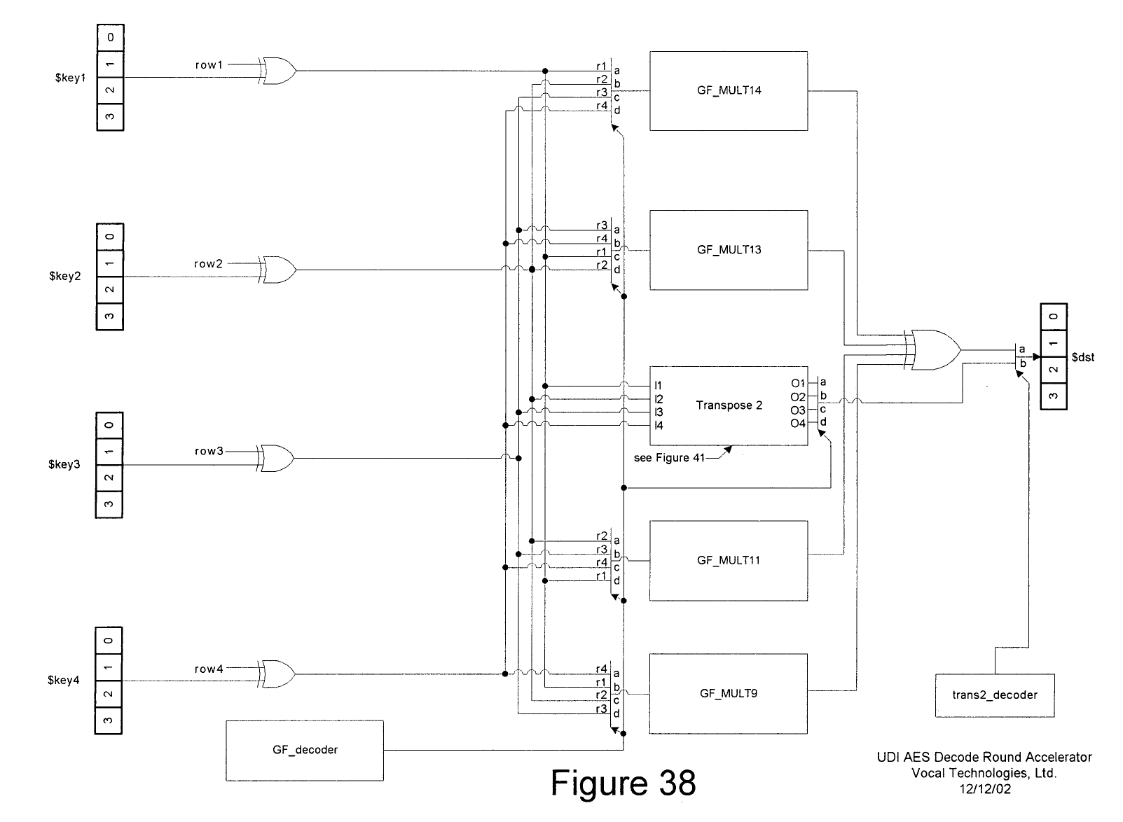

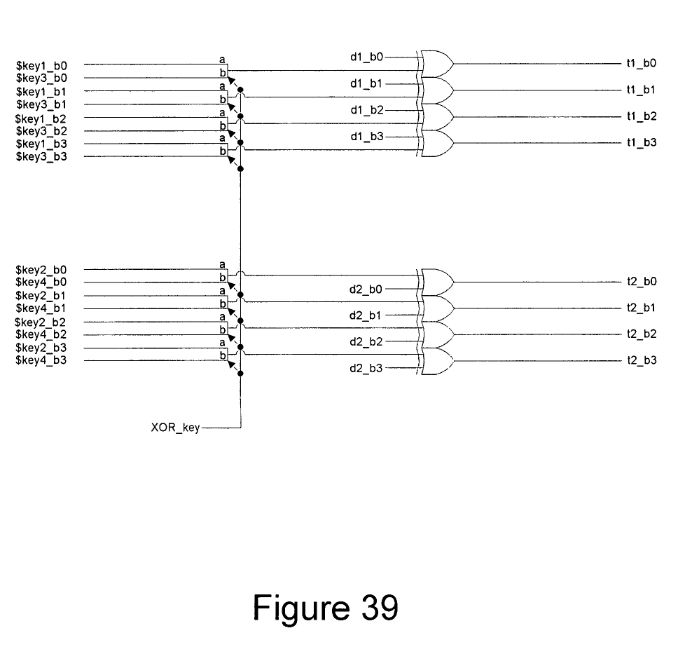

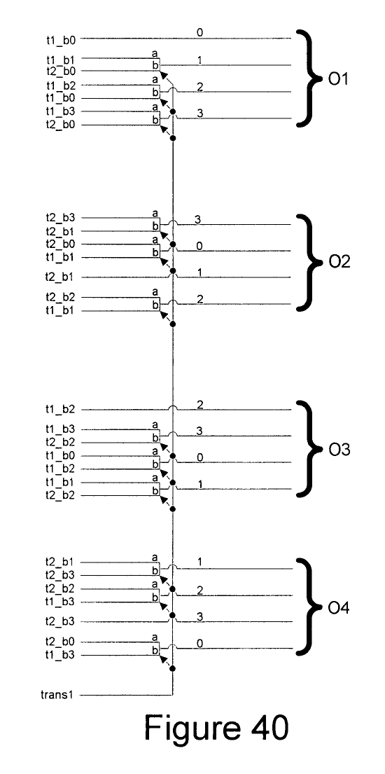

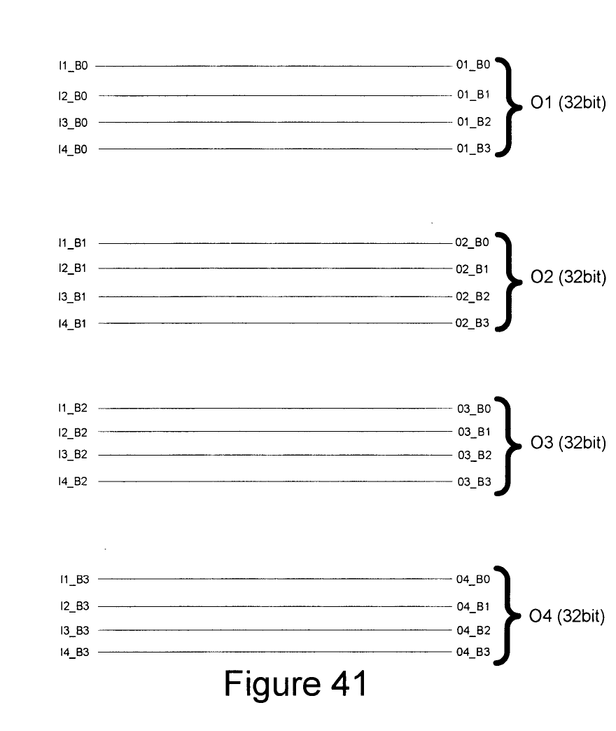

FIG. 36 through 41 display the AES Decode Round Accelerator implementation. FIG. 31 shows the hardware necessary for the implementation of the aes_dec_pre_in_{—}1/2 and aes_dec_rud_in_{—}1/2 instructions. There are 2 source registers, $data1 and $data2. As the bytes from the source registers come into the hardware, they are immediately used as the offset to each INV_SBOX lookup. All 8 lookups are performed in parallel. The INV_SBOX lookups are held on a ROM inside the hardware. The output from the INV_SBOX lookup is multiplexed in order to distinguish between the different input instructions. The aes_dec_rnd_pre_in_{—}1/2 perform the exclusive-or with the key as shown in FIG. 39. If the instruction being performed is the aes_dec_rnd_in_{—}1, the results from the INV_SBOX lookup are sent to buried state registers, row1 and row2. If the instruction is the aes_enc_rnd_in_{—}2, the results are sent to row3 and row4. The results are oriented in such a way that the byte rotation by 0, 1, 2, or 3 bytes is performed as the result is being sent to the buried state registers. The buried state registers hold the results until the next half of the engine is executed during the aes_dec_rnd_out_{—}1/2/3/4 instructions. FIG. 37 displays the hardware necessary for the implementation of these instructions. There are 4 source registers, which hold the key data. During each output instruction, the hardware obtains data from each of the buried state row registers and performs the GF multiplication on the rows according to the multiplexers. The data from the GF multiplication and the key registers are then exclusive-or'd together to form the result that is output to the $dst register. The aes_dec_rnd_post_out_{—}1/2 simply bypass the GF multiplication, which is skipped for the last round.

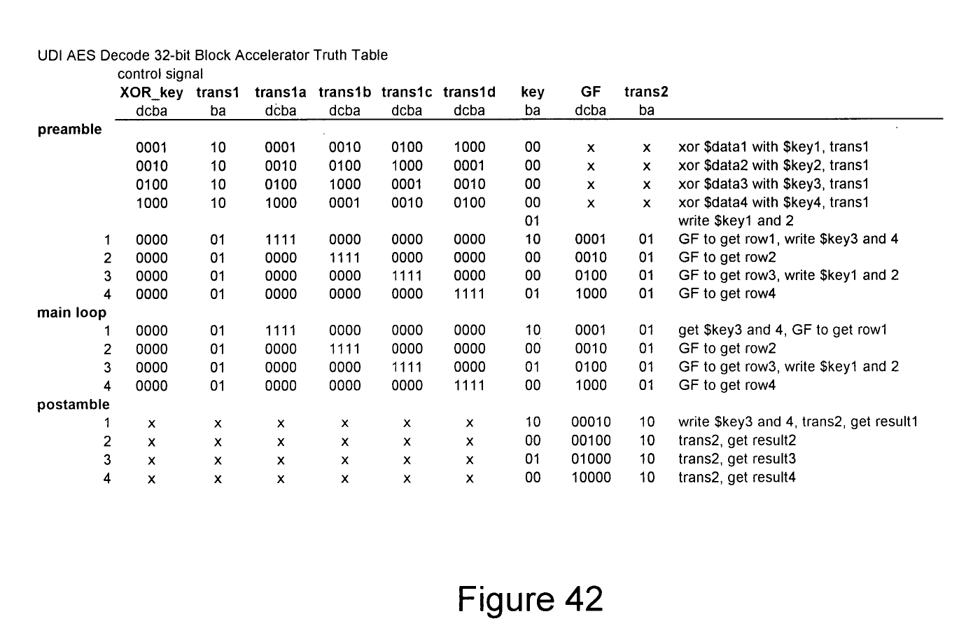

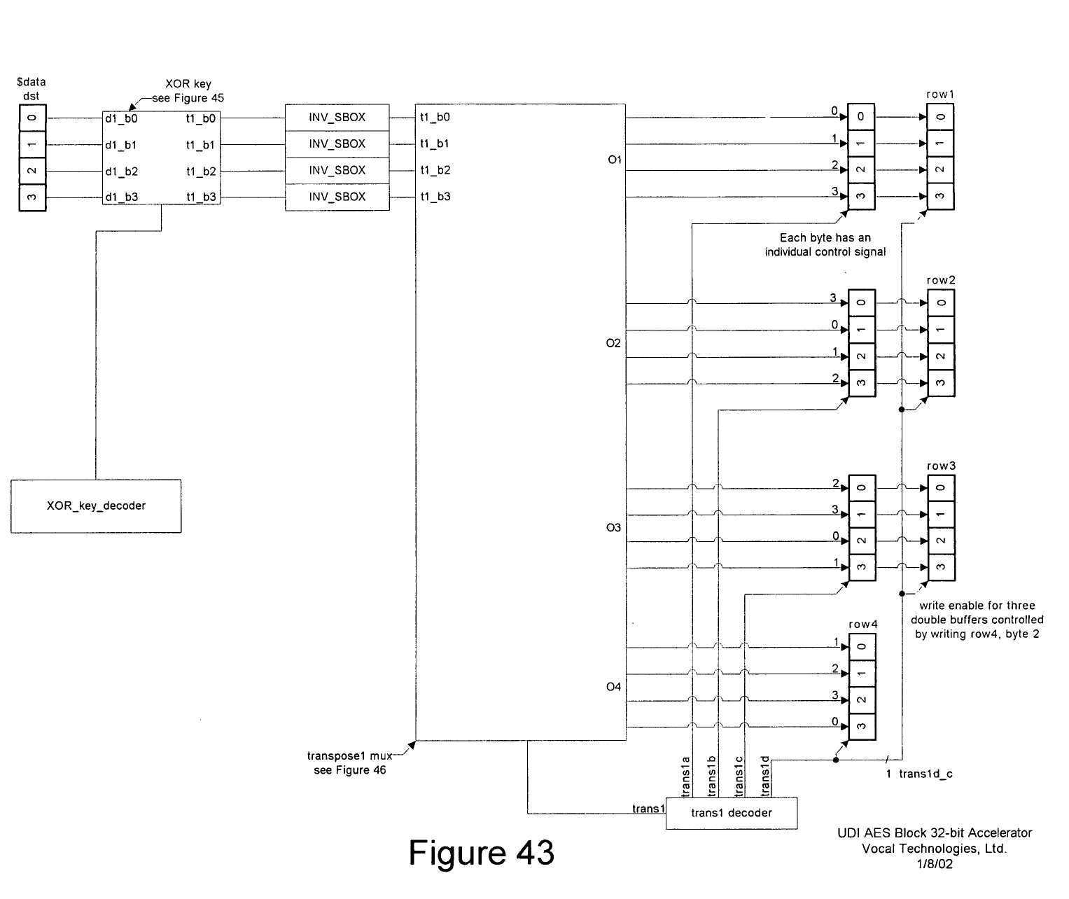

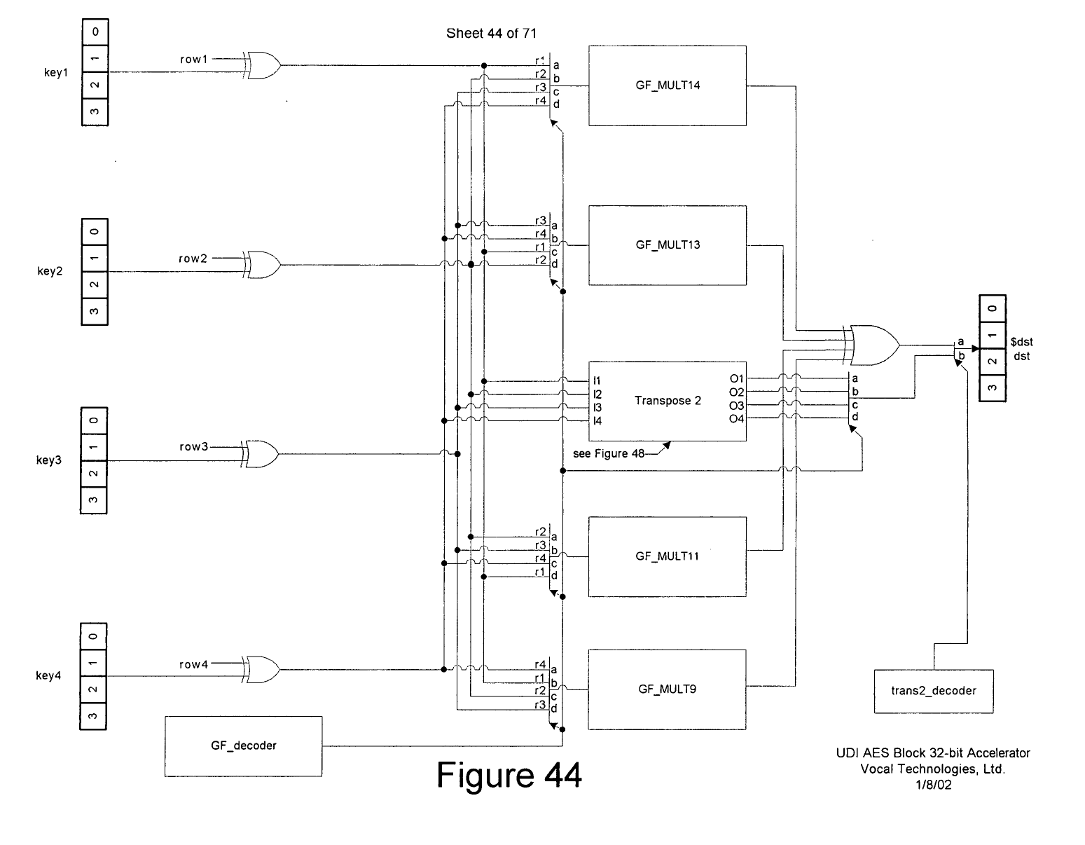

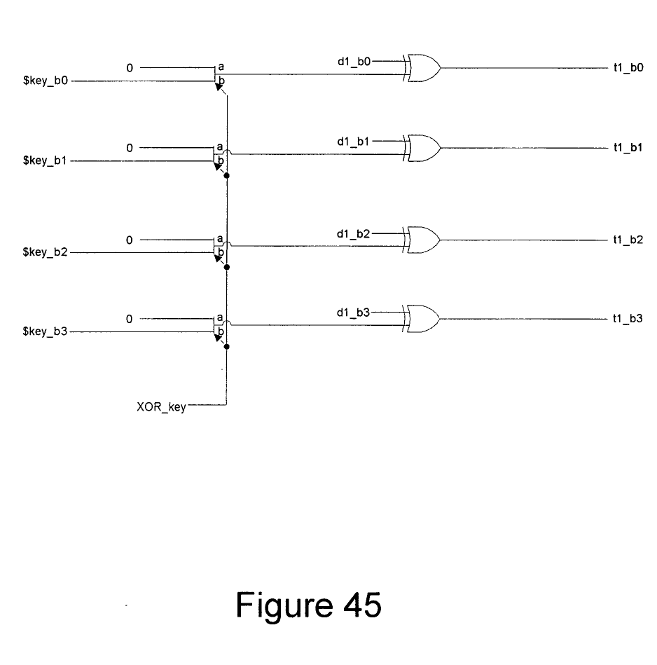

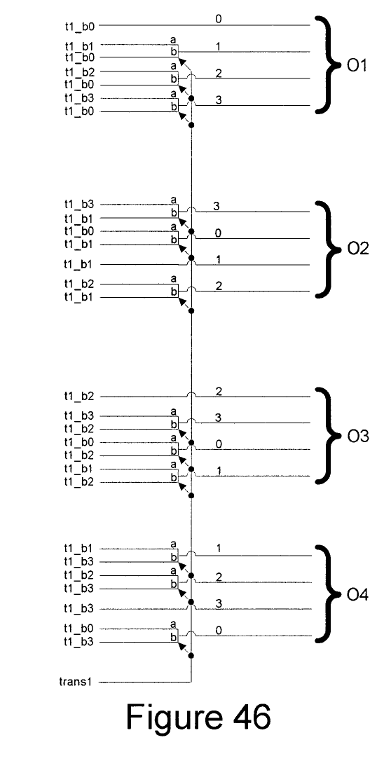

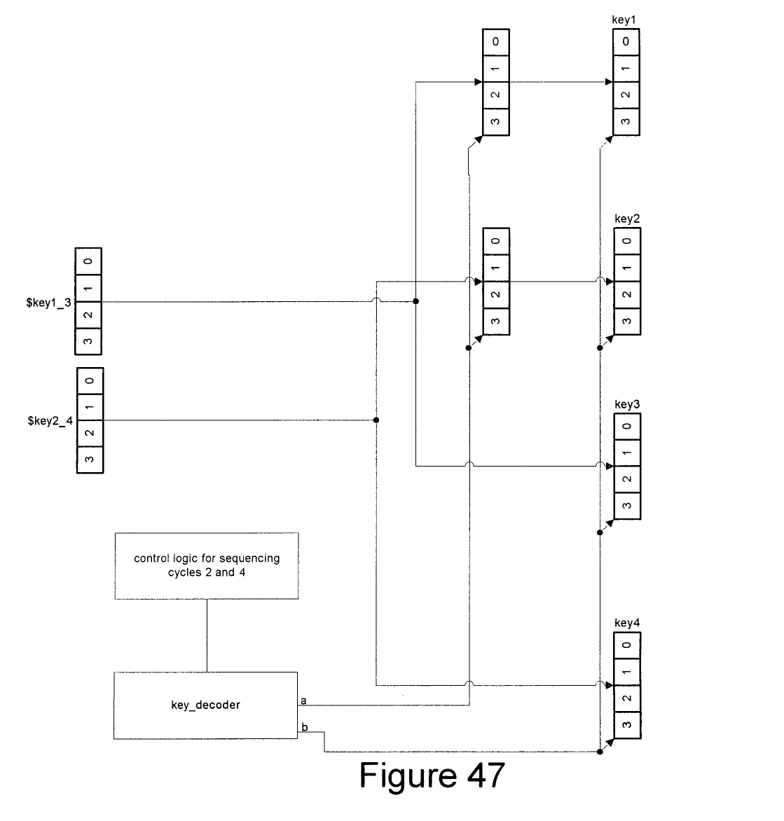

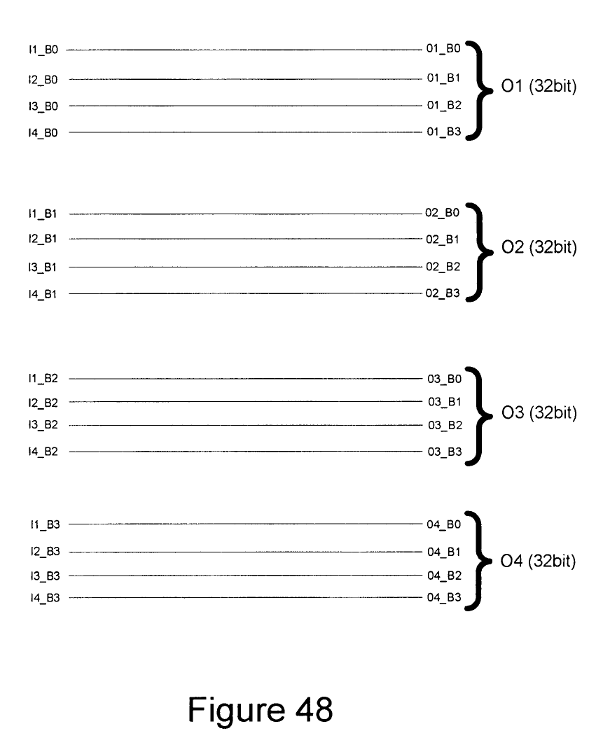

FIG. 42 through 48 display the AES Decode 32-bit Block Accelerator implementation. It is almost the same as the round accelerator except that it routes the data back to the beginning of the hardware for the next round. This implementation starts at the $data register in FIG. 43, where the exclusive-or with the key takes place. The exclusive-or of the key and the data is shown in FIG. 44. The key is written into four registers unlike the encode block implementation which needs only one key at a time. When the aes_dec_blk_key_{—}1 instruction writes two keys to hardware, they are double buffered until the aes_dec_blk_key_{—}2 instruction executes. Each time the aes_dec_blk_key_{—}2 instruction puts two keys in, the keys are used right away. Here there is also a nop as far as the processor is concerned immediately after each aes_dec_blk_key instruction.

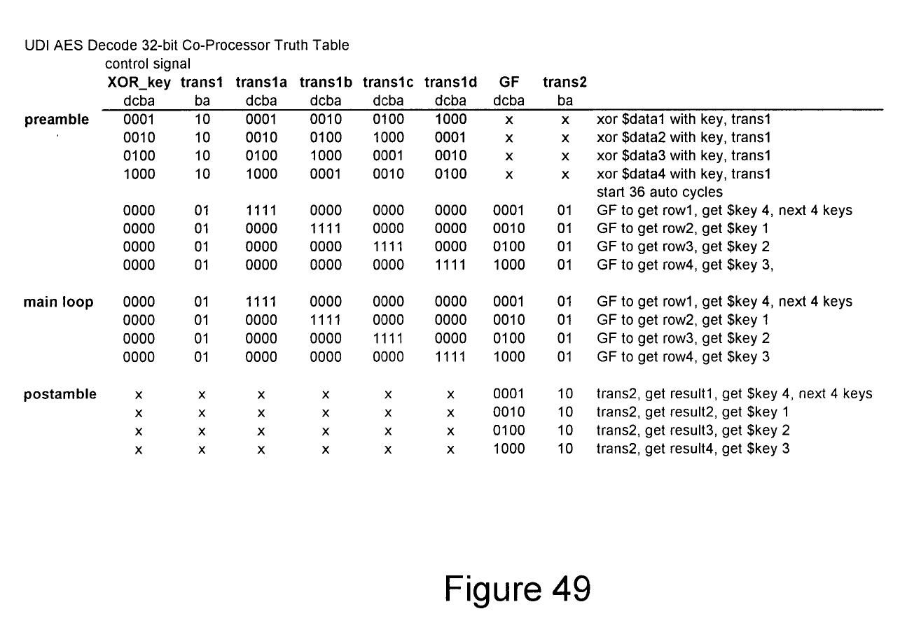

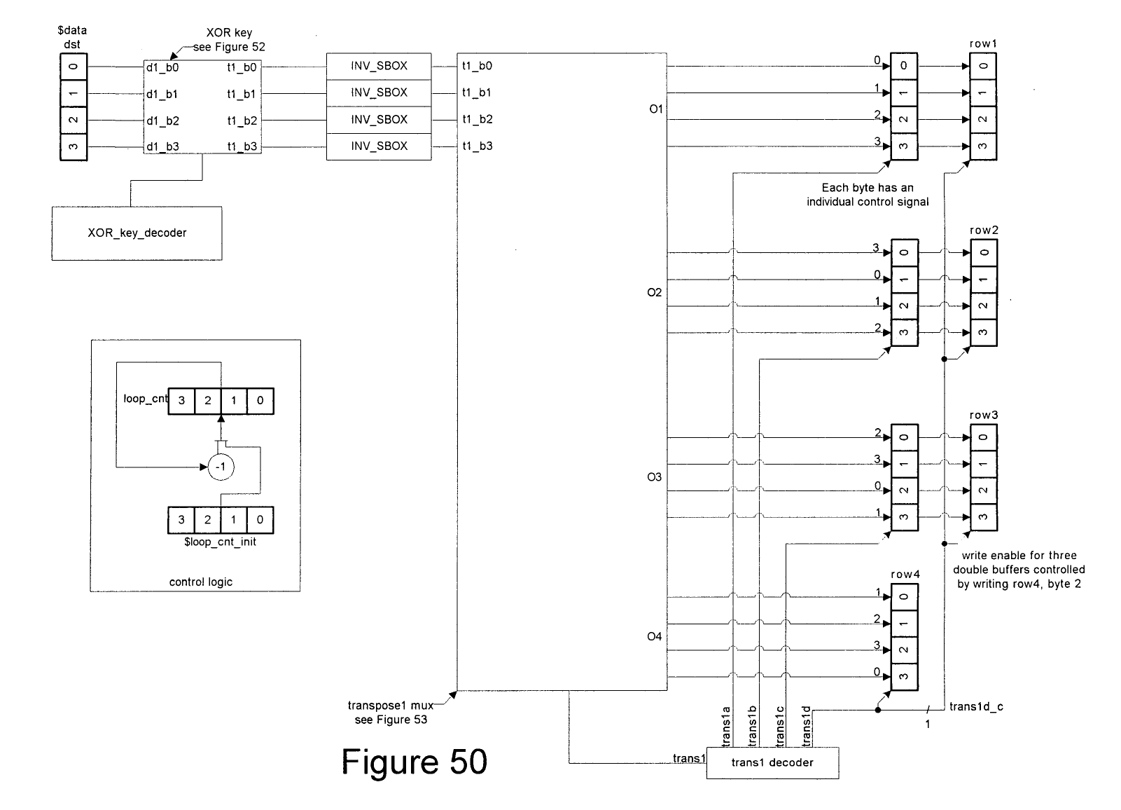

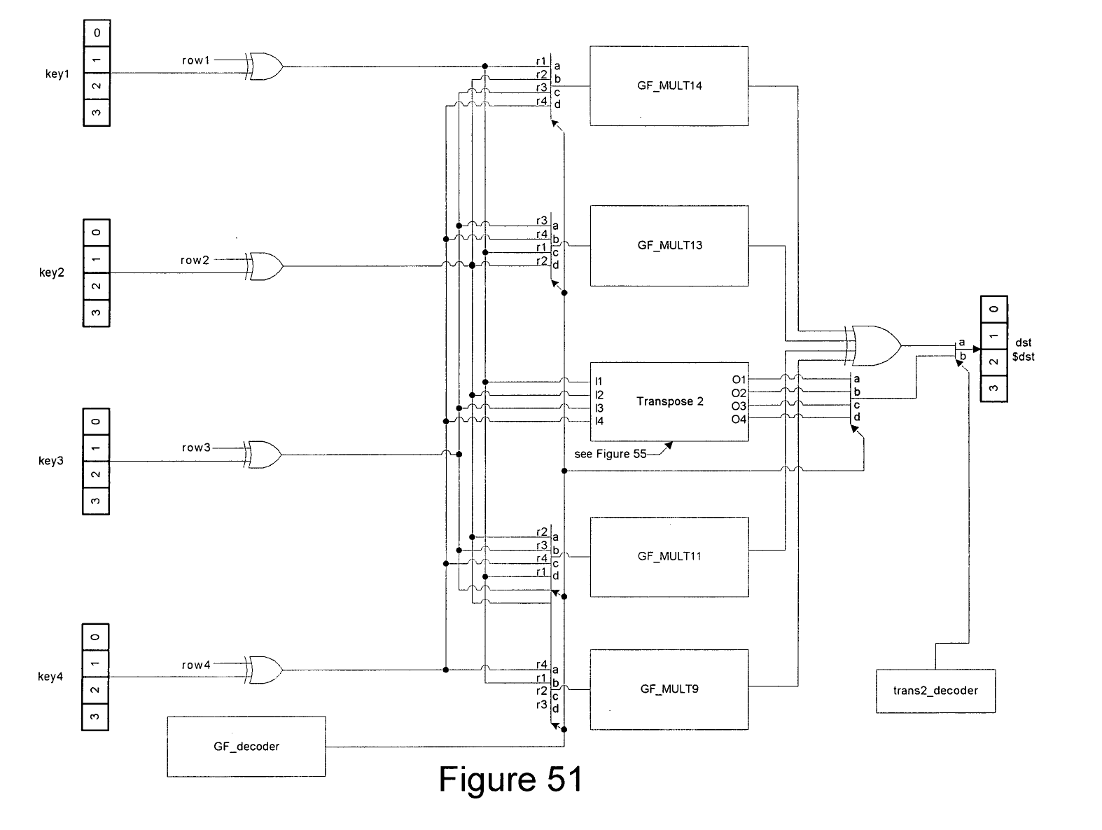

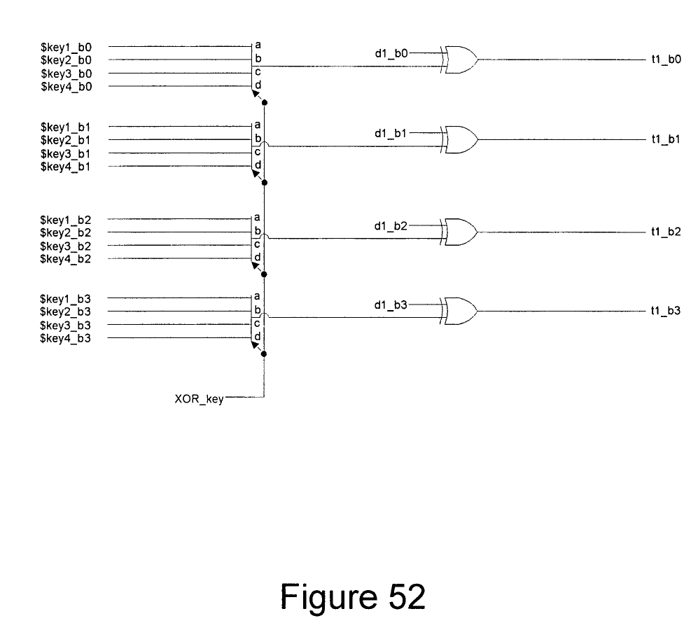

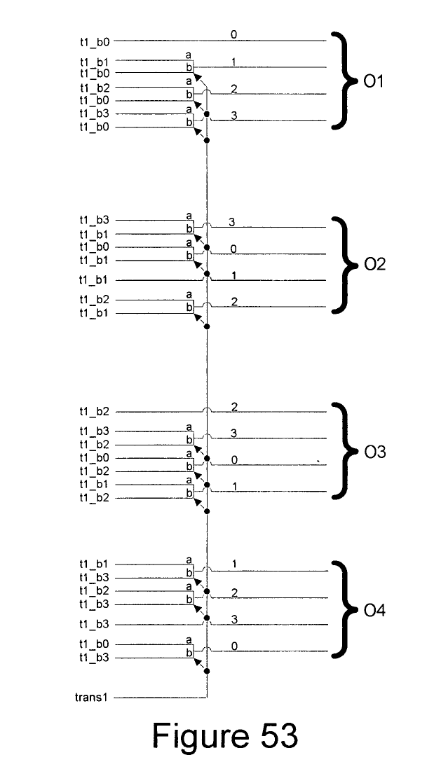

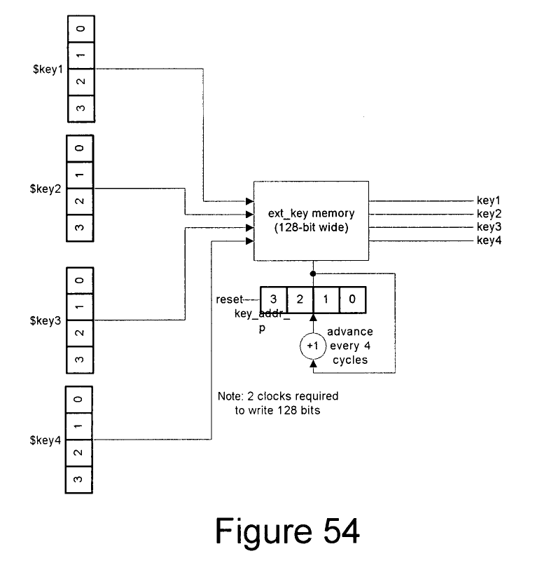

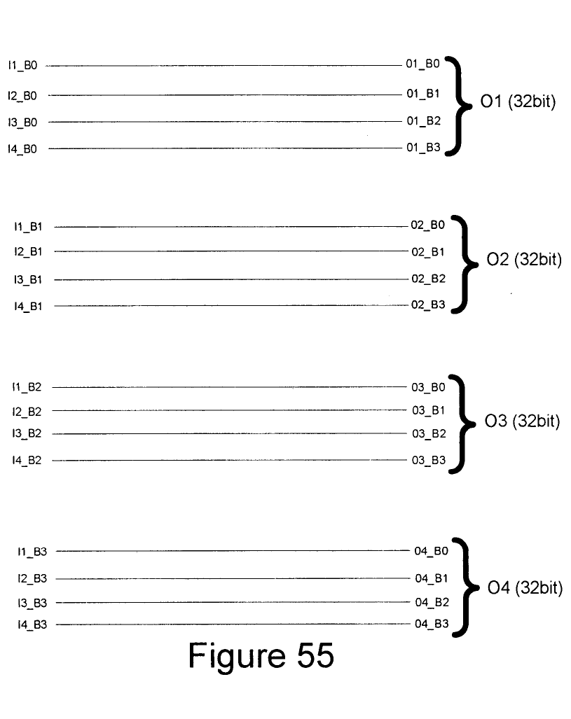

FIG. 49 through 55 display the AES Decode 32-bit Co-Processor implementation. The difference with this implementation is shown in FIG. 54 where the AES local key memory is shown. The key memory is 128 bits wide because all four key words are required at once. The other difference is that the aes_dec_cop_in_{—}2 instruction starts a number automatic cycles which depend upon the initial value of the loop_cnt register. While the hardware is going through these cycles 4 key words are read from the key memory and exclusive-or'd with the row results.

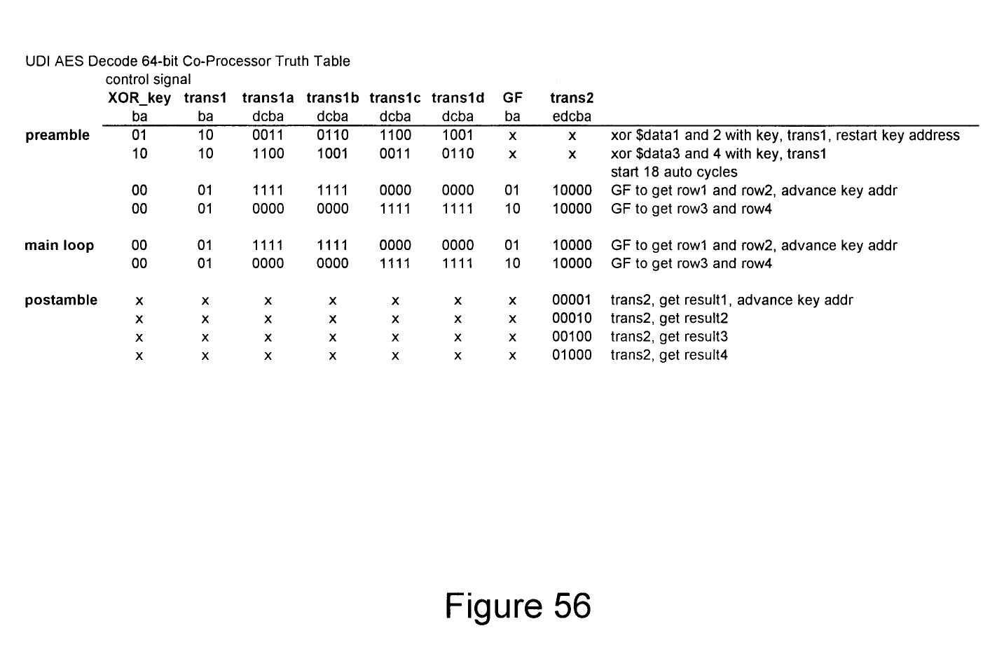

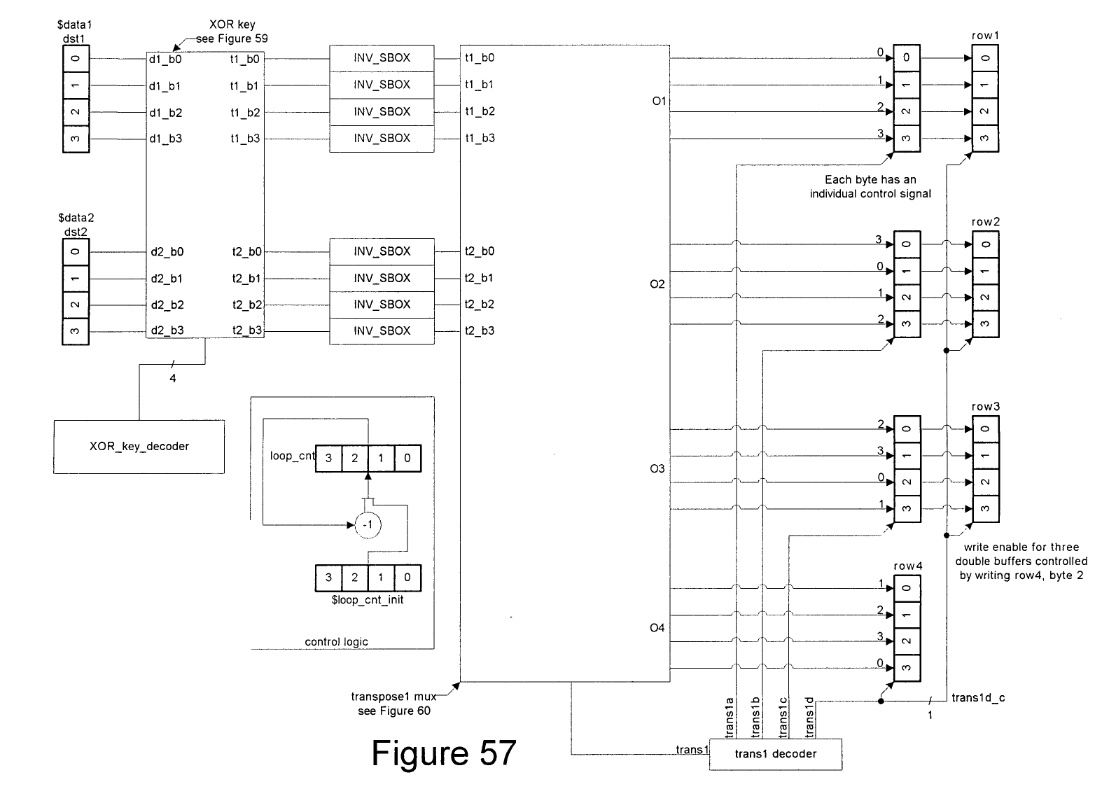

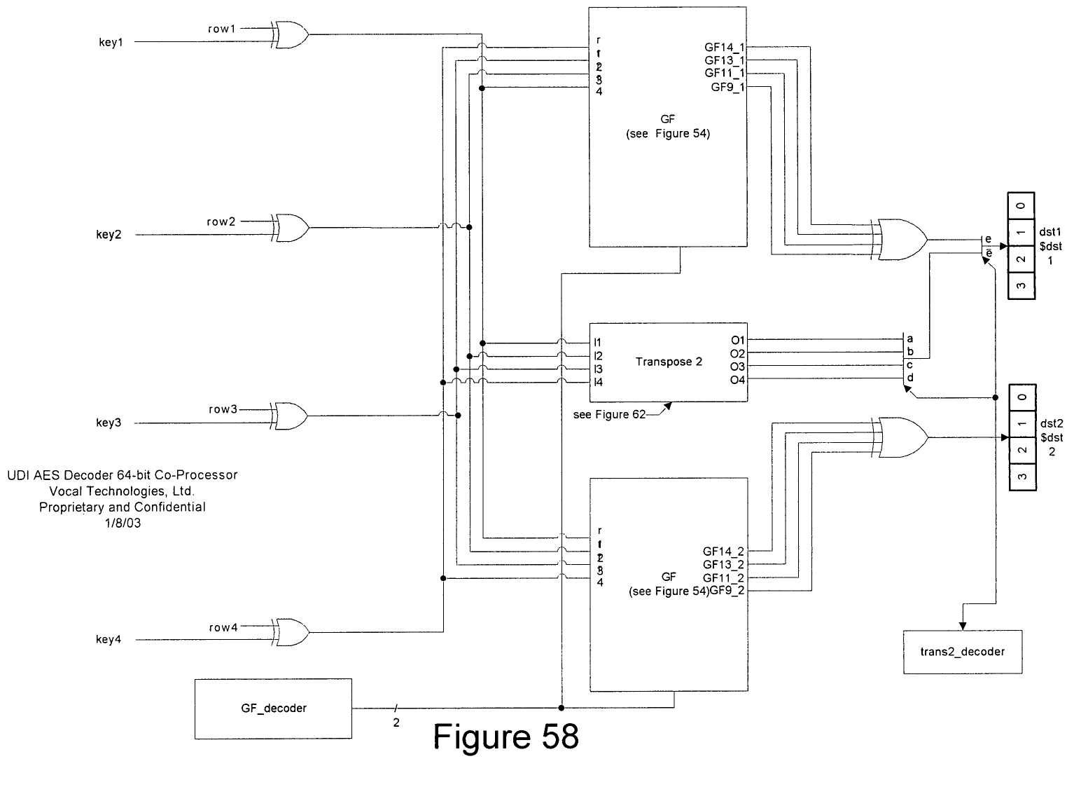

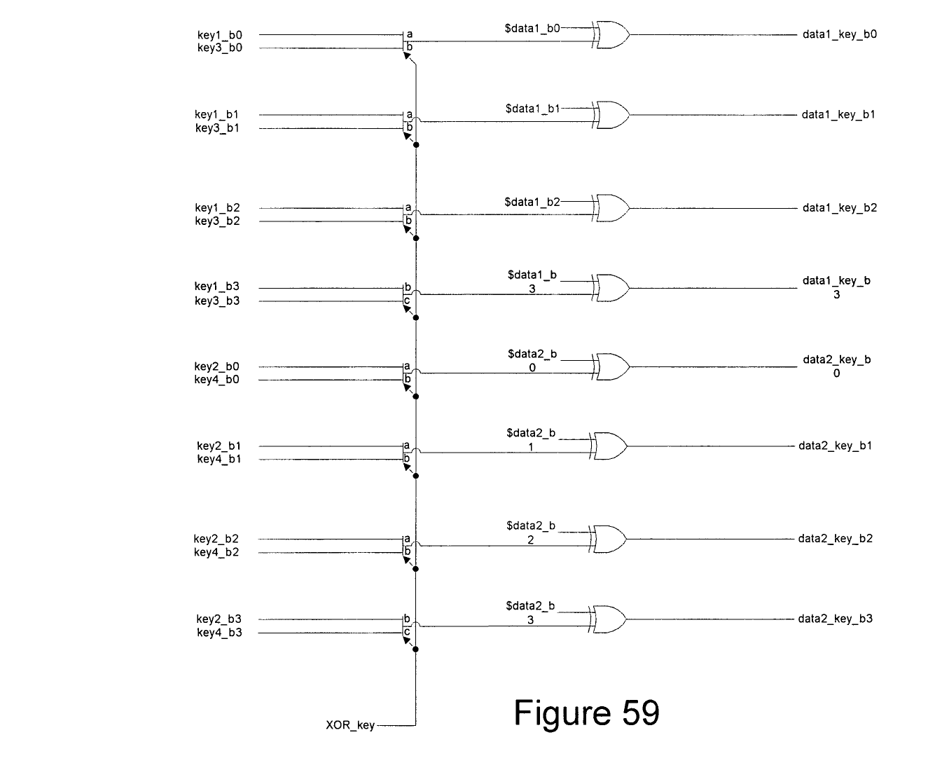

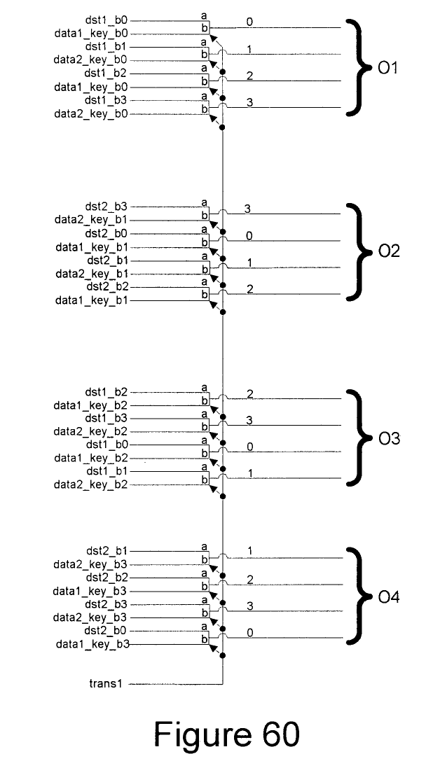

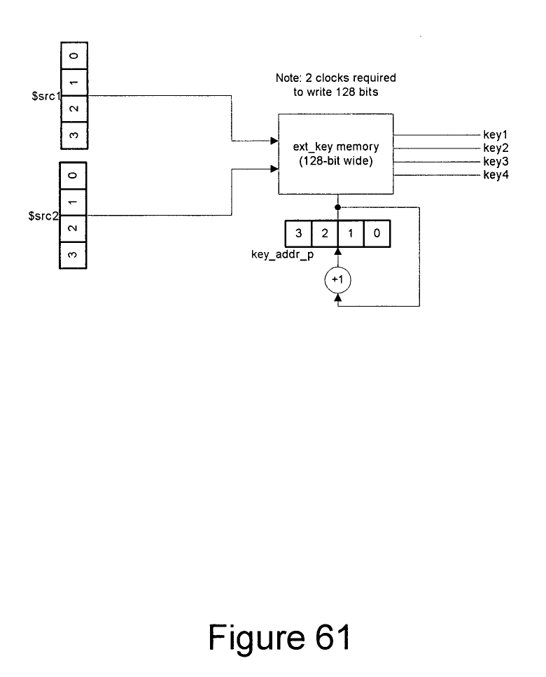

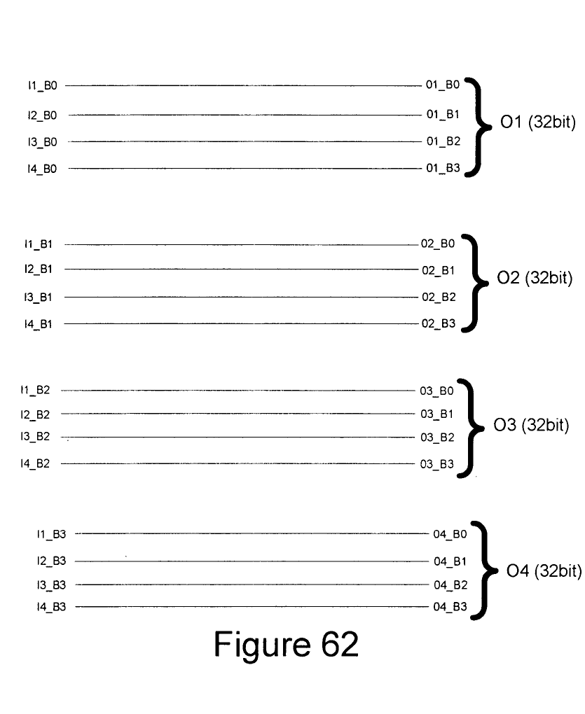

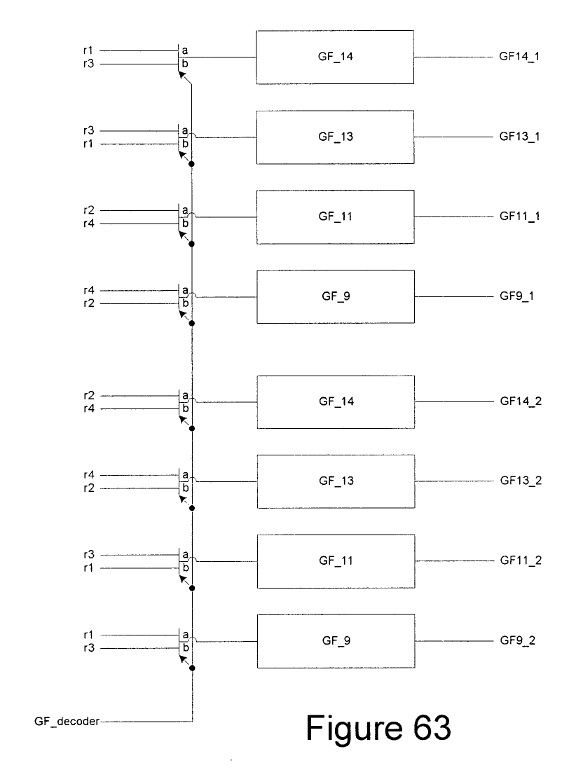

FIG. 56 through 63 display the AES Decode 64-bit Co-Processor which is like the 32-bit version except that it has two data registers, two INV_SBOX lookups, double the GF hardware, and two dst registers which allows for 64-bit processing of data.

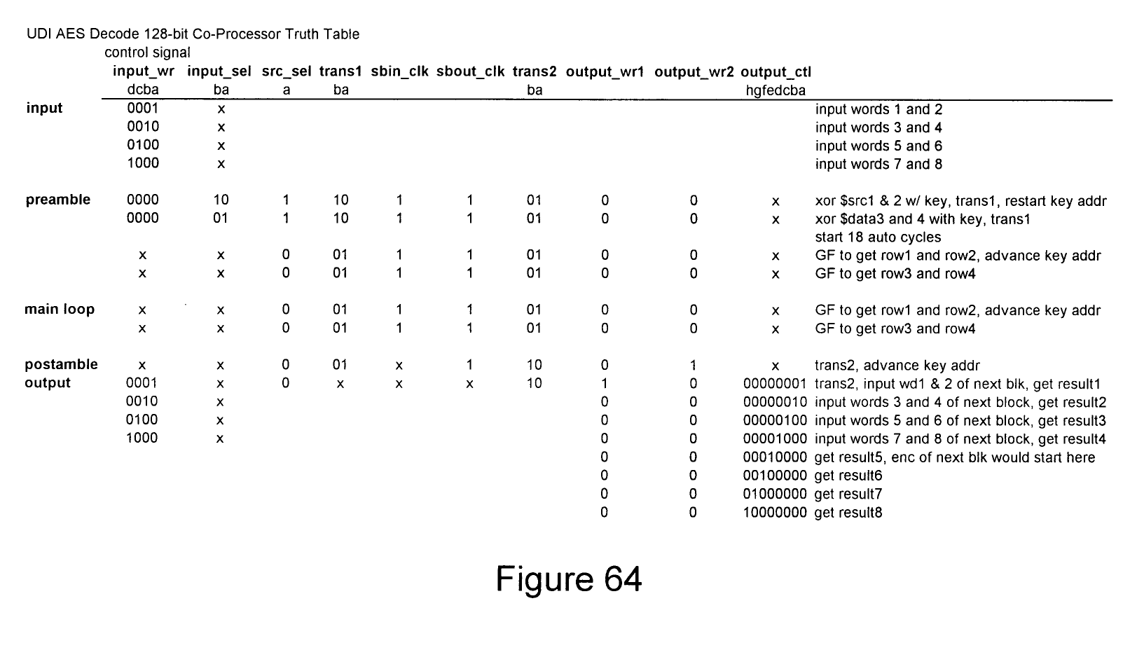

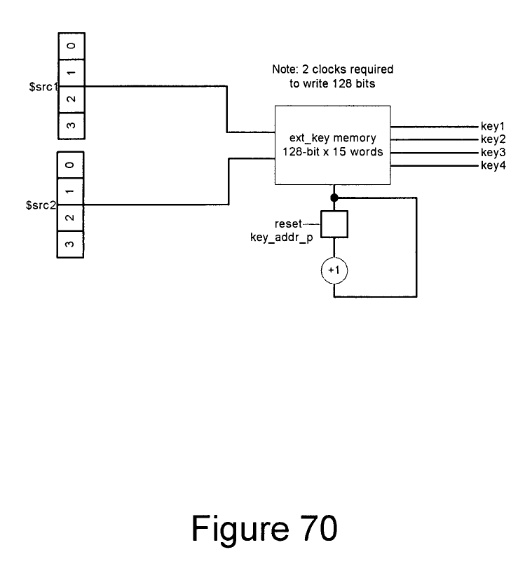

FIG. 64 through 70 display the 128-bit AES Decode Co-Processor implementation with support for interleaving. This implementation is closely related to the 128-bit Encode Co-Processor. An additional pipeline register has been added to the SBOX ROM inputs. This pipelining allows the pipeline operation speed to be increased to match the speed of the ROM used for the SBOX transformation. A typical small 256 byte ROM (such as used for SBOX), has a typical delay of 3 nsec. This allows a 333 MHz pipeline clock speed. As long as the remaining logic requires less than 3 nsec of propagation delay, this will be the governing factor of this design. Without the additional pipeline register, then the speed of the pipeline would be approximately 6 nsec (assuming a logic delay of nearly 3 nsec) for a 167 MHz pipeline clock.

The AES algorithm typically does not tolerate pipeline delays since all the data from one round must be completed prior to the computation of the next round. We exploit this fact as we perform the AES algorithm on two independent blocks of information to be encrypted. During the first cycle, the generation of the decryption sequence is produced to be exclusive-or'd with the first block and on the second cycle, the second block is computed. Arranged in this order, the second block immediately follows the first block. This is an optimal time order for the computation of the AES encryption using interleaved hardware.

FIG. 65 contains the 1^{st} half of the 128-bit AES Decode Co-Processor. The data comes in and is exclusive-or'd with the first 4 words of the extended key. It then is substituted with a value from the SBOX ROM and finally transposed (if necessary). The results are saved in the first row of 16 bytes of registers. During the same clock cycle the previous data is taken from the first row of registers, SBOX substituted, and saved in the second row of registers. This is how the interleaving is performed.

FIG. 66 contains the 2^{nd} half of the AES 128-bit Co-Processor. The outputs of the first transpose multiplexors are the row inputs. The rows are GF multiplied, transposed if necessary, and finally exclusive-or'd together. The data is fed back to the beginning until is it finished. When the data is finished it is buffered in registers, which allows incoming data to be fed into the engine while the previous results are being output.

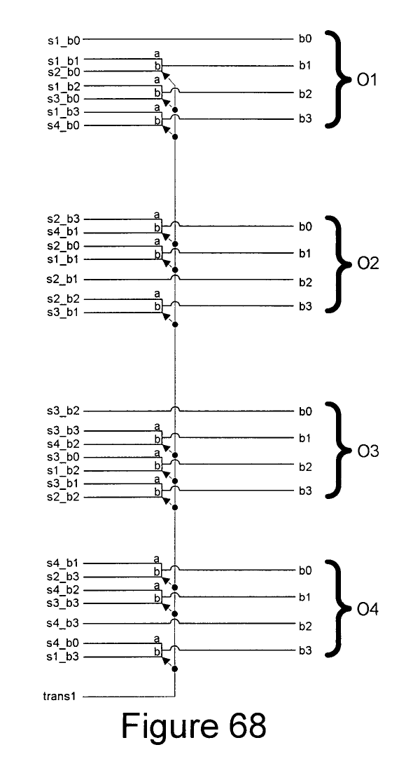

FIG. 68 shows the details of the first tranpose multiplexors. They are used to transpose the data as it comes into the engine for the 1^{st} round.

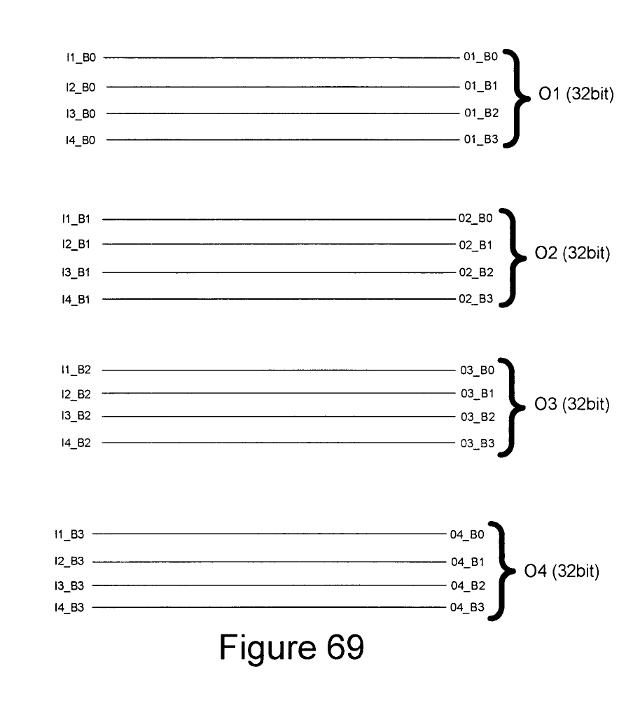

FIG. 69 shows the details of the 2^{nd} tranpose multiplexors. These multiplexors are used to transpose the data on the final round of the AES encryption.

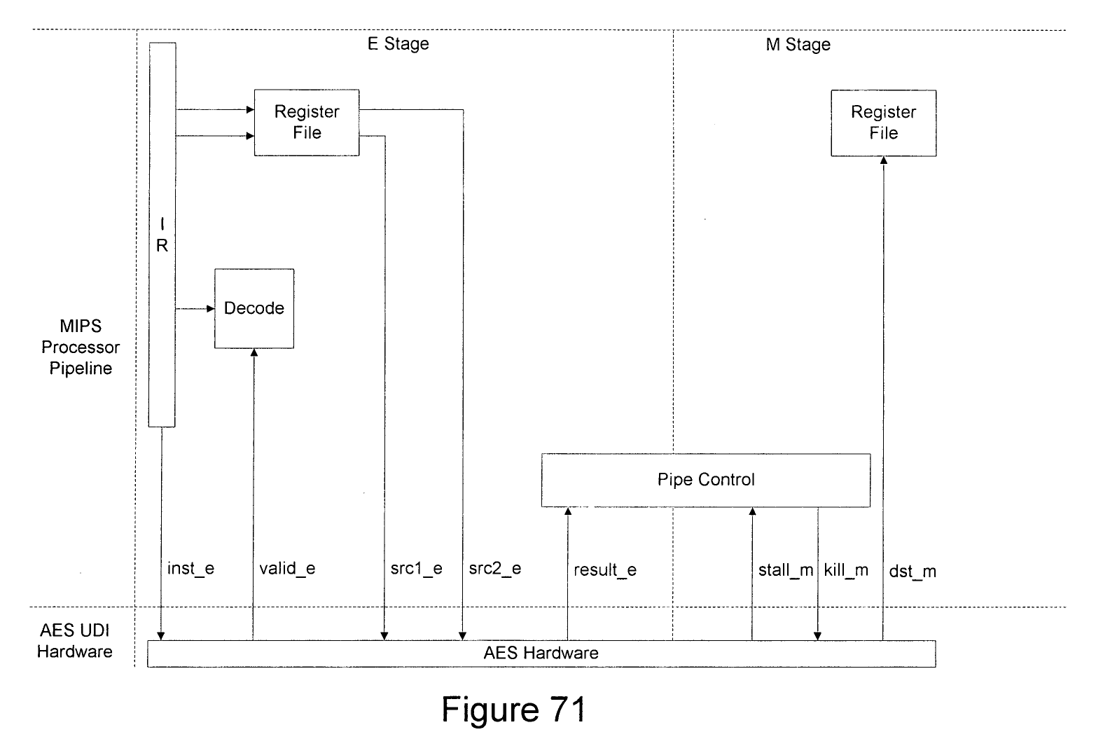

FIG. 71 displays how the hardware interacts with the MIPS CorExtend UDI interface. The interaction between the AES hardware and the processor are timed according to the E and the M stages of the MIPS pipeline. During the E stage, a 32-bit instruction opcode is given to the AES hardware. The AES hardware determines if the instruction is a valid AES instruction and notifies the MIPS core by way of the inst_e signal. The source data $src1 and $src2 is read by AES hardware through the src1_e and src2_e signals, each 32-bits wide. For single cycle AES instructions, such as those used to input data into the co-processor, the data is read into internal hardware registers. If the instruction returns data to a destination register, $dst, the number of the register is specified by the resulte signal at this time. The processing of the single-cycle instruction is then finished. For a multi-cycle AES instruction, such as those intended to perform the AES encryption for 18 cycles, the stall_m signal is asserted by the AES hardware if the processor tries to execute another multi-cycle AES instruction while it is still in the process of encrypting data. If the processor needs to kill the instruction for example due to an interrupt, the kill_m signal is asserted. The AES hardware finishes the current instruction automonously. After the interrupt, the processor reissues the instruction and the AES hardware may ignore the duplicate instruction so as not to corrupt the current data set. During the processing of a mult-cycle AES instruction however, the processor can issue single-cycle instructions which input data or output results from the previous encryption. Data results from the AES hardware are output during the M stage through the dst_m signal, which is 32-bits wide.

This application illustrates several preferred embodiments all of which incorporate hardware logic used to perform AES operations into a processor such that the AES operations are accessed as instructions of the processor. Once the AES operations are initiated by a processor instruction, they operate independently of the processor allowing the processor to perform other operations. In these preferred embodiments, the processor may perform other operations to save preceding data already processed by the AES operations. Also, the processor may perform other operations to prepare data for a subsequent AES operation.

In these prefered embodiments, the AES operations are performed in dedicated AES hardware which is accessed as instructions of the processor. The AES hardware may have registers to buffer data results from a preceding AES operation so that the processor may read such data results after the AES hardware has initiated another operation. The AES hardware may also have registers to buffer data prepared for a subsequent AES operation so that the processor may prepare data for the following AES operation while the AES hardware is still completing a current operation. The AES hardware may also have a signal to delay the processor until it is ready to begin a subsequent AES operation, whereby the delay is used when the AES hardware is busy with a current AES operation. This avoids the need for the processor to poll for the AES hardware to be ready.

The AES operations performed by the AES hardware and started by AES instructions of the processor may include the following: AES encryption, AES decryption, AES CBC mode, AES key expansion, CCMP data encryption, CCMP data decryption, CCMP MIC generation and CCMP MIC authentication.

In the preferred embodiments, the AES hardware exchanges data to and from data registers of the processor. The AES instructions of the processor are decoded by the processor and dispatched to the AES hardware when it is detected to be requesting any AES operations. The dispatching to the AES hardware includes provision for the processor to delay execution of the AES operations when the processor is delaying instructions in its own pipeline. The dispatching to the AES hardware may also include provision for the processor to abort execution of the AES operations when the processor is aborting instructions in its own pipeline.

In a preferred embodiment, two AES operations may be performed in an interleaved fashion on the AES hardware whereby the data for the two AES operations are held in two distinct pipeline registers. The two AES operations may be CCMP data encryption and CCMP MIC generation possibly operating on the same incoming data. The two AES operations may also be CCMP data decryption and CCMP MIC authentication possibly operating on the same incoming data. Or the two AES operations may be operating on different sets of incoming data.

In a preferred embodiment, the distinct pipeline registers are located on the inputs and outputs of a SBOX unit. The SBOX unit may be implemented using well known techniques including read only memory (ROM), random access memory (RAM) or logic implemented in hardware. The AES hardware is also accessed as instructions of a processor.

What we claim is:

1. A method of incorporating hardware to perform AES operations into a processor such that said AES operations are accessed as instructions of said processor and once said AES operation is are initiated by said processor instruction, operate independently of said processor allowing said processor to perform other operations.

2. A method of performing AES operations in processor where said AES operations once initiated by a processor instruction operate independently of said processor allowing said processor to perform other operations.

3. A method recited in claim 2, wherein said processor performs said other operations to save preceding data already processed by said AES operations.

4. A method recited in claim 2, wherein said processor performs said other operations to prepare data for a subsequent AES operation.

5. A method recited in claim 2, wherein said AES operations are performed in AES hardware accessed as instructions of said processor.

6. A method recited in claim 5, wherein said AES hardware has registers to buffer data results from a preceding AES operation.

7. A method recited in claim 5, wherein said AES hardware has registers to buffer data prepared for a subsequent AES operation.

8. A method recited in claim 5, wherein said AES hardware has a signal to delay said processor until it is ready for a subsequent AES operation, whereby said delay is used when said AES hardware is busy with a current AES operation.

9. A method recited in claim 2, wherein said AES operations include one or more elements of a group consisting of AES encryption, AES decryption, AES CBC mode, AES key expansion, CCMP data encryption, CCMP data decryption, CCMP MIC generation and CCMP MIC authentication.

10. A method recited in claim 5, wherein said AES hardware exchanges data to and from data registers of said processor.

11. A method recited in claim 5, wherein said instructions of said processor are decoded by said processor and dispatched to said AES hardware when it is detected to be requesting any said AES operations.

12. A method recited in claim 11, wherein said dispatching to said AES hardware includes provision for said processor to delay execution of said AES operations when said processor is delaying instructions in its own pipeline.

13. A method recited in claim 11, wherein said dispatching to said AES hardware includes provision for said processor to abort execution of said AES operations when said processor is aborting instructions in its own pipeline.

14. A method of performing two AES operations in an interleaved fashion on AES hardware whereby the data for said two AES operations are held in two distinct pipeline registers.

15. A method recited in claim 14, wherein said two AES operations are CCMP data encryption and CCMP MIC generation.

16. A method recited in claim 14, wherein said two AES operations are CCMP data decryption and CCMP MIC authentication.

17. A method recited in claim 14, wherein said two AES operations are operating on different sets of incoming data.

18. A method recited in claim 14, wherein said distinct pipeline registers are located on the inputs and outputs of a SBOX unit.

19. A method recited in claim 18, wherein said SBOX unit is implemented using one or more elements of a group consisting of read only memory (ROM), random access memory (RAM) and logic implemented in hardware.

20. A method recited in claim 14, wherein said AES hardware is accessed as instructions of a processor.
